(19) United States
(12) Patent Application Publication
(10) Pub. No.: US 2024/0132331 A1
(43) Pub. Date: Apr. 25, 2024

(54) LIFTING SYSTEMS AND METHODS FOR PERFORMING OPERATIONS ON A STRUCTURE

(71) Applicant: Daniel E. Davis, San Benito, TX (US)

(72) Inventors: Daniel E. DAVIS, San Benito, TX (US); Steven PRECOPIA, Van Alstyne, TX (US); James E. HOPKINS, McKinney, TX (US); Gaspar JIMENEZ, JR., Hutto, TX (US); Quintin GARZA, III, Kyle, TX (US)

(21) Appl. No.: 18/490,599

(22) Filed: Oct. 18, 2023

Related U.S. Application Data
(60) Provisional application No. 63/536,793, filed on Sep. 6, 2023.
(60) Provisional application No. 63/418,278, filed on Oct. 21, 2022.

(51) Int. Cl. B66C 23/20; B66C 23/76; E04H 12/34; F03D 13/10

(52) U.S. Cl. CPC B66C 23/207; B66C 23/76; E04H 12/342; F03D 13/112

(57) ABSTRACT

A lift system for performing operations on a structure includes a base and rack assembly mounted on the base. The rack assembly includes at least two legs. A carriage is engaged with the rack assembly, and is configured to travel vertically along the legs of the rack assembly. A crane is configured for transverse movement on the carriage. In some implementations, the base is moved under self-propulsion. In some implementations, the base includes a leveling assembly that is operable to adjust an orientation of the rack assembly with respect to the structure.

### CROSS-REFERENCE TO RELATED APPLICATIONS

This application claims the benefit of U.S. provisional patent application Ser. No. 63/418,278, filed Oct. 21, 2022, and U.S. provisional patent application Ser. No. 63/536,793, filed Sep. 6, 2023. Both application Ser. No. 63/418,278 and application Ser. No. 63/536,793 are incorporated herein by reference in their entireties.

### BACKGROUND

### Field

Embodiments of the present disclosure generally relate to systems and methods for performing operations on a structure, such as a mast or a tower.

### Description of the Related Art

A wind turbine includes a rotor having a hub and multiple (typically three) blades connected to the hub. The rotor is connected to an input drive shaft of a gearbox. The blades transform wind energy into torque that drives a generator connected to an output shaft of the gearbox. The gearbox steps up the inherently low rotational speed of the rotor for the generator to efficiently convert the rotational mechanical energy to electricity, which is fed into a utility grid. Gearless direct drive wind turbines also exist. The drive shafts, generator, gearbox and other components are typically mounted within a nacelle that is positioned on top of a tower that may be a truss or tubular.

Installing the nacelle, and accessing the nacelle and other equipment for maintenance, involves the use of large cranes, such as 300 to 2,000 metric ton cranes (or even larger cranes) that stand on the ground or on an offshore structure and include a boom that can lift the nacelle more than 100 m off the ground. Operations involving such cranes can be time-consuming, cumbersome, and expensive due to the size and complexity of such cranes. For example, weather phenomena, such as wind gusts, can adversely impact the capability to operate such cranes safely. Thus, there is a need for improved systems and processes that facilitate the installation of, and access to, the nacelle and other equipment.

### SUMMARY

The present disclosure generally relates to systems and methods for performing operations on a structure. In one implementation, a lift system includes a base configured for self-propelled motion, and a rack assembly on the base. The rack assembly is configured to be releasably coupled to the structure. A carriage is engaged with the rack assembly, and is configured to travel along the rack assembly. A crane is on the carriage.

In another implementation, a lift system includes a rack assembly and a carriage engaged with the rack assembly. The carriage is configured to travel along the rack assembly. A sled is on the carriage. The sled is movable along the carriage towards and away from the rack assembly. A crane is on the sled.

In another implementation, a method of performing an operation on a structure includes positioning a base at a location adjacent the structure. The method further includes assembling a rack assembly on the base, coupling the rack assembly to the structure, and moving a carriage along the rack assembly. The method further includes decoupling the rack assembly from the structure, disassembling the rack assembly, and removing the base from the location adjacent the structure.

In another implementation, a lift system includes a base. The base includes a leveling assembly. The leveling assembly includes a leveling table and one or more outriggers extending from the leveling table. A foot is coupled to each outrigger by a corresponding jack. A rack assembly is coupled to the leveling table. A carriage is engaged with the rack assembly, and is configured to travel along the rack assembly. A crane is on the carriage.

In another implementation, a method of performing an operation on a structure includes positioning a base at a location adjacent the structure. The base includes a leveling assembly. The method further includes operating a plurality of jacks of the leveling assembly to move corresponding feet towards a support surface beneath the base, and operating at least one of the plurality of jacks to tilt a leveling table of the leveling assembly with respect to the support surface. The method further includes constructing a rack assembly on the base, and moving a carriage along the rack assembly, thereby accessing an elevated portion of the structure.

In another implementation, a method of performing an operation on a structure includes constructing a rack assembly at a location adjacent the structure, and coupling the rack assembly to the structure. The method further includes moving a carriage along the rack assembly to an elevated location, and using a crane on the carriage to transfer a component of the structure between a floor and the structure while the carriage is at the elevated location. The method further includes decoupling the rack assembly from the structure, and disassembling the rack assembly.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, as the disclosure may admit to other equally effective embodiments.

FIG. 1A schematically illustrates a lift system for performing operations on a structure.

FIG. 1B schematically illustrates a lift system for performing operations on a structure.

FIGS. 2A and 2B schematically illustrate a lift system for performing operations on a structure.

FIGS. 3A to 3I schematically illustrate embodiments of a rack assembly for use with any of the lift systems of FIGS. 1A, 1B, and 2A-2B.

FIGS. 4A to 4F schematically illustrate the coupling of a lift system to a structure.

FIGS. 5A to 5D schematically illustrate selected components of the lift systems of FIGS. 1A, 1B, and 2A-2B.

FIG. 6A schematically illustrates an embodiment of a component that may be used with any of the lift systems of FIGS. 1A, 1B, and 2A-2B.

FIGS. 6B to 6D schematically illustrate selected components of the lift systems of FIGS. 1A, 1B, and 2A-2B.

FIG. 7 schematically illustrates selected components of the lift systems of FIGS. 1A, 1B, and 2A-2B.

FIGS. 8A to 8F schematically illustrate the constructing of a structure.

FIGS. 9A to 9D schematically illustrate the positioning of selected components of the lift systems of FIGS. 1A, 1B, and 2A-2B during the operations depicted in FIGS. 8A to 8F.

FIGS. 10A to 10C schematically illustrate aspects of the assembling of a rack assembly adjacent a structure, and coupling the rack assembly to the structure.

FIG. 11 schematically illustrates the installation of a nacelle of a wind turbine on the top of a tower.

FIG. 12 is a flow chart for a method of performing an operation on a structure.

FIGS. 13A to 13D schematically illustrate a lift system.

FIGS. 14A to 14D schematically illustrate aspects of the lift system of FIGS. 13A to 13D.

FIGS. 15A, 15B, and 15B-1 schematically illustrate aspects of the lift system of FIGS. 13A to 13D in some embodiments.

FIGS. 15C, 15D, and 15D-1 schematically illustrate the aspects depicted in FIGS. 15A, 15B, and 15B-1 in operation.

FIG. 16 schematically illustrates an aspect of the lift system of FIGS. 13A to 13D in some embodiments.

FIGS. 17A to 17C schematically illustrate exemplary operations of the lift system of FIGS. 13A to 13D.

FIG. 18 is a flow chart for a method of performing an operation on a structure.

FIGS. 19A and 19B schematically illustrate a lift system.

FIG. 20 is a flow chart for a method of performing an operation on a structure.

FIGS. 21A to 21C schematically illustrate examples of locating a lift system adjacent a structure.

FIG. 22 is a flow chart for a method of performing an operation on a structure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure concerns systems and methods for performing operations on a structure. The structure can be a mast or a tower, such as a tower including a wind turbine. The operations can include constructing the structure, performing maintenance on the structure, or dismantling the structure. The structure may be located on land. The structure may be located offshore.

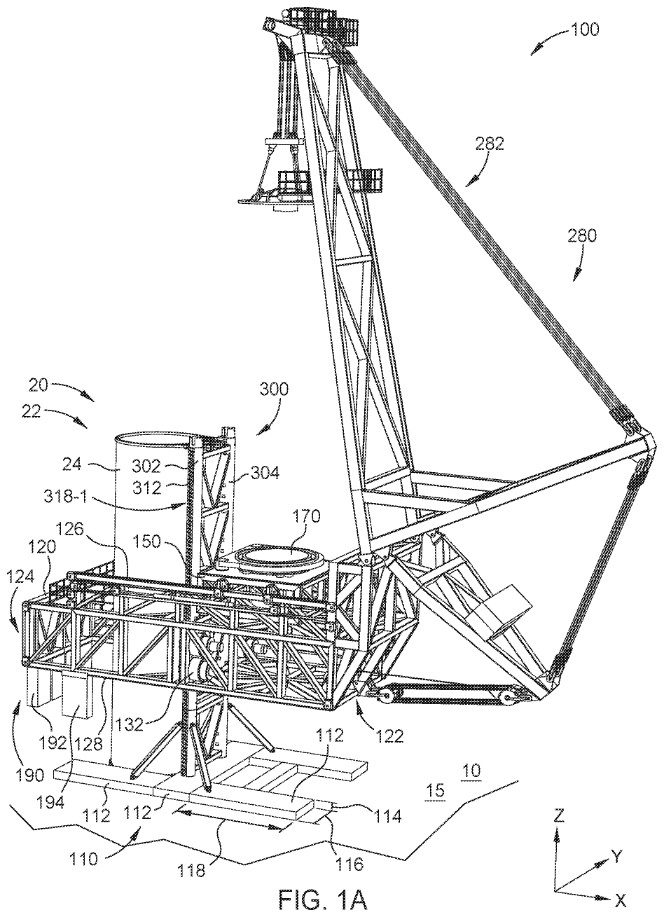

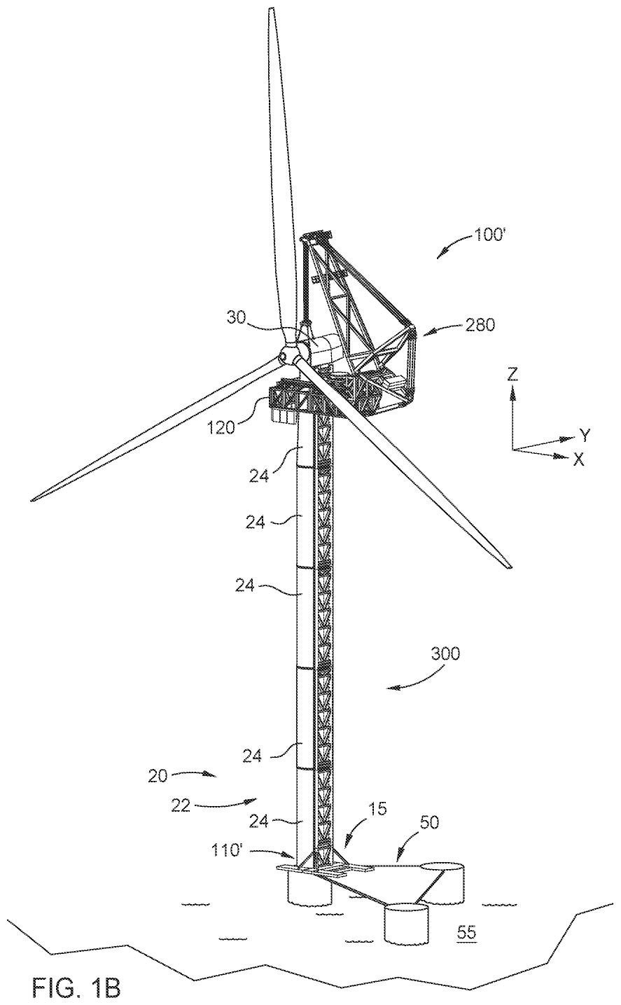

FIG. 1A schematically illustrates a lift system 100 for performing operations on a structure 20. In the illustrated example, the structure 20 is a tower, and a tower section 24 is shown in place. The lift system 100 is shown assembled for performing an operation on the structure 20, such as a construction or maintenance operation.

The lift system 100 includes a base 110. The base 110 is positioned on a support surface 15. Examples of the support surface 15 include any body configured to support a load, such as a ground surface 10 or at least a portion of an offshore installation (e.g. offshore installation 50, described below). The ground surface 10 may include a road, a roadbed, a paved surface, or a foundation. The ground surface 10 may include earth, wood, rock, aggregate, concrete, metal, asphalt, or the like. In some examples, the support surface 15 includes an item on a body that is configured to support a load, such as a mat on the ground surface 10.

The base 110 includes two or more modules 112 coupled together. The modules 112 are configured to be removably positioned on a ground surface, such as adjacent the structure 20. As illustrated, in some embodiments, each module 112 is formed with a height 114 that is less than a width 116 and less than a length 118 thereof. The modules 112 are configured to distribute load forces to the support surface 15, and to facilitate lateral stabilization of the lift system 100. In some embodiments, one or more module 112 is formed from a stack of metal plates, such as steel plates, coupled face-to-face. In some embodiments, one or more module 112 is formed as a metal box, such as a steel box. In an example, the metal box contains a weighting material, such as concrete. In some embodiments, the modules 112 include a non-metallic corrosion-resistant material, such as high density polyethylene (HDPE) or ultra high molecular weight (UHMW) polyethylene.

The lift system 100 includes a rack assembly 300 mounted on the base 110. As illustrated, in some embodiments, the rack assembly 300 extends substantially vertically from the base 110. For example, the rack assembly 300 may extend from 85 to 90 degrees with respect to horizontal. In some embodiments, the rack assembly 300 may extend at an acute angle less than 85 degrees with respect to horizontal.

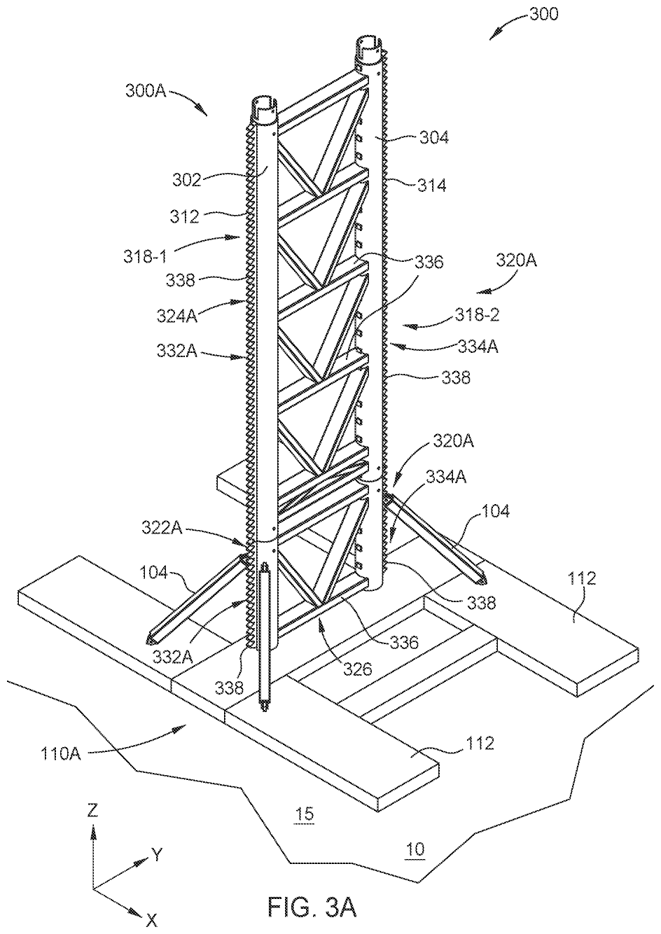

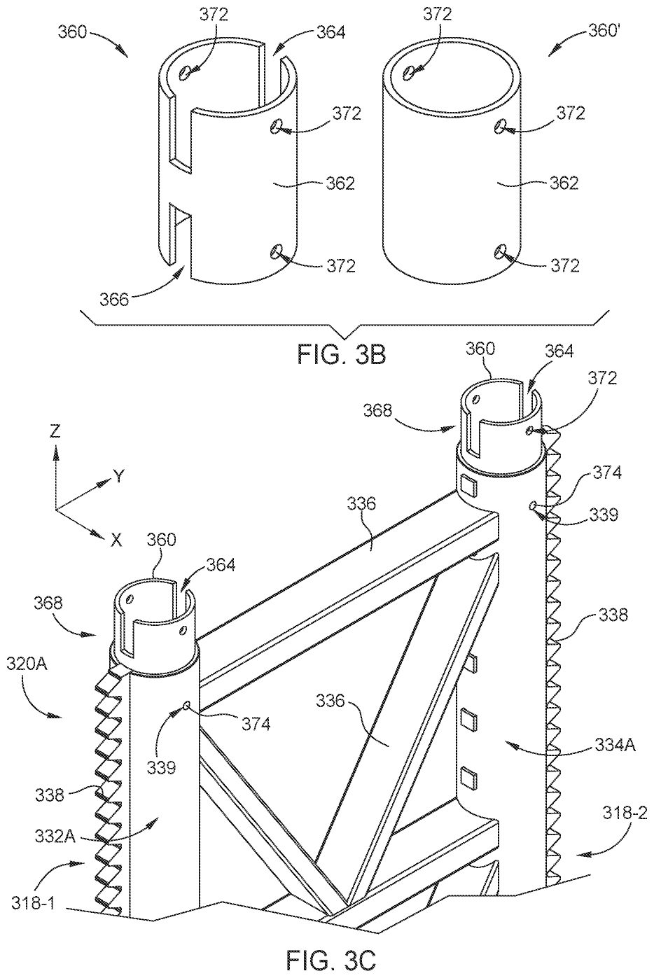

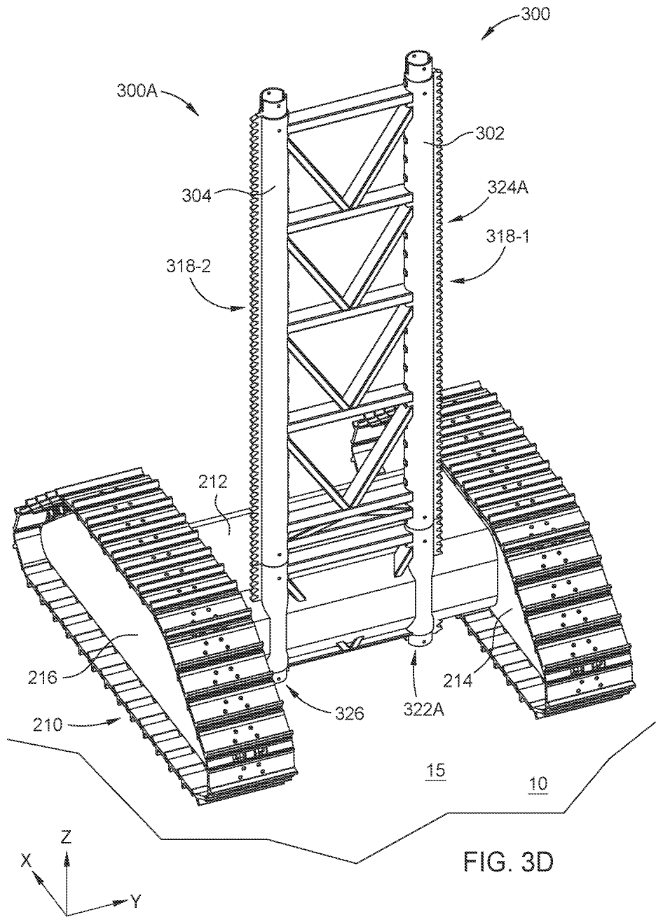

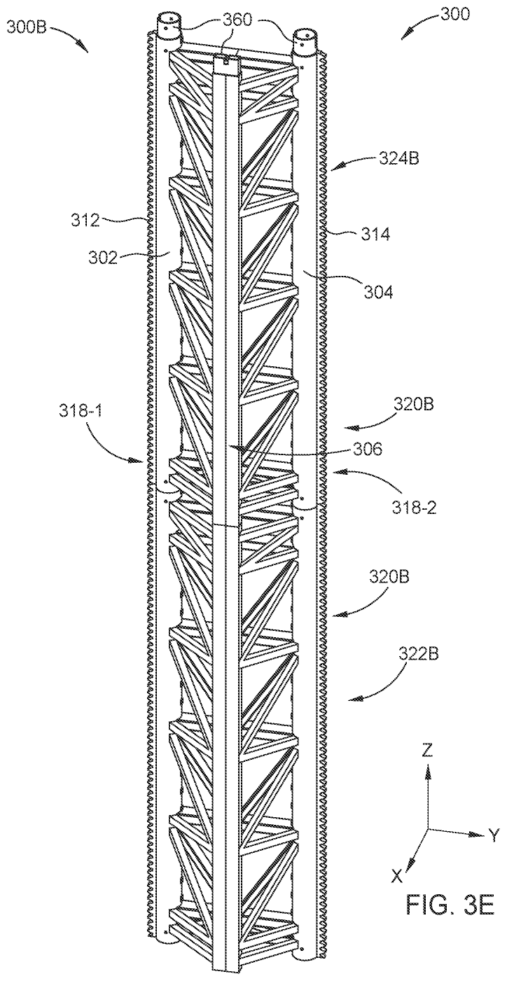

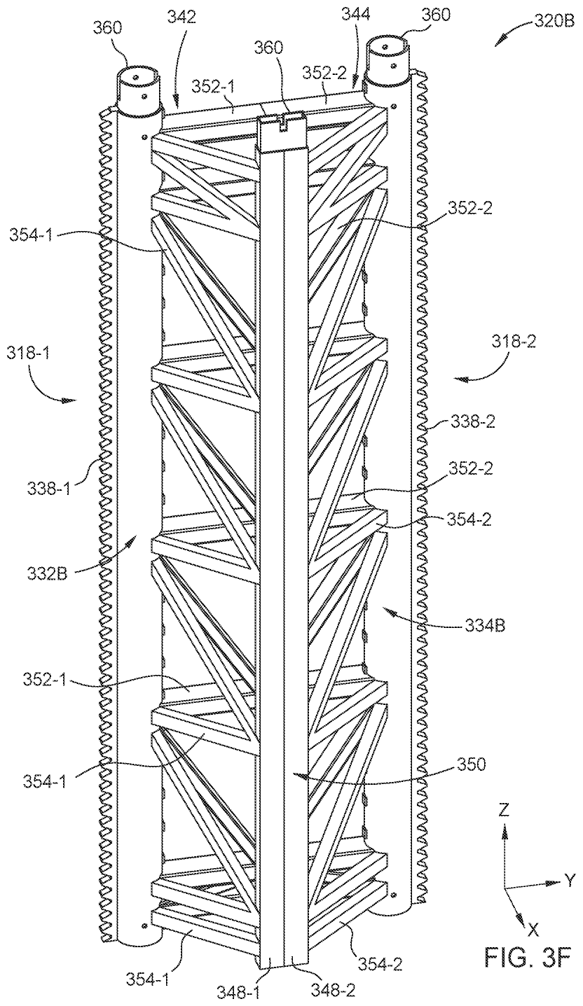

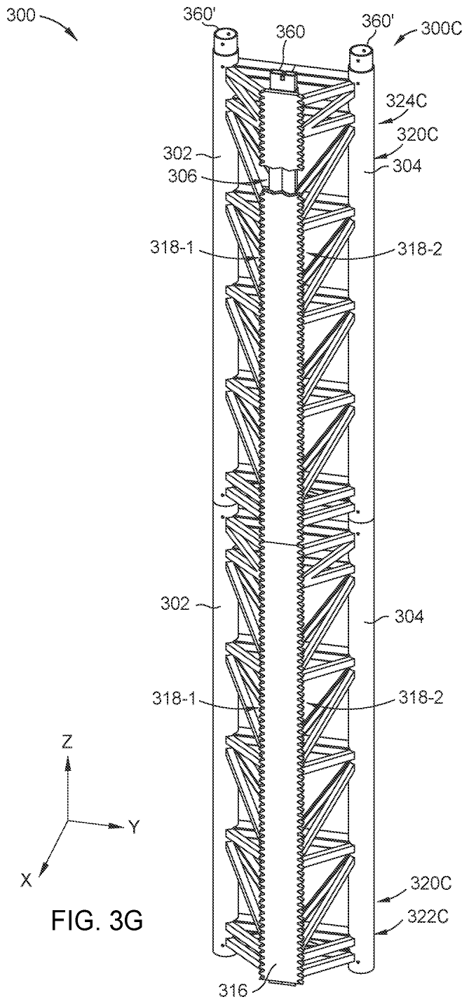

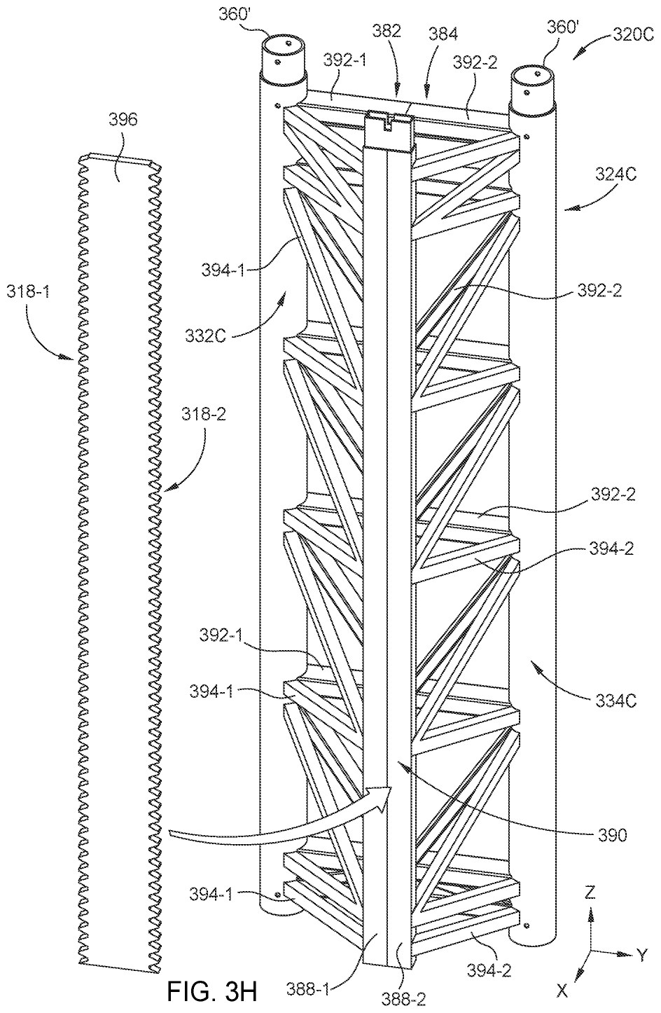

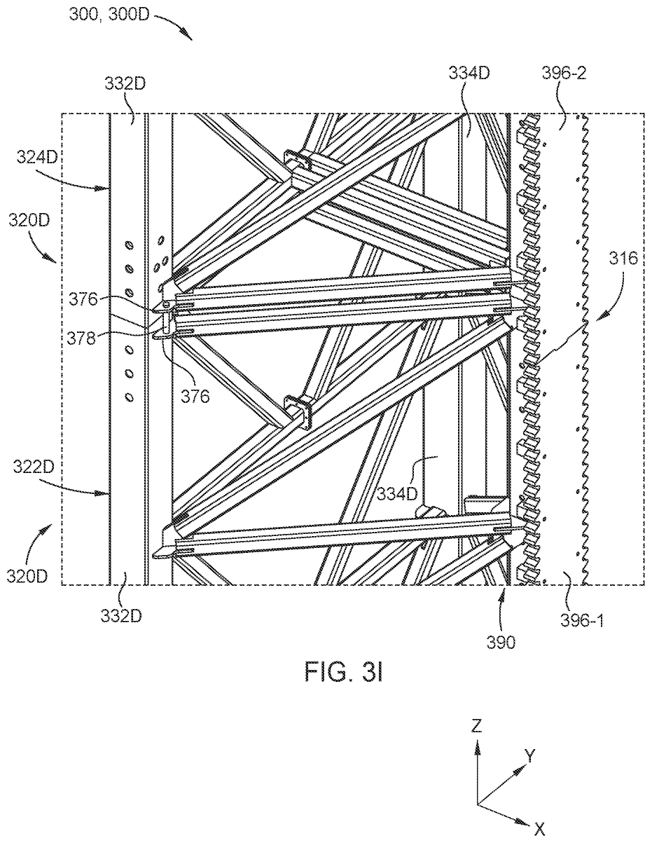

The rack assembly 300 includes a first leg 302 and a second leg 304. The rack assembly 300 further includes a first set of outwardly-projecting teeth 318-1 and a second set of outwardly-projecting teeth (318-2, shown in FIGS. 3A, 3E, and 3G, for example). The first and second sets of outwardly-projecting teeth 318-1, 318-2 face in opposite directions.

Each of the first and second sets of outwardly-projecting teeth 318-1, 318-2 extends along a majority of the height of the rack assembly 300. In an example each of the first and second sets of outwardly-projecting teeth 318-1, 318-2 extends along at least 80%, such as at least 85%, at least 90%, at least 95%, or at least 98% of the height of the rack assembly 300.

As illustrated, in some embodiments, the first set of outwardly-projecting teeth 318-1 extends along the first leg 302, and the second set of outwardly-projecting teeth 318-2 extends along the second leg 304. However, in some embodiments, the first set of outwardly-projecting teeth 318-1 and/or the second set of outwardly-projecting teeth 318-2 may extend along one or more other legs or assemblies that are additional to the first and second legs 302, 304.

The lift system 100 includes a carriage 120 mounted to the rack assembly 300. As illustrated, in some embodiments, the carriage 120 is in the form of a cage. It is contemplated that the carriage 120 may be transported to a work site in two or more separate sections, and assembled at the work site. As illustrated, in some embodiments, upon assembly, the carriage 120 encircles the structure 20 and the rack assembly 300. In some embodiments, the carriage 120 includes a door or a removable section that facilitates placement of the carriage 120 around the structure 20.

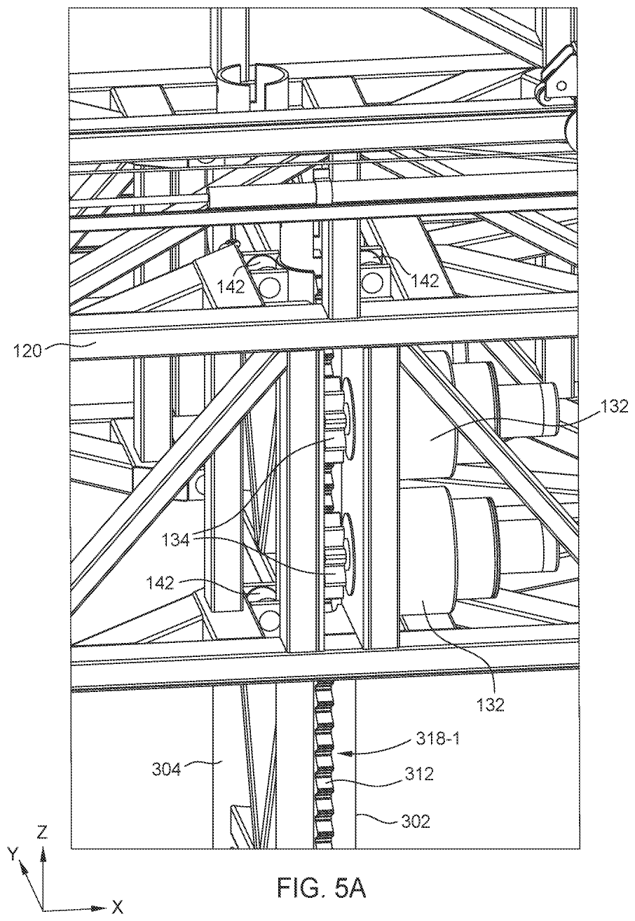

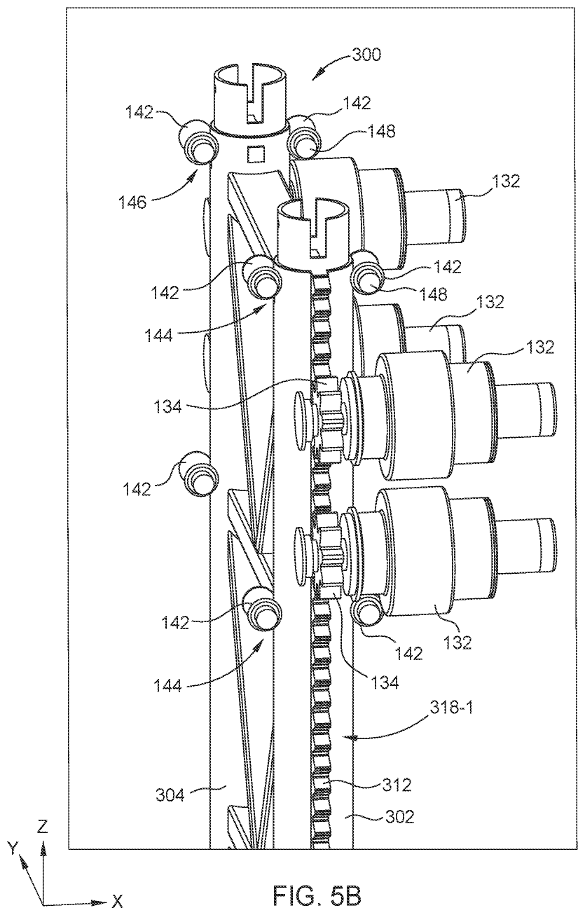

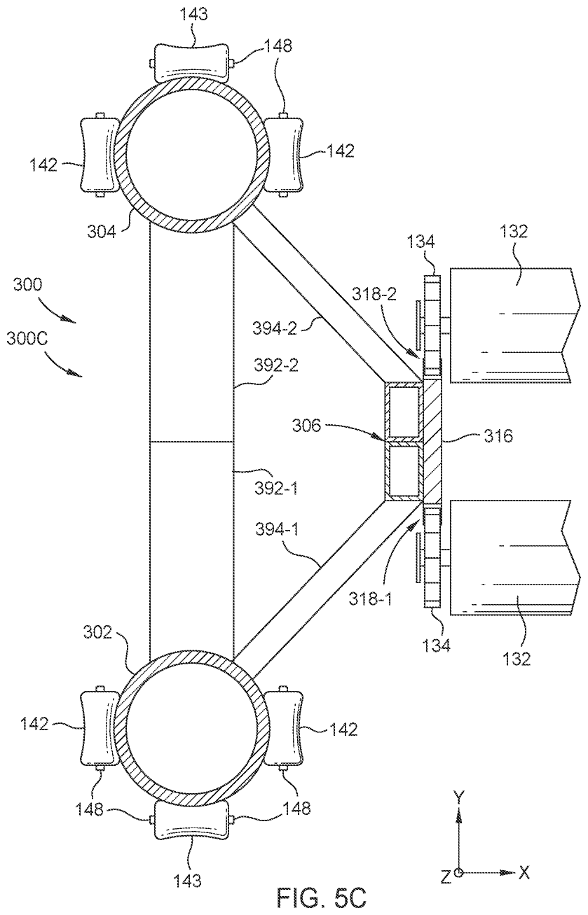

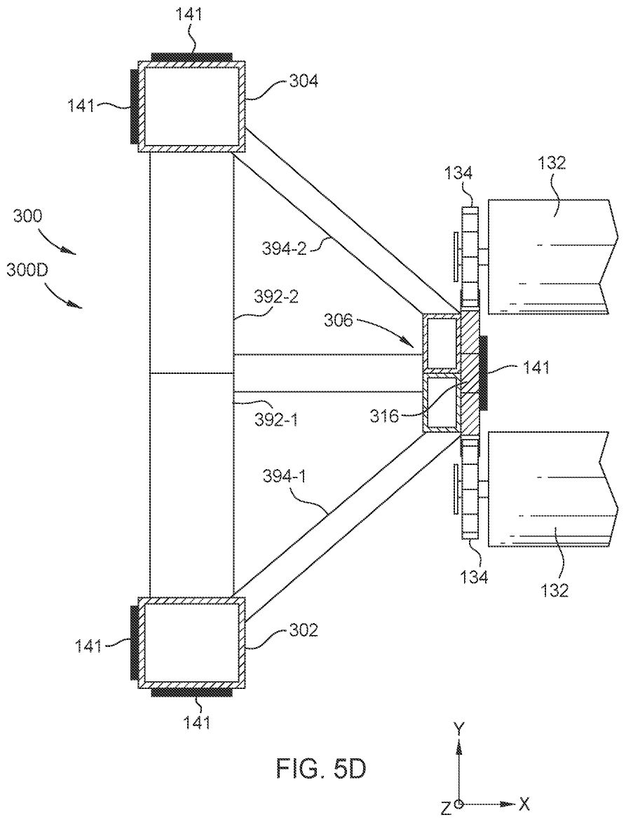

A plurality of motors 132 are mounted to the carriage 120. At least one motor 132 drives a pinion (134, FIGS. 5A, 5B) that is engaged with the first set of outwardly-projecting teeth 318-1 of the rack assembly 300, and at least one motor 132 drives a pinion (134, FIGS. 5A, 5B) that is engaged with the second set of outwardly-projecting teeth 318-2 of the rack assembly 300. The motors 132 driving the pinions 134 move the carriage 120 along the rack assembly 300. It is contemplated two, six, eight, or more motors 132, each driving a corresponding pinion 134, may be mounted to the carriage 120. It is further contemplated that the number of motors 132 driving the pinions 134 that engage the first set of outwardly-projecting teeth 318-1 equals the number of motors 132 driving the pinions 134 that engage the second set of outwardly-projecting teeth 318-2.

The lift system 100 includes a trolley 150 mounted to the carriage 120. The trolley 150 is mounted on a pair of rails 126 of the carriage 120, of which only one rail 126 is visible in the Figure. The trolley 150 is movable along the rails 126 with respect to the carriage 120 in a transverse direction with respect to vertical. As illustrated, the trolley 150 is movable substantially horizontally with respect to the carriage 120. A stool 170 is mounted on the trolley 150, and moves with the trolley 150 in the transverse direction. As described below, in some embodiments, the stool 170 can be raised and lowered with respect to the trolley 150 and the with respect to the carriage 120.

The lift system 100 includes a crane 280 mounted to the carriage 120. The crane 280 is mounted at a first end 122 of the carriage 120. As illustrated, the crane 280 is represented by an A-frame 282. The A-frame 282 is pivotably mounted to the carriage 120 about a horizontal axis. In some embodiments, the crane 280 includes a jib mounted for rotational movement with respect to the carriage 120 about a vertical axis, and mounted for rotational movement with respect to the carriage 120 about a horizontal axis.

The lift system 100 includes counterweights 190 mounted to the carriage 120. One or more fixed counterweights 192 are attached to the carriage 120 at a second end 124 of the carriage 120 opposite to the first end 122 at which the crane 280 is mounted. One or more movable counterweights 194 are attached to a bottom rail 128 at each side of the carriage 120 between the first and second ends 122, 124. As described below, the one or more movable counterweights 194 can move along the bottom rails 128 of the carriage 120 towards and away from each of the first end 122 and the second end 124.

In some embodiments, the lift system 100 may incorporate any one or more features of lift system 700, which is described further below.

FIG. 1B schematically illustrates a lift system 100′ for performing operations on a structure 20. In the illustrated example, the structure 20 is a tower 22. The tower 22 is located on an offshore installation 50 which is in water 55, such as a lake, river, or sea. The offshore installation 50 may include any man-made offshore structure, such as a monopile, a tripod, a quadrapod, a gravity-based structure, a jacket (e.g. a conventional jacket, a suction caisson, or the like), a platform (e.g. a tension leg platform), a vessel (e.g. a ship, a barge, a semi-submersible vessel, a jack-up vessel, or a spar-buoy), or the like. The offshore installation 50 may be standing on the bed (such as a sea bed, a lake bed, or a river bed) underlying the water 55. Alternatively, the offshore installation 50 may be floating in or on the water 55. The tower 22 is constructed of several tower sections 24. A nacelle 30 is shown being installed on the tower 22.

The lift system 100′ is similar to the lift system 100, and includes similar components as described in the present disclosure. The base 110′ is positioned adjacent the tower 22 on a support surface 15. In the illustrated example, the support surface 15 includes a portion, such as a deck, of the same offshore installation 50 on which the structure 20 is located. In other examples, the support surface 15 includes a portion, such as a deck, of a different offshore installation that is located adjacent the tower 22. In an example, the base 110′ may be positioned on a mobile service vessel, such as a jack-up vessel, that is moved on the water 55 to be located adjacent the tower 22. In some embodiments, the base 110′ is positioned at least partly on the offshore installation 50, and at least partly on a different offshore installation that is located adjacent the tower 22.

In some embodiments, the base 110′ is similar to the base 110 of the lift system 100. In an example, the base 110′ includes two or more modules 112 (FIG. 1A) coupled together, as described above. In a further example, the modules 112 are configured to be removably positioned on an offshore installation, such as the offshore installation 50. The modules 112 may be shaped and sized to fit in or on the superstructure of the offshore installation. The modules 112 may include provisions for fasteners, such as bolts or clamps, to secure the modules 112 to the offshore installation. The fasteners may be released to allow for removal of the base 110′

In some embodiments, the base 110′ is integral with an offshore installation, such as the offshore installation 50, at the location adjacent the tower 22. In an example, the base 110′ is permanently attached to the offshore installation, such as by welding, and/or by fasteners, such as bolts or clamps. For instance, the base 110′ may remain attached to the offshore installation after the carriage 120 and the rack assembly 300 have been removed from the tower 22.

In some embodiments, the lift system 100′ may incorporate any one or more features of lift system 700, which is described further below.

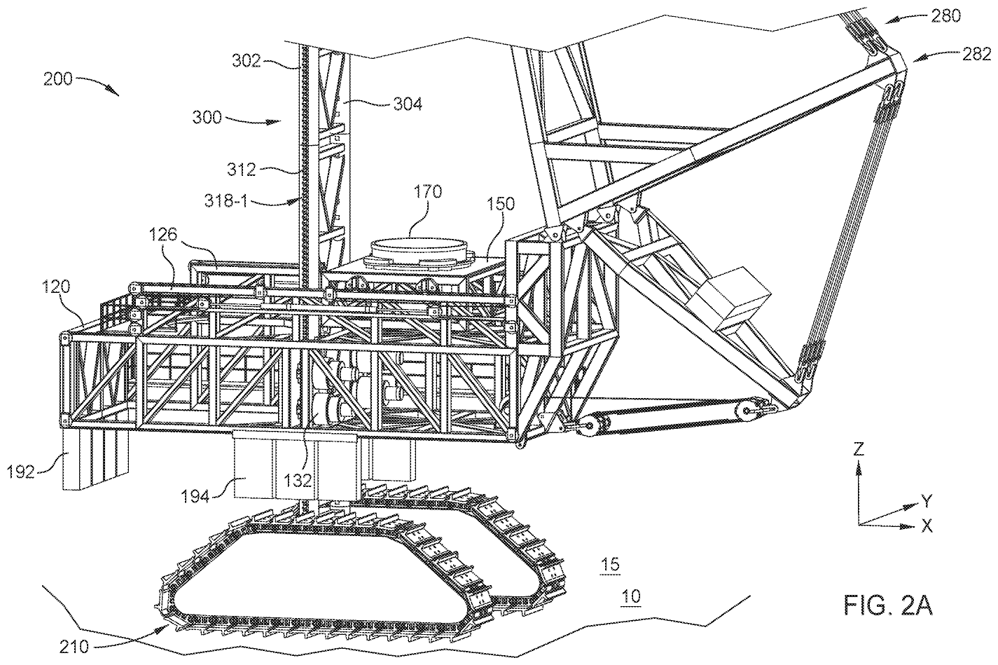

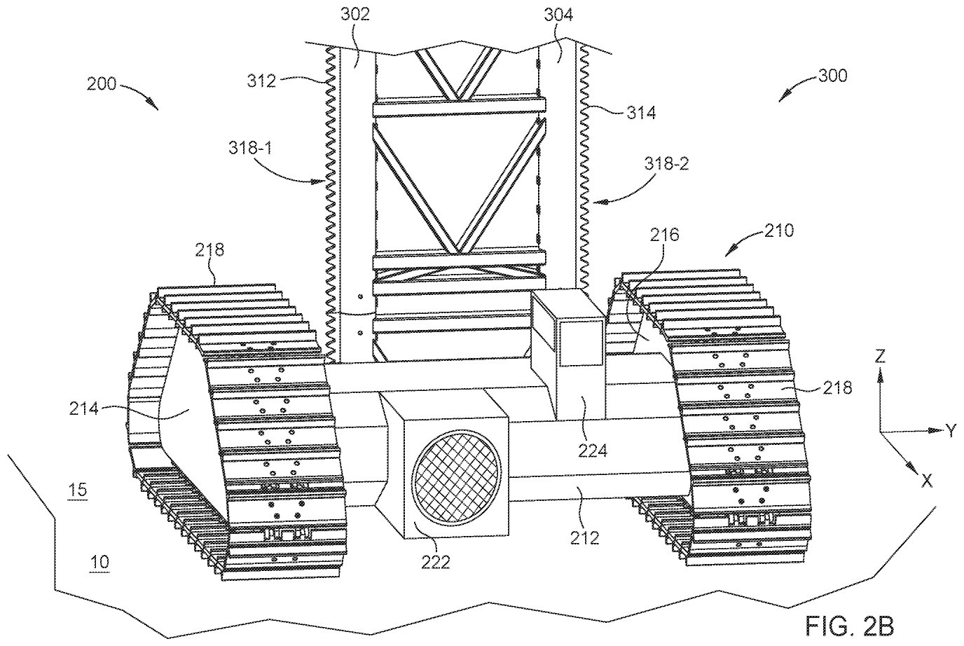

FIGS. 2A and 2B schematically illustrate a lift system 200 for performing operations on a structure, such as the structure 20 of FIG. 1A, such as the tower 22. The lift system 200 is similar to the lift system 100, except for the base. Instead of the base 110 of the lift system 100, the lift system 200 includes a base 210 that is configured for self-propelled motion. The base 210 is motorized, and includes a car body 212 coupled to first and second traction units 214, 216. The first and second traction units 214, 216 contact the support surface 15 to propel the base 210 along the support surface 15. In some embodiments, the first and second traction units 214, 216 include wheels that contact the support surface 15. As illustrated, in some embodiments, the first and second traction units 214, 216 include caterpillar tracks 218 that contact the support surface 15. In some embodiments, the first and second traction units 214, 216 are detachable from the car body 212.

The base 210 includes a power unit 222, such as a diesel engine, that drives the first and second traction units 214, 216. In some embodiments, the base 210 is powered by a power unit mounted on the carriage 120. In some embodiments, the base 210 is powered by a power unit mounted on the crane 280. In some embodiments, the base 210 includes a cab 224 for an operator. In some embodiments, self-propelled motion of the base 210 is controlled from the cab 224. In some embodiments, self-propelled motion of the base 210 is controlled remotely. In some embodiments, the cab 224 is omitted.

In some embodiments, the lift system 200 may incorporate any one or more features of lift system 500, which is described further below.

FIGS. 3A to 3I schematically illustrate aspects of the rack assembly 300. It is contemplated that the rack assembly 300 may include one or more features of any one or more of three exemplary rack assemblies 300A, 300B, 300C, or 300D, respectively. It is contemplated that the rack assembly 300— including any feature of any one or more of the exemplary rack assemblies 300A, 300B, 300C, or 300D—may be used as part of any of the lift systems 100, 100′, 200, 500, or 700.

In FIG. 3A, the rack assembly 300 is represented by the rack assembly 300A. FIG. 3A shows the rack assembly 300A mounted to the base 110 of the lift system 100 of FIG. 1A. The rack assembly 300A includes the first leg 302 and the second leg 304. The first and second legs 302, 304 are parallel. The first leg 302 includes a rack 312 on which the first set of outwardly-projecting teeth 318-1 are disposed. The rack 312 is oriented along the first leg 302. The second leg 304 includes a rack 314 on which the second set of outwardly-projecting teeth 318-2 are disposed. The rack 314 is oriented along the second leg 304. The first and second sets of outwardly-projecting teeth 318-1, 318-2 face in opposite directions.

The rack assembly 300A includes a plurality of rack sections 320A coupled together end-to-end. A second rack section 324A is shown mounted on a first rack section 322A. Although only two rack sections 320A are illustrated, it is contemplated that further rack sections 320A may be installed onto the second rack section 324A to lengthen the rack assembly 300A.

In the Figure, the first rack section 322A is also the lowermost rack section 326. When used as part of the lift system 100 or the lift system 100′, the lowermost rack section 326 is mounted to one of the base modules 112 of the base 110/110′. In some embodiments, the lowermost rack section 326 is removably mounted to the base module 112, such as by a releasable fastener, such as a connector (for example, connector 360, described below), a latch, a bolt, or the like. In some embodiments, the lowermost rack section 326 is permanently coupled to the base module 112, such as by welding. In some embodiments, one or more support braces 104 extend from the base 110 to the lowermost rack section 326. As illustrated, in some embodiments, the one or more support braces 104 extend from one or more module 112 that is coupled to the module 112 on which the lowermost rack section 326 is mounted.

Each rack section 320A includes a first leg unit 332A connected to a second leg unit 334A by a plurality of cross beams 336. When the rack sections 320A are coupled together, the first leg units 332A of each rack section 320A are coupled together end-to-end to form the first leg 302 of the rack assembly 300A. Similarly, the second leg units 334A of each rack section 320A are coupled together end-to-end to form the second leg 304 of the rack assembly 300A.

The first leg unit 332A includes a first rack unit 338-1 that forms part of the corresponding rack 312. The second leg unit 334A includes a second rack unit 338-2 that forms part of the corresponding rack 314. When the rack sections 320A coupled together, each of the first rack units 338-1 are aligned to form the first rack 312, and each of the second rack units 338-2 are aligned to form the second rack 314.

FIG. 3B schematically illustrates a connector 360 used for coupling corresponding leg units 332A/334A together. FIG. 3B also schematically illustrates a connector 360′ that may be used for coupling portions of any of the rack assemblies 300A, 300B, 300C, or 300D together. FIG. 3C schematically illustrates a rack section 320A with connectors 360.

Each connector 360 includes a body 362 with upper and lower recesses 364, 366. The body 362 may include a tubular shape that is cylindrical, as shown, and/or may include any other tubular geometric shape, such as triangular, square, rectangular, and the like. Each connector 360′ is similar to connector 360, except that the upper and lower recesses 364, 366 are omitted. Each connector 360, 360′ includes holes 372 through the body 362 for the insertion of a cotter to secure the connector 360, 360′ to the structural element with which the connector 360, 360′ is being coupled.

In an exemplary use, a connector 360 is inserted into the top of the first leg unit 332A, and a similar connector 360 is inserted into the top of the second leg unit 334A. Each lower recess 366 accommodates the rack unit 338-1/338-2 of each of the corresponding first or second leg unit 332A/334A. An upper portion 368 of each connector 360 protrudes out of the top of each corresponding leg unit 332A, 334A. When rack sections 320A are being coupled together, the upper portion 368 of each connector 360 of one rack section 320A is inserted into the bottom of the corresponding leg unit 332A/334A of the other rack section 320A. Each upper recess 364 of each connector accommodates the rack unit 338-1/338-2 of each of the corresponding first or second leg unit 332A/334A of the other rack section 320A.

When a connector 360 is inserted into the top or the bottom of a leg unit 332A/334A, the holes 372 align with corresponding holes 339 in the leg unit 332A/334A. A cotter 374 is inserted through the holes 339, 372 to secure the coupling of the connector 360 to the leg unit 332A/334A.

FIG. 3D shows the rack assembly 300 mounted to the car body 212 of the lift system 200 of FIGS. 2A and 2B. The rack assembly 300 is represented by the rack assembly 300A. In some embodiments, the lowermost rack section 326 is removably mounted to the car body 212, such as by a releasable fastener, such as a connector (for example, connector 360), a latch, a bolt, or the like. In some embodiments, the lowermost rack section 326 is permanently coupled to the car body 212, such as by welding. In some embodiments, the lowermost rack section 326 is integrated into the car body 212.

When the rack assembly 300A is used in the lift system 500, the rack assembly 300A may be mounted to, or incorporated with, the base 510 of the lift system 500 in a similar way as described above with respect to the car body 212 of the lift system 200. In some embodiments, the lowermost rack section 326 is removably mounted to the base 510, such as by a releasable fastener, such as a connector (for example, connector 360), a latch, a bolt, or the like. In some embodiments, the lowermost rack section 326 is permanently coupled to the base 510, such as by welding. In some embodiments, the lowermost rack section 326 is integrated into the base 510.

When the rack assembly 300A is used in the lift system 700, the rack assembly 300A may be mounted to, or incorporated with, the base 710 of the lift system 700 in a similar way as described above with respect to the car body 212 of the lift system 200. In some embodiments, the lowermost rack section 326 is removably mounted to the base 710, such as by a releasable fastener, such as a connector (for example, connector 360), a latch, a bolt, or the like. In some embodiments, the lowermost rack section 326 is permanently coupled to the base 710, such as by welding. In some embodiments, the lowermost rack section 326 is integrated into the base 710.

In FIG. 3E, the rack assembly 300 is represented by rack assembly 300B. The rack assembly 300B may be used in place of the rack assembly 300A in any of the lift systems 100, 100′, 200, 500, or 700. FIG. 3E schematically illustrates a portion of the rack assembly 300B. The rack assembly 300B is similar to the rack assembly 300A, including the first leg 302 and the second leg 304 parallel to the first leg 302. The first leg 302 includes the rack 312 on which the first set of outwardly-projecting teeth 318-1 are disposed. The rack 312 is oriented along the first leg 302. The second leg 304 includes the rack 314 on which the second set of outwardly-projecting teeth 318-2 are disposed. The rack 314 is oriented along the second leg 304. The first and second sets of outwardly-projecting teeth 318-1, 318-2 face in opposite directions.

The rack assembly 300B differs from the rack assembly 300A in that the rack assembly 300B includes also a buttress leg 306. The buttress leg 306 is parallel to the first leg 302 and to the second leg 304, and provides lateral support to the rack assembly 300B.

The rack assembly 300B includes a plurality of rack sections 320B coupled together end-to-end. A second rack section 324B is shown mounted on a first rack section 322B. Although only two rack sections 320B are illustrated, it is contemplated that further rack sections 320B may be installed onto the second rack section 324B to lengthen the rack assembly 300B.

FIG. 3F schematically illustrates a rack section 320B in further detail. Each rack section 320B includes first and second subsections 342, 344 that are detachably connected together. The first and second subsections 342, 344 can be disconnected for transport to and from a worksite, and can be connected together at the worksite, such as by bolts.

The first subsection 342 includes a first leg unit 332B. The first leg unit 332B includes a first rack unit 338-1 that forms part of the corresponding rack 312 of the first leg 302. A plurality of first cross beams 352-1 is coupled to the first leg unit 332B. A buttress unit 348-1 is oriented parallel to the first leg unit 332B, and is coupled to the first leg unit 332B by a plurality of second cross beams 354-1.

The second subsection 344 includes a second leg unit 334B. The second leg unit 334B includes a second rack unit 338-2 that forms part of the corresponding rack 314 of the second leg 304. A plurality of first cross beams 352-2 is coupled to the second leg unit 334B. A buttress unit 348-2 is oriented parallel to the second leg unit 334B, and is coupled to the second leg unit 334B by a plurality of second cross beams 354-2.

When the first and second subsections 342, 344 are connected together to form a rack section 320B, the first cross beams 352-1 of the first subsection 342 are coupled to corresponding first cross beams 352-2 of the second subsection 344. Additionally, the buttress unit 348-1 of the first subsection 342 is coupled to the buttress unit 348-2 of the second subsection 344 to form a buttress section 350.

[ono] When a plurality of rack sections 320B are coupled together to form the rack assembly 300B, the first leg units 332B of the plurality of rack sections 320B are coupled end-to-end by the connectors 360 to form the corresponding first leg 302 of the rack assembly 300B. Similarly, the second leg units 334B of the plurality of rack sections 320B are coupled end-to-end by the connectors 360 to form the corresponding second leg 304 of the rack assembly 300B. Additionally, each of the first rack units 338-1 are aligned to form the rack 312, and each of the second rack units 338-2 are aligned to form the rack 314. Furthermore, the buttress sections 350 are connected end-to-end to form the buttress leg 306. It is contemplated that the buttress sections 350 are coupled together by suitable connectors, such as connectors 360 or 360′.

It is contemplated that a lowermost rack section 320B of the rack assembly 300B may be mounted to the base 110 of the lift system 100 or to the base 110′ of the lift system 100′ in any one of the ways described above for the rack assembly 300A. It is further contemplated that a lowermost rack section 320B of the rack assembly 300B may be mounted to the car body 212 of the lift system 200 in any one of the ways described above for the rack assembly 300A. It is further contemplated that a lowermost rack section 320B of the rack assembly 300B may be mounted to the base 510 of the lift system 500 in any one of the ways described above for the rack assembly 300A. It is further contemplated that a lowermost rack section 320B of the rack assembly 300B may be mounted to the base 710 of the lift system 700 in any one of the ways described above for the rack assembly 300A.

In FIG. 3G, the rack assembly 300 is represented by rack assembly 300C. The rack assembly 300C may be used in place of the rack assembly 300A or the rack assembly 300B in any of the lift systems 100, 100′, 200, 500, or 700. FIG. 3G schematically illustrates a portion of the rack assembly 300C. The rack assembly 300C is similar to the rack assembly 300B, including the first leg 302, the second leg 304 parallel to the first leg 302, and the buttress leg 306 parallel to the first leg 302 and to the second leg 304.

The rack assembly 300C differs from the rack assembly 300B in that the racks 312 and 314 are replaced by a rack 316. The rack 316 is located on the buttress leg 306 instead of the first and second legs 302, 304. The rack 316 includes the first and second sets of outwardly-projecting teeth 318-1, 318-2. The first and second sets of outwardly-projecting teeth 318-1, 318-2 face in opposite directions. The rack 316 is attached to the buttress leg 306 by bolts, pins, or the like.

The rack assembly 300C includes a plurality of rack sections 320C coupled together end-to-end. A second rack section 324C is shown mounted on a first rack section 322C. Although only two rack sections 320C are illustrated, it is contemplated that further rack sections 320C may be installed onto the second rack section 324C to lengthen the rack assembly 300C.

FIG. 3H schematically illustrates a rack section 320C in further detail. Each rack section 320C includes first and second subsections 382, 384 that are detachably connected together. The first and second subsections 382, 384 can be disconnected for transport to and from a worksite, and can be connected together at the worksite, such as by bolts.

The first subsection 382 includes a first leg unit 332C. A plurality of first cross beams 392-1 is coupled to the first leg unit 332C. A buttress unit 388-1 is oriented parallel to the first leg unit 332C, and is coupled to the first leg unit 332C by a plurality of second cross beams 394-1.

The second subsection 384 includes a second leg unit 334C. A plurality of first cross beams 392-2 is coupled to the second leg unit 334C. A buttress unit 388-2 is oriented parallel to the second leg unit 334C, and is coupled to the second leg unit 334C by a plurality of second cross beams 394-2.

When the first and second subsections 382, 384 are connected together to form a rack section 320C, the first cross beams 392-1 of the first subsection 382 are coupled to corresponding first cross beams 392-2 of the second subsection 384. Additionally, the buttress unit 388-1 of the first subsection 382 is coupled to the buttress unit 388-2 of the second subsection 384 to form a buttress section 390.

Each rack section 320C includes a rack unit 396. In some embodiments, the rack unit 396 is attached to the buttress section 390 of each rack section 320C after the buttress units 388-1 and 388-2 are coupled, such as by bolts. In some embodiments, the rack unit 396 is initially attached to one of the buttress units 388-1 or 388-2 before the buttress units 388-1 and 388-2 are coupled. When a plurality of rack sections 320C are coupled together to form the rack assembly 300C, the rack units 396 of each rack section 320C are aligned to form the rack 316.

When a plurality of rack sections 320C are coupled together to form the rack assembly 300C, the first leg units 332C of the plurality of rack sections 320C are coupled end-to-end by the connectors 360 or 360′ to form the corresponding first leg 302 of the rack assembly 300C. Similarly, the second leg units 334C of the plurality of rack sections 320C are coupled end-to-end by the connectors 360 or 360′ to form the corresponding second leg 304 of the rack assembly 300C. Additionally, the buttress sections 390 are connected end-to-end to form the buttress leg 306. It is contemplated that the buttress sections 390 are coupled together by suitable connectors, such as connectors 360 or 360′.

It is contemplated that a lowermost rack section 320C of the rack assembly 300C may be mounted to the base 110 of the lift system 100 or to the base 110′ of the lift system 100′ in any one of the ways described above for the rack assembly 300A. It is further contemplated that a lowermost rack section 320C of the rack assembly 300C may be mounted to the car body 212 of the lift system 200 in any one of the ways described above for the rack assembly 300A. It is further contemplated that a lowermost rack section 320C of the rack assembly 300C may be mounted to the base 510 of the lift system 500 in any one of the ways described above for the rack assembly 300A. It is further contemplated that a lowermost rack section 320C of the rack assembly 300C may be mounted to the base 710 of the lift system 700 in any one of the ways described above for the rack assembly 300A.

As illustrated in FIG. 3A and FIGS. 3C to 3H, in some embodiments, a cross-sectional shape of the first leg 302, first leg units 332/332A-332C, second leg 334, and second leg units 334A-334C of the rack assembly 300 is circular. In other embodiments, a cross-sectional shape of the first leg 302, first leg units 332/332A-332C, second leg 334, and second leg units 334A-334C of the rack assembly 300 is not circular. For example, the cross-sectional shape may be oval, triangular, rectangular (such as square), hexagonal, octagonal, or the like.

FIG. 3I schematically illustrates a portion of an embodiment of the rack assembly 300 that is similar to the rack assembly 300C. The rack assembly 300 is represented by rack assembly 300D. In the rack assembly 300D, the cross-sectional shapes of the first leg 302 and second leg 304 are rectangular, such as square. Rack sections 320D (equivalent to rack sections 320/320A-320C) are represented by a first rack section 322D coupled to a second rack section 324D. The rack 316 includes rack units 396-1 and 396-2. The rack unit 396-2 of the second rack section 324D overlaps the buttress section 390 of the first rack section 322D. The rack unit 396-2 abuts the rack unit 396-1 of the first rack section 322D.

The first leg unit 332D of the first rack section 322D is coupled to the first leg unit 332D of the second rack section 324D, and the second leg unit 334D of the first rack section 322D is coupled to the second leg unit 334D of the second rack section 324D. Gussets 376 are on the first leg unit 332D and the second leg unit 334D of each of the first rack section 322D and the second rack section 324D. Each gusset 376 of the first rack section 322D is coupled to a corresponding gusset 376 of the second rack section 324D by a bolt 378. In some embodiments, a connector (such as connector 360′) internal to the first leg unit 332D of the first rack section 322D projects into, and couples with, the first leg unit 332D of the second rack section 324D. In some embodiments, a connector (such as connector 360′) internal to the second leg unit 334D of the first rack section 322D projects into, and couples with, the second leg unit 334D of the second rack section 324D.

It is contemplated that a lowermost rack section 320D of the rack assembly 300D may be mounted to the base 110 of the lift system 100 or to the base 110′ of the lift system 100′ in any one of the ways described above for the rack assembly 300A. It is further contemplated that a lowermost rack section 320D of the rack assembly 300D may be mounted to the car body 212 of the lift system 200 in any one of the ways described above for the rack assembly 300A. It is further contemplated that a lowermost rack section 320D of the rack assembly 300D may be mounted to the base 510 of the lift system 500 in any one of the ways described above for the rack assembly 300A. It is further contemplated that a lowermost rack section 320D of the rack assembly 300D may be mounted to the base 710 of the lift system 700 in any one of the ways described above for the rack assembly 300A.

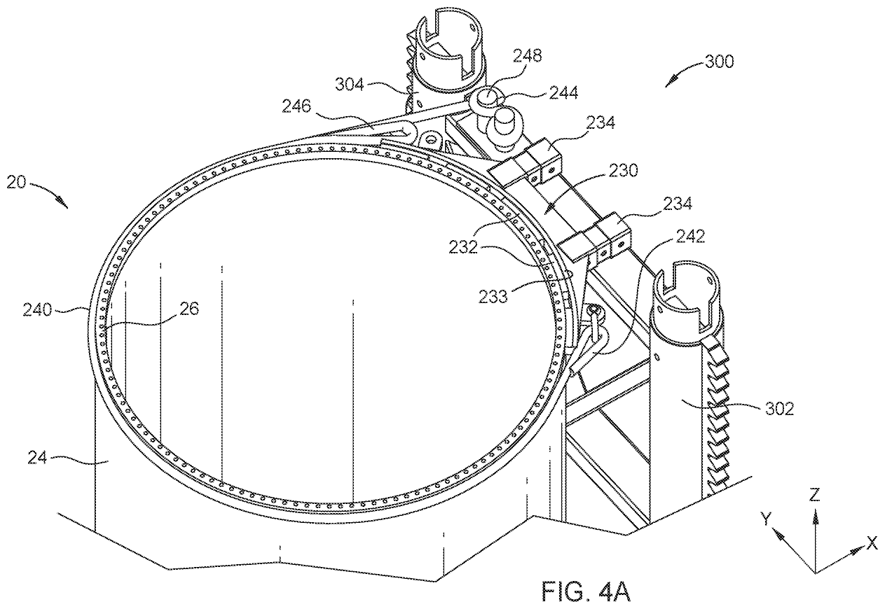

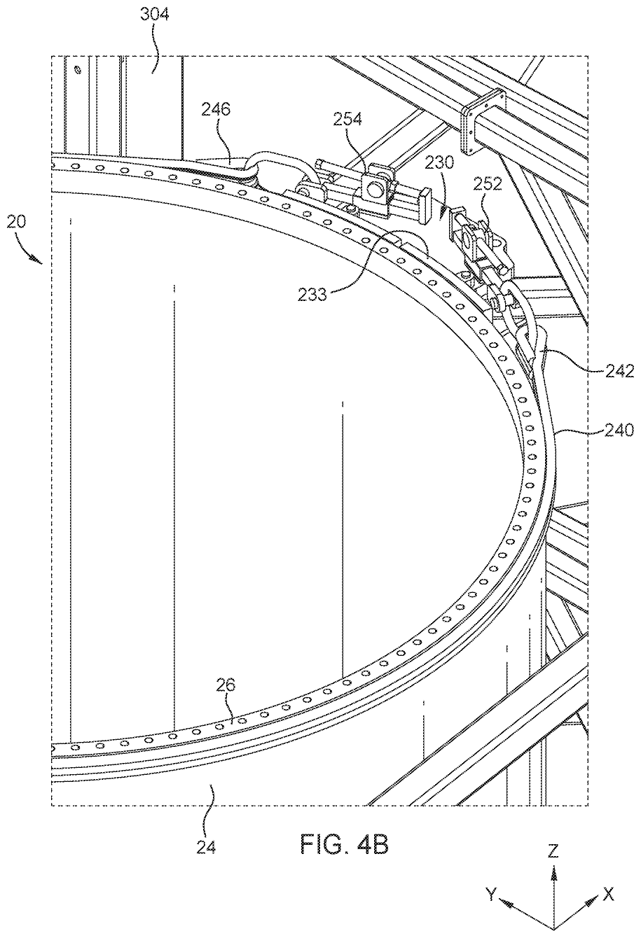

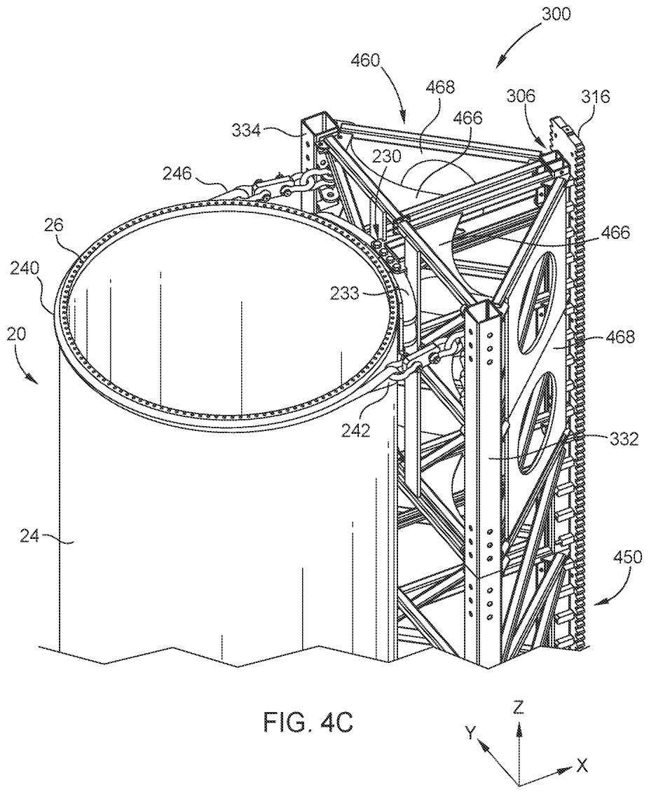

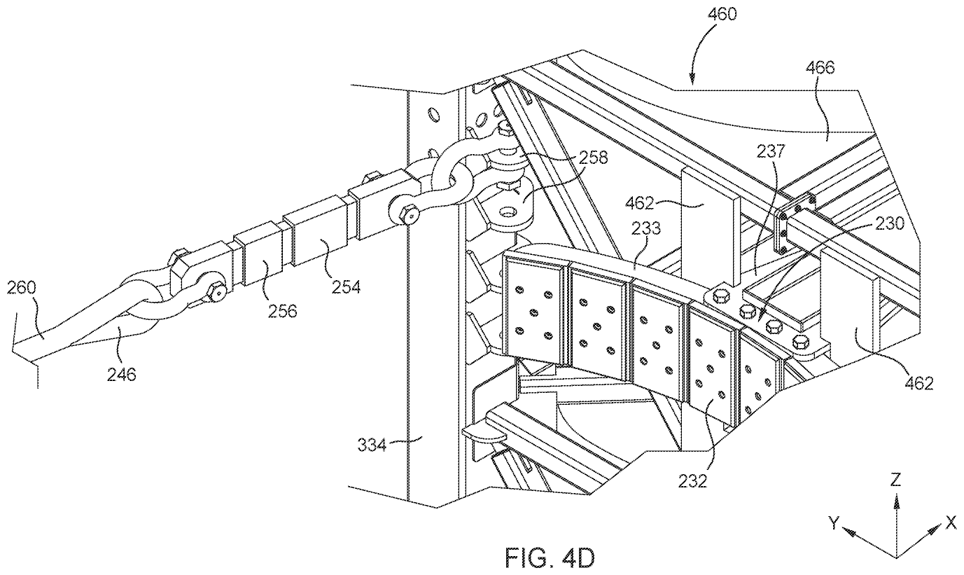

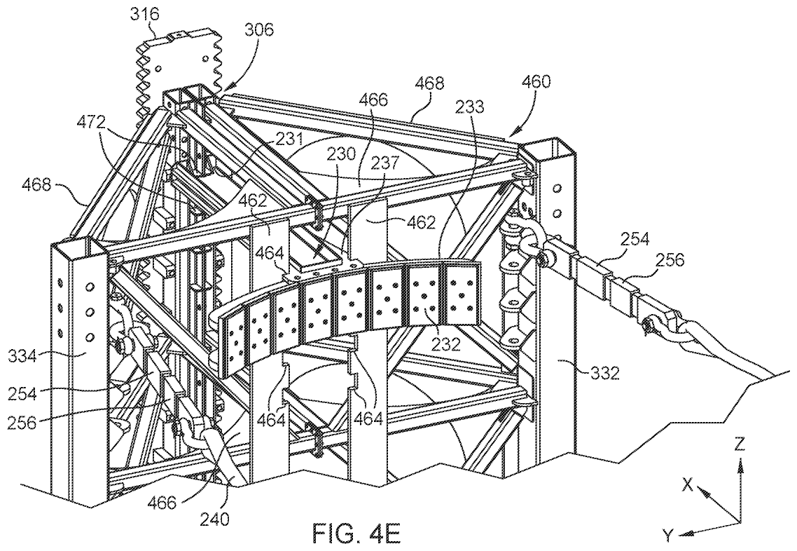

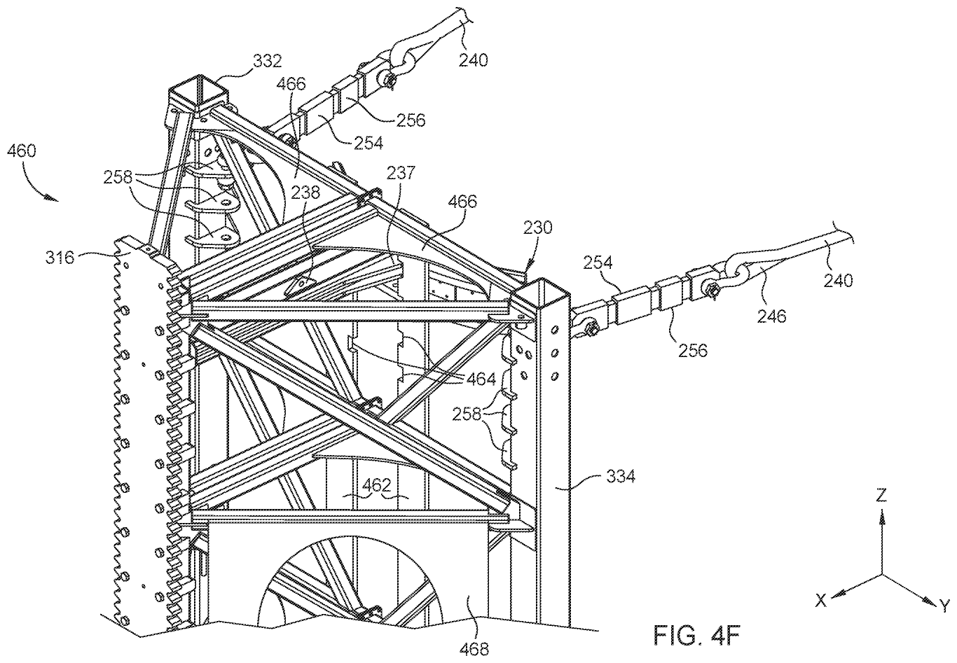

FIGS. 4A to 4F schematically illustrate the coupling of any of the lift system 100, the lift system 100′, the lift system 200, the lift system 500, or the lift system 700 to a structure 20. In the illustrated example, the structure 20 is a tower, and a tower section 24 is shown. The lift system 100, 100′, 200, 500, 700 is coupled to the structure (here, the tower section 24) at the rack assembly 300. As illustrated in FIG. 4A, the rack assembly 300 is coupled to the tower section 24 by one or more stand-off braces 230 and one or more straps 240. Each stand-off brace 230 and each strap 240 are positioned at a portion of the tower section 24 proximal to a flange 26 of the tower section 24. It is contemplated that the portion of the tower section 24 proximal to the flange 26 may be more resistant to collapse loading than other portions of the tower section 24. Nevertheless, in some embodiments, the stand-off brace 230 and/or the strap 240 may be positioned at a portion of the tower section 24 distal from the flange 26.

The stand-off brace 230 maintains a minimum separation between the rack assembly 300 and the tower section 24. As illustrated, in some embodiments, the stand-off brace 230 is shaped to match the external shape of the tower section 24. However, in some embodiments, the stand-off brace 230 is not shaped to match the external shape of the tower section 24. One or more contact pads 232 attached to a cradle 233 of the stand-off brace 230 provide protection for the tower section 24 against scratching or denting by the stand-off brace 230. In some embodiments, the one or more contact pads 232 are elastically deformable to accommodate a mismatch between the shape/size of the stand-off brace 230 and the shape/size of the tower section 24. In some embodiments, the one or more contact pads 232 may be omitted.

As illustrated, in some embodiments, the stand-off brace 230 is connected to the rack assembly 300 by one or more actuators 234. In an example, the one or more actuators 234 include a piston and cylinder that is driven hydraulically or pneumatically. In another example, the one or more actuators 234 include a screw thread. Relative rotation of a nut with respect to the screw thread advances or retracts the stand-off brace 230. The one or more actuators 234 move the cradle 233 and contacts pads 232 of the stand-off brace 230 into (and out of) contact with the tower section 24.

In some embodiments, the cradle 233 and contacts pads 232 of the stand-off brace 230 are assembled into a preset position on a rack section 320 before the rack section 320 is coupled to the rack assembly 300. The preset position of the cradle 233 and contacts pads 232 facilitates the minimum separation between the rack assembly 300 and the tower section 24 upon the rack section 320 being installed on the rack assembly 300.

The strap 240 maintains a maximum separation between the rack assembly 300 and the tower section 24. Examples of the strap 240 include rope, wire, cord strapping, metal strapping, plastic strapping, and the like. As illustrated, a first end 242 of the strap 240 is attached to the rack assembly 300 via the stand-off brace 230. However, in some embodiments, the first end 242 of the strap 240 is attached to the rack assembly 300 without being attached to the stand-off brace 230. The strap 240 is positioned around the tower section 24. The strap 240 includes a loop 246 proximal to a second end 244. In some embodiments, when fitting the strap 240, a tensioner is coupled to the loop 246 and to the rack assembly 300. The tensioner applies tension to the strap 240 by pulling the loop 246 toward the rack assembly 300. When a desired magnitude of tension has been applied, the second end 244 of the strap 240 is secured at the rack assembly 300, such as by tying off at a cleat 248. In some embodiments, the strap 240 is tensioned using a capstan.

FIG. 4B schematically illustrates an embodiment in which tensioners 252 and 254 are located on the stand-off brace 230. The first end 242 of the strap 240 is coupled to tensioner 252. The strap 240 terminates at the loop 246, which is coupled to tensioner 254. The tensioners 252, 254 may be driven mechanically (such as by a portable impact wrench), electrically (such as by a motor or solenoid), or by a fluid (such as by a pneumatic or hydraulic piston and cylinder). In some embodiments, each tensioner 252, 254 includes a load cell. Additionally, or alternatively, a load cell may be coupled to one or more of the tensioners 252, 254.

FIGS. 4C to 4F schematically illustrate some embodiments of the coupling of any of the lift system 100, the lift system 100′, the lift system 200, the lift system 500, or the lift system 700 to a structure 20. In FIGS. 4D to 4F, the structure 20 is omitted for clarity.

The rack assembly 300 is shown including a standard rack section 450 and a stand-off rack section 460. The standard rack section 450 may be any of rack section 320, 320A, 320B, 320C, or 320D. As illustrated, in some embodiments, the stand-off brace 230 and the strap 240 are omitted from the standard rack section 450. In some embodiments, at least one of the stand-off brace 230 or the strap 240 are present on the standard rack section 450.

The stand-off rack section 460 includes a stand-off brace 230 and a strap 240. The stand-off brace 230 may be situated at any one of multiple locations (arranged vertically) on the stand-off rack section 460. The multiple locations facilitate appropriate vertical alignment of the stand-off brace 230 with the flange 26 of the tower section 24. In an example best shown in FIGS. 4E and 4F, the stand-off rack section 460 includes one or more locator plates 462 coupled between the leg units 322, 324. The one or more locator plates 462 include slots 464 that are separated vertically. The stand-off brace 230 includes one or more flanges 237, each flange 237 engaged with a corresponding slot 464. Each flange 237 may be secured to the corresponding locator plate 462, such as by bolting to brackets (not shown). In some embodiments (shown in FIG. 4E), the rear end 231 of the stand-off brace 230 is coupled to the buttress leg 306 of the stand-off rack section 460, such as by bolting to one of more brackets 472. In some embodiments, the stand-off brace 230 is coupled to the stand-off rack section 460 via a lift eye 238 (shown in FIG. 4F).

As shown in FIGS. 4D to 4F, the strap 240 may be situated at any one of multiple locations (arranged vertically) on the stand-off rack section 460. The multiple locations facilitate appropriate vertical alignment of the strap 240 with the flange 26 of the tower section 24. In some embodiments, lugs 258 at the multiple locations facilitate coupling the strap 240 to the stand-off rack section 460. The lugs 258 connect the strap 240 to the leg units 322, 324 of the stand-off rack section 460. The strap 240 is coupled to the tensioners 252, 254 as described above, each of which is coupled to a corresponding lug 258. As illustrated, in some embodiments, each tensioner is coupled to a separate load cell 256. In some embodiments, each tensioner 252, 254 includes a load cell. In some embodiments, the separate load cells 256 may be omitted.

In some embodiments, the stand-off rack section 460 includes supplementary structural bracing compared to the standard rack section 450. As shown in FIG. 4C, in some embodiments, the supplementary structural bracing is in the form of one or more gussets 466 or one or more plates 468 attached to the superstructure of the stand-off rack section 460. The supplementary bracing provides the stand-off rack section 460 with additional resistance to torsional and bending loads compared to the standard rack section 450. It is contemplated that a carriage (such as carriage 120, 120′, 520) will be positioned at a stand-off rack section 460 during the execution of an activity, such as slewing a crane on the carriage, manipulating a component of the structure 20, installing a component onto the structure 20, removing a component from the structure 20, manipulating a component of the rack assembly 300, installing a component onto the rack assembly 300, removing a component from the rack assembly 300, or the like.

FIGS. 5A to 5D schematically illustrate arrangements of selected motors 132 and pinions 134 of the lift systems 100, 100′, 200, 500, 700 in further detail. FIGS. 5A and 5B show an exemplary configuration for use when the rack assembly 300 is represented by the rack assembly 300A or the rack assembly 300B. FIG. 5A is an isometric view of a portion of the carriage 120 with the motors 132, whereas the same view is presented in FIG. 5B without the carriage 120.

The motors 132 are mounted to the carriage 120. A corresponding pinion 134 is mounted to each motor 132, and each corresponding pinion 134 is engaged with the first set of outwardly-projecting teeth 318-1 of the rack assembly 300. Although not in view, similar arrangement is contemplated at the second set of outwardly-projecting teeth 318-2 of the rack assembly 300, in which additional motors 132 are mounted to the carriage 120. A corresponding pinion 134 is mounted to each additional motor 132, and each corresponding pinion 134 is engaged with the second set of outwardly-projecting teeth 318-2. In some embodiments, the motors 132 are electrically-driven. In some embodiments, the motors 132 are hydraulically-driven.

Guide rollers 142 are mounted to the carriage 120. A first set 144 of guide rollers 142 is engaged with the first leg 302 of the rack assembly 300, and a second set 146 of guide rollers 142 is engaged with the second leg 304 of the rack assembly 300. As best shown in FIG. 5B, in each set 144, 146 of guide rollers 142, at least one guide roller 142 is mounted above a level of a pinion 134, and at least one guide roller 142 is mounted below the level of the pinion 134. In some embodiments, at least one guide roller 142 of each set 144, 146 of guide rollers 142 is mounted between two pinions 134 at the corresponding first or second leg 302/304 of the rack assembly 300. As illustrated, in some embodiments, there are no guide rollers 142 mounted between two pinions 134 at the corresponding first or second leg 302/304 of the rack assembly 300.

As best shown in FIG. 5B, a pair of guide rollers 142 is mounted to engage opposite sides of the first leg 302 above the level of a pinion 134, and another pair of guide rollers 142 is mounted to engage opposite sides of the first leg 302 below the level of the pinion 134. A similar arrangement is contemplated at the second leg 304 of the rack assembly 300, such that a pair of guide rollers 142 is mounted to engage opposite sides of the second leg 304 above the level of a pinion 134, and another pair of guide rollers 142 is mounted to engage opposite sides of the second leg 304 below the level of the pinion 134.

In some embodiments, at least one guide roller 142 engaged with the first leg 302 and at least one guide roller 142 engaged with the second leg 304 each include a load pin 148. The load pins 148 are utilized to measure lateral loads resulting from engagement of the corresponding guide rollers 142 with the respective first or second leg 302/304. In some embodiments, each guide roller 142 in each set of guide rollers 142 includes a load pin 148.

FIG. 5C is a plan view of an exemplary configuration for use when the rack assembly 300 is represented by the rack assembly 300C. The carriage 120 has been omitted for clarity. One or more motors 132 each drive a corresponding pinion 134 that is engaged with either the first set or the second set of outwardly-projecting teeth 318-1/318-2 of the rack 316. It is contemplated that the number of motors 132 driving the pinions 134 that engage the first set of outwardly-projecting teeth 318-1 equals the number of motors 132 driving the pinions 134 that engage the second set of outwardly-projecting teeth 318-2.

As with the configuration described above, guide rollers 142 are mounted to the carriage 120. Similarly, a first set 144 of guide rollers 142 is engaged with the first leg 302 of the rack assembly 300, and a second set 146 of guide rollers 142 is engaged with the second leg 304 of the rack assembly 300.

In some embodiments, in each set 144, 146 of guide rollers 142, at least one guide roller 142 is mounted above a level of a pinion 134, and at least one guide roller 142 is mounted below the level of the pinion 134. In some embodiments, at least one guide roller 142 of each set 144, 146 of guide rollers 142 is mounted between two pinions 134 at the corresponding first or second leg 302/304 of the rack assembly 300. In some embodiments, there are no guide rollers 142 mounted between two pinions 134 at the corresponding first or second leg 302/304 of the rack assembly 300. In some embodiments, at least one guide roller 142 of each set 144, 146 of guide rollers 142 is mounted at the corresponding first or second leg 302/304 of the rack assembly 300 at the same level as a pinion 134.

In some embodiments, a pair of guide rollers 142 is mounted to engage opposite sides of the first leg 302 above the level of a pinion 134, and another pair of guide rollers 142 is mounted to engage opposite sides of the first leg 302 below the level of the pinion 134. In some embodiments, a pair of guide rollers 142 is mounted to engage opposite sides of the second leg 304 above the level of a pinion 134, and another pair of guide rollers 142 is mounted to engage opposite sides of the second leg 304 below the level of the pinion 134.

As illustrated, in some embodiments, lateral guide rollers 143 are mounted to engage the first or second leg 302/304. The lateral guide rollers 143 are mounted on the carriage 120, and are oriented substantially perpendicularly to the guide rollers 142. In some embodiments, the lateral guide rollers 143 are omitted. In some embodiments, non-rolling pads are used in place of the lateral guide rollers 143.

In some embodiments, at least one guide roller 142 engaged with the first leg 302 and at least one guide roller 142 engaged with the second leg 304 each include a load pin 148. The load pins 148 are utilized to measure lateral loads resulting from engagement of the corresponding guide rollers 142 with the respective first or second leg 302/304. In some embodiments, each guide roller 142 in each set of guide rollers 142 includes a load pin 148.

In some embodiments, at least one lateral guide roller 143 engaged with the first leg 302 and at least one lateral guide roller 143 engaged with the second leg 304 each include a load pin 148. The load pins 148 are utilized to measure lateral loads resulting from engagement of the corresponding lateral guide rollers 143 with the respective first or second leg 302/304. In some embodiments, each lateral guide roller 143 includes a load pin 148.

FIG. 5D is a plan view of an exemplary configuration for use when the rack assembly 300 is represented by the rack assembly 300D. The carriage (such as any carriage disclosed herein) has been omitted for clarity. One or more motors 132 each drive a corresponding pinion 134 that is engaged with either the first set or the second set of outwardly-projecting teeth 318-1/318-2 of the rack 316. It is contemplated that the number of motors 132 driving the pinions 134 that engage the first set of outwardly-projecting teeth 318-1 equals the number of motors 132 driving the pinions 134 that engage the second set of outwardly-projecting teeth 318-2.

Guide pads 141 are mounted to the carriage (not shown). Each guide pad 141 is configured to make sliding contact with a portion of the rack assembly 300. Exemplary materials of the guide pads 141 include high density polyethylene (HDPE), ultra high molecular weight (UHMW) polyethylene, and the like. In some examples, the material of the guide pads 141 is oil-impregnated. At least one guide pad 141 contacts the first leg 302 of the rack assembly 300, and at least one guide pad 141 contacts the second leg 304 of the rack assembly 300. In some embodiments, at least one guide pad 141 contacts an outward-facing surface of the rack 316.

In some embodiments, at least one guide pad 141 is located above the level of a pinion 134. In some embodiments, at least one guide pad 141 is located at the same level as a pinion 134. In some embodiments, at least one guide pad 141 is located below the level of a pinion 134. In some embodiments, at least one guide pad 141 extends from a location above the level of a pinion 134 to a location below the level of the pinion 134.

In some embodiments, one or more guide pads 141 may be utilized instead of, or additional to, one or more guide rollers (such as one or more guide rollers 142 or one or more lateral guide rollers 143) with any one of rack assembly 300A, rack assembly 300B, or rack assembly 300C. In some embodiments, one or more guide rollers (such as one or more guide rollers 142 or one or more lateral guide rollers 143) may be utilized instead of, or additional to, one or more guide pads 141 with any one of rack assembly 300D.

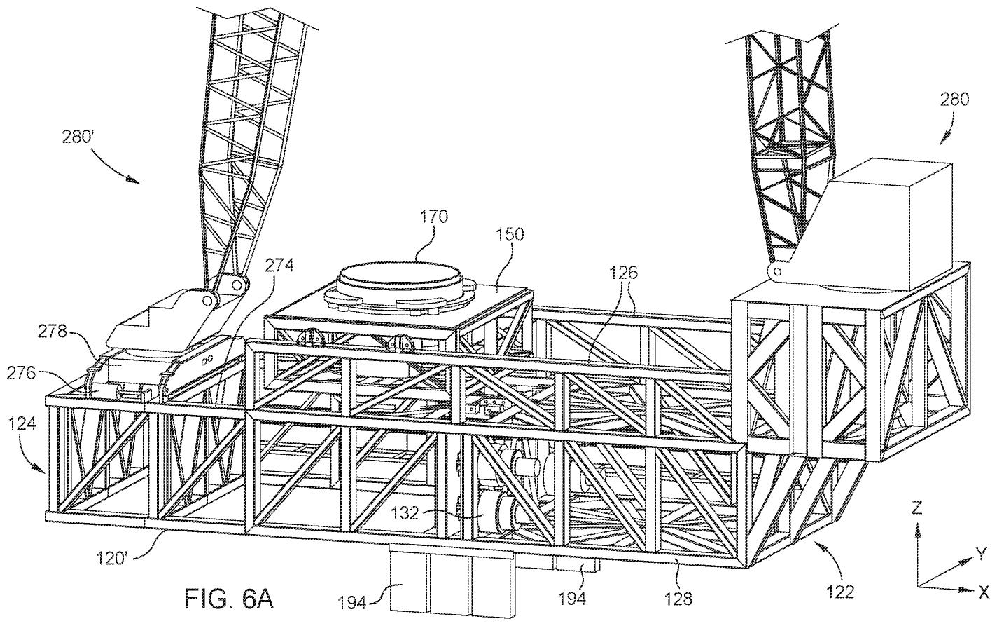

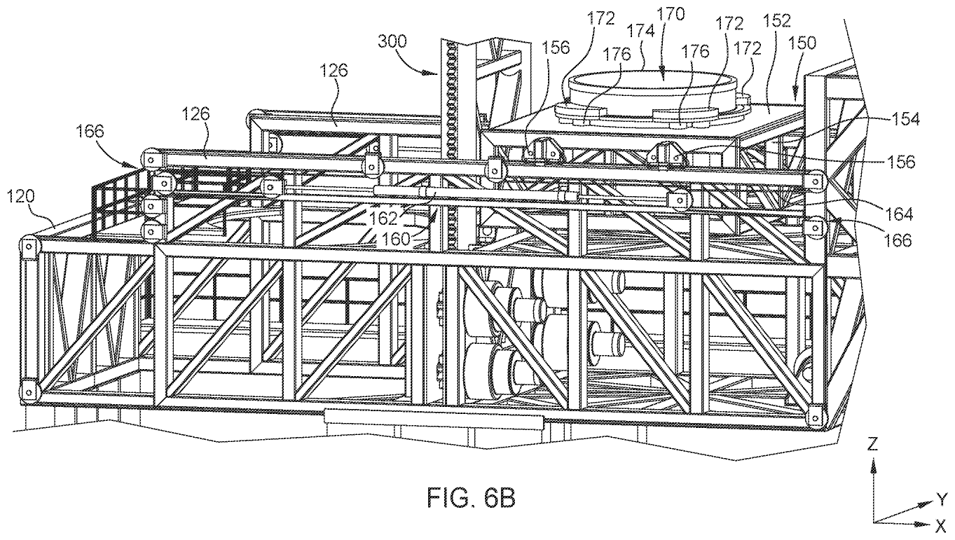

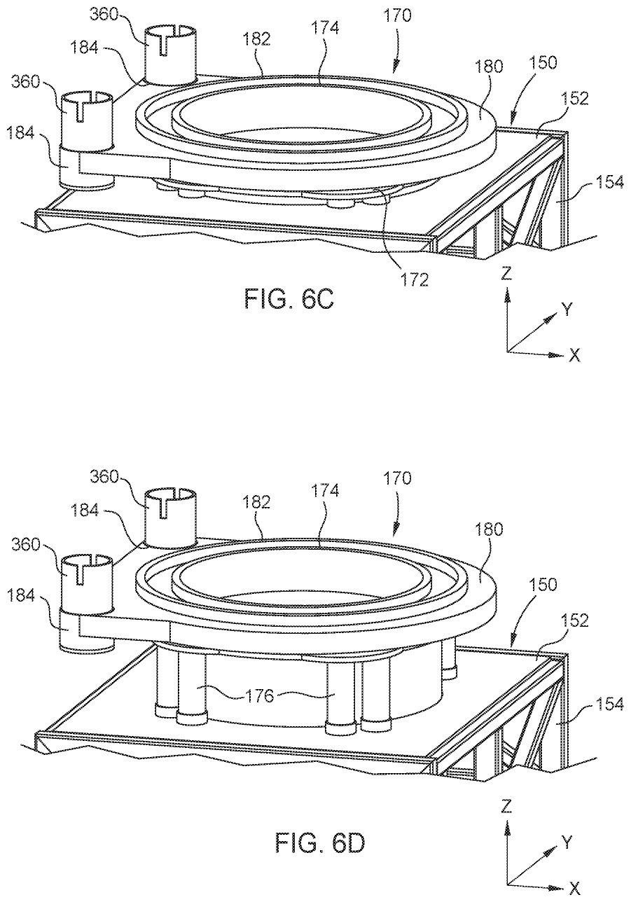

FIG. 6A schematically illustrates a carriage 120′ that may be used in place of carriage 120 with any of the lift systems 100, 100′, 200, 500, or 700. As illustrated, in some embodiments, the carriage 120′ is in the form of a cage. It is contemplated that the carriage 120′ may be transported to a work site in two or more separate sections, and assembled at the work site. It is contemplated that upon assembly, the carriage 120′ encircles the rack assembly 300 (not shown) and the structure 20 (not shown). In some embodiments, the carriage 120′ includes a door or a removable section that facilitates placement of the carriage 120′ around the structure 20.

As with the carriage 120, a plurality of motors 132 are mounted to the carriage 120′. The motors 132 drive corresponding pinions that engage the rack assembly 300 (not shown), as described above. As with the carriage 120, in each lift system 100/100′/200 incorporating the carriage 120′, the trolley 150 is mounted on a pair of rails 126 of the carriage 120′, and the stool 170 is mounted on the trolley 150. The trolley and stool 170 are movable with respect to the carriage 120′ as described herein with respect to the carriage 120.

As with the carriage 120, in each lift system 100/100′/200/500/700 incorporating the carriage 120′, a crane 280 is mounted at a first end 122 of the carriage 120′. The crane 280 may be of any form, as described herein. An additional crane 280′ is mounted at a second end 124 of the carriage 120′ opposite to the first end 122 at which the crane 280 is mounted. The crane 280′ may be of any form, as described herein with respect to the crane 280. As illustrated, the crane 280′ may include a chassis 278, such as a car body, coupled to one or more actuators 276. Exemplary actuators 276 may include corresponding pistons and cylinders. Additionally, or alternatively, exemplary actuators 276 may include motorized pinions that are engaged with one or more racks. Additionally, or alternatively, exemplary actuators 276 may include a winch or a driven chain. The one or more actuators 276 are configured to move the crane 280′ along rails 274 of the carriage 120′ between the first and second ends 122, 124 in a direction towards and away from the second end 124.

One or more movable counterweights 194 are attached to a bottom rail 128 at each side of the carriage 120′ between the first and second ends 122, 124. As described below, the one or more movable counterweights 194 can move along the bottom rails 128 of the carriage 120′ towards and away from each of the first end 122 and the second end 124. In some embodiments, one or more fixed counterweights, such as the fixed counterweights 192 (FIG. 1A) are attached to the carriage 120′ at the second end 124. As illustrated, in some embodiments, the one or more fixed counterweights are omitted.

FIGS. 6B to 6D schematically illustrate further details of the trolley 150 and of the stool 170 mounted on the trolley 150. In FIG. 6B, the trolley 150 is shown mounted on the carriage 120; nevertheless, the following description with respect to FIGS. 6B to 6D applies also to embodiments in which the trolley 150 is mounted on the carriage 120′. In other words, the carriage 120 may be replaced by the carriage 120′. The trolley 150 includes a platen 152 mounted on a frame 154. Wheel units 156 attached to the frame 154 facilitate movement of the trolley 150 along the rails 126 of the carriage 120/120′. In some embodiments, one or more of the wheel units 156 is driven by a motor to move the trolley 150 along the rails 126. In some embodiments, the trolley 150 is moved along the rails 126 by an actuator 160, such as a piston or a cable. In an example, the actuator 160 includes a rack and pinion. In another example, the actuator 160 includes a screw thread. Relative rotation of a nut with respect to the screw thread advances or retracts the trolley 150 along the rails 126. In the illustrated example, the actuator 160 includes a piston 162 coupled to a cable 164 and pulley system 166. In another example, the trolley 150 is moved by a cable 164 that is driven by a winch.

The stool 170 is disposed on the top of the trolley 150. FIG. 6B shows the stool 170 includes a platform 172. The platform 172 can be raised and lowered with respect to the trolley 150 by one or more jacks 176, each jack 176 including a piston and cylinder. In some embodiments, the stool 170 includes a profile 174 shaped and sized to facilitate positioning of equipment on the stool 170. Exemplary equipment includes tower sections, nacelles, and other apparatus to be placed on or in a tower. As illustrated, in some embodiments, the profile 174 protrudes above the platform 172. In the illustrated example, the profile 174 is cylindrical. In some embodiments, the profile 174 includes a recess in the platform 172.

FIG. 6C shows an adapter 180 positioned on the stool 170. The adapter 180 is shaped and sized to facilitate positioning of equipment on the stool 170. In the illustrated example, the adapter 180 fits around the profile 174 of the stool 170 and on the platform 172. The illustrated adapter 180 includes an adapter profile 182 that protrudes upwardly. In some embodiments, the adapter profile 182 includes a recess. The adapter profile 182 alone, or in combination with the profile 174 of the stool 170, is shaped and sized to facilitate positioning of equipment on the stool 170.

The illustrated adapter 180 includes a secondary adapter profile 184 that is shaped and sized to facilitate positioning of a rack section 320A/320B/320C/320D on the stool 170. The illustrated secondary adapter profile 184 includes a connector 360 that is configured to engage with the bottom of a leg unit 332/332A-332D/334/334A-334D of a rack section 320/320A-320D. As shown, in some embodiments, the adapter 180 includes multiple secondary adapter profiles 184. In some embodiments, at least one secondary adapter profile 184 may be configured to engage a buttress unit 348/388. In some embodiments, the adapter 180 includes the adapter profile 182, but does not include a secondary adapter profile 184. In some embodiments, the adapter includes one or more secondary adapter profile 184, but does not include the adapter profile 182.

FIG. 6D shows the stool 170 raised with respect to the trolley 150. The stool 170 is raised by the one or more jacks 176. The profile 174 of the stool 170 is raised along with the stool 170. The adapter 180 is raised along with the stool 170. The one or more jacks 176 can lower the stool 170 and the adapter 180 with respect to the trolley 150, such as by allowing gravity to move the stool 170 and the adapter 180 downwards.

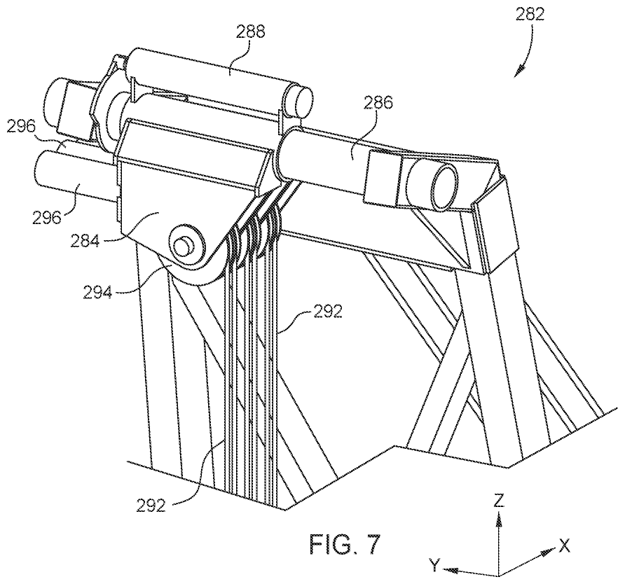

FIG. 7 schematically illustrates the top of the A-frame 282 that may be used as the crane 280 and/or as the crane 280′. A head unit 284 is mounted on an axle 286 of the A-frame 282. A piston assembly 288 is configured to move the head unit 284 along the axle 286. Lines 292 are suspended from the head unit 284. The lines 292 are configured to bear the weight of a load. The lines 292 are routed over sheaves 294 in the head unit 284, and are raised and lowered with respect to the head unit 284 by one or more pistons 296. The head unit 284 is rotationally movable relative to the axle 286. When the A-frame 282 pivots about a horizontal axis with respect to the carriage 120/120′, the head unit 284 can rotate about the axle 286 such that the sheaves 294 remain in a vertical orientation.

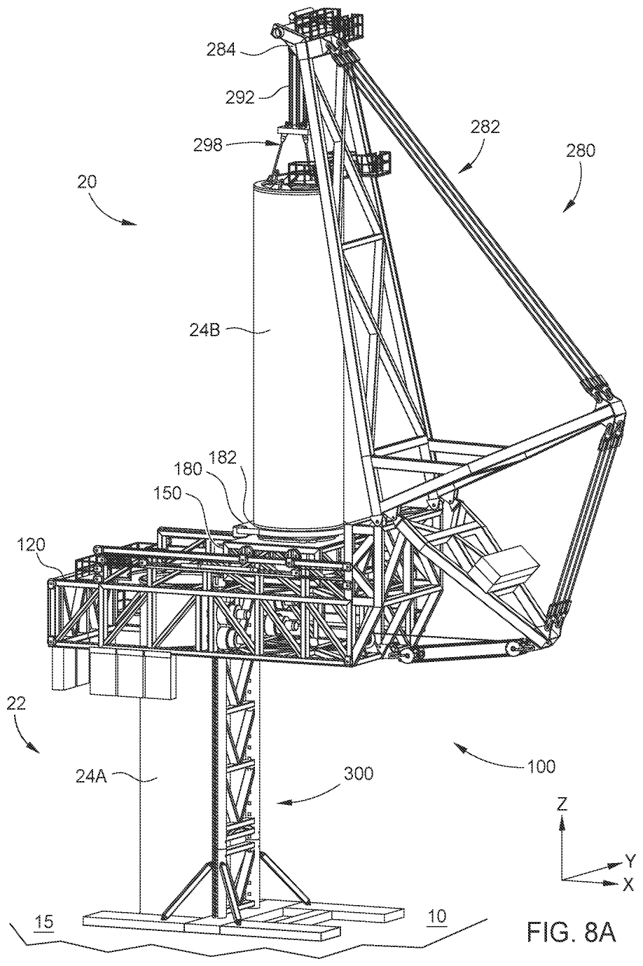

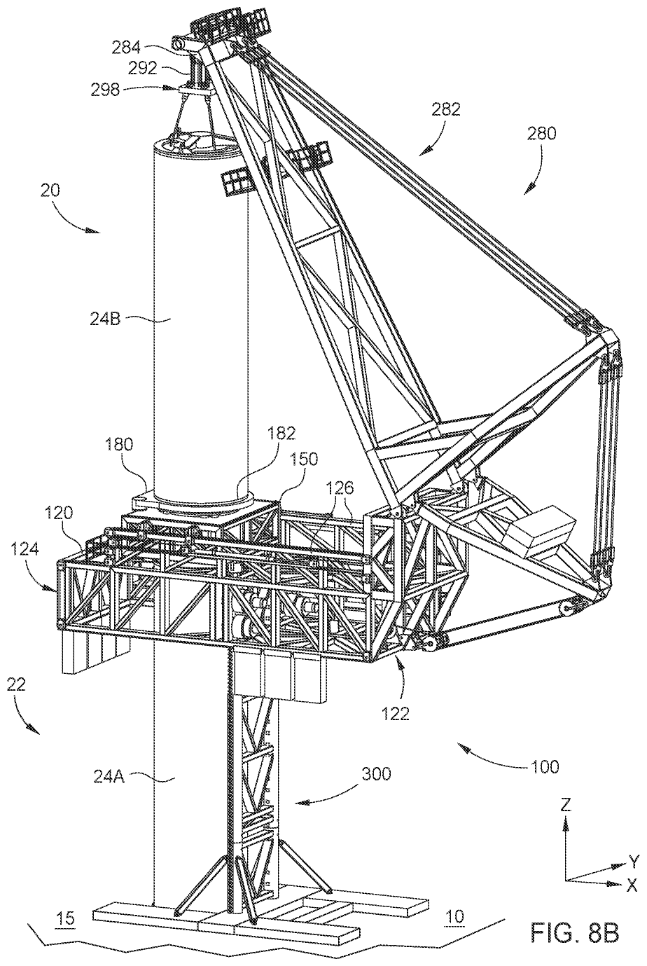

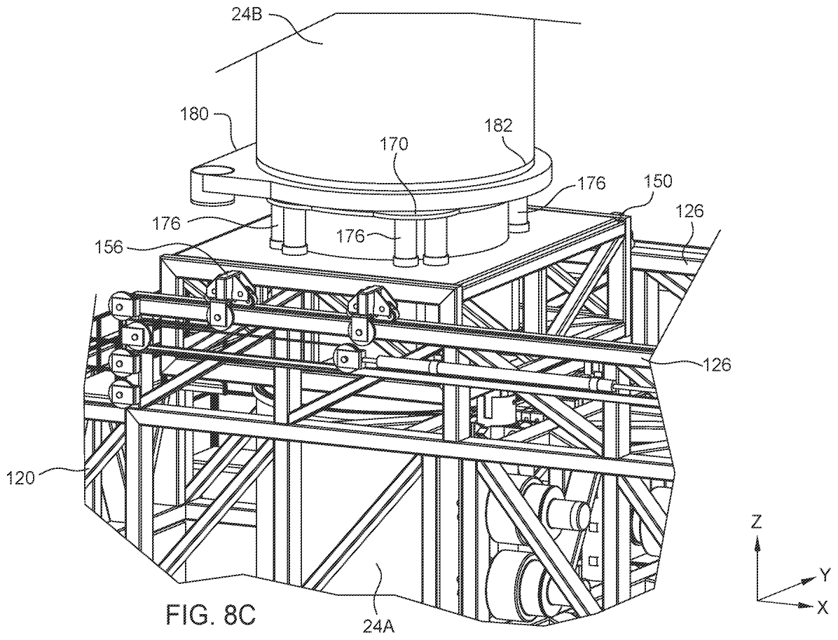

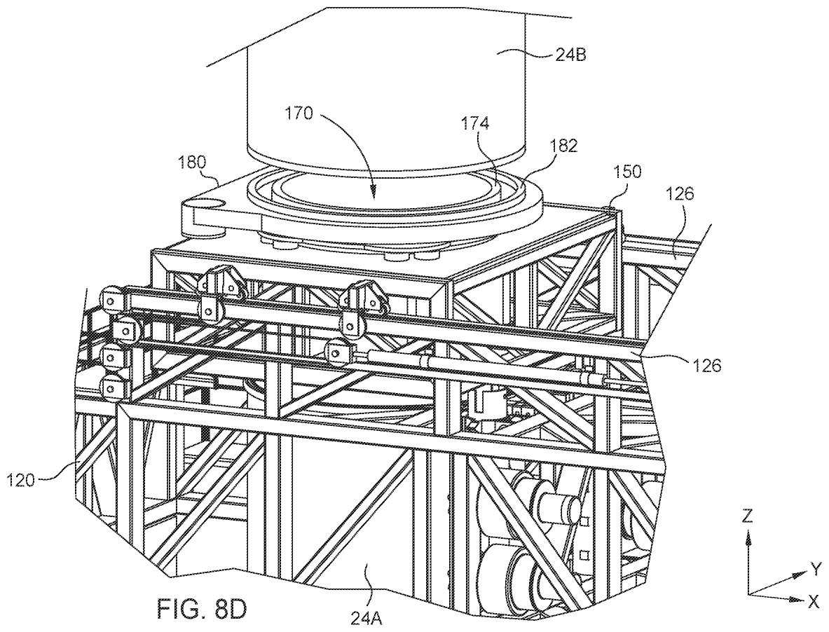

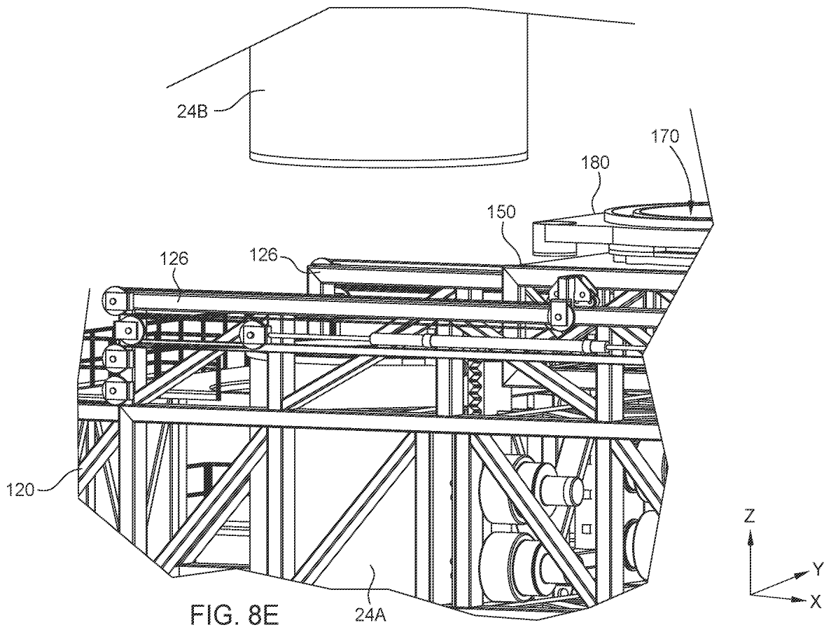

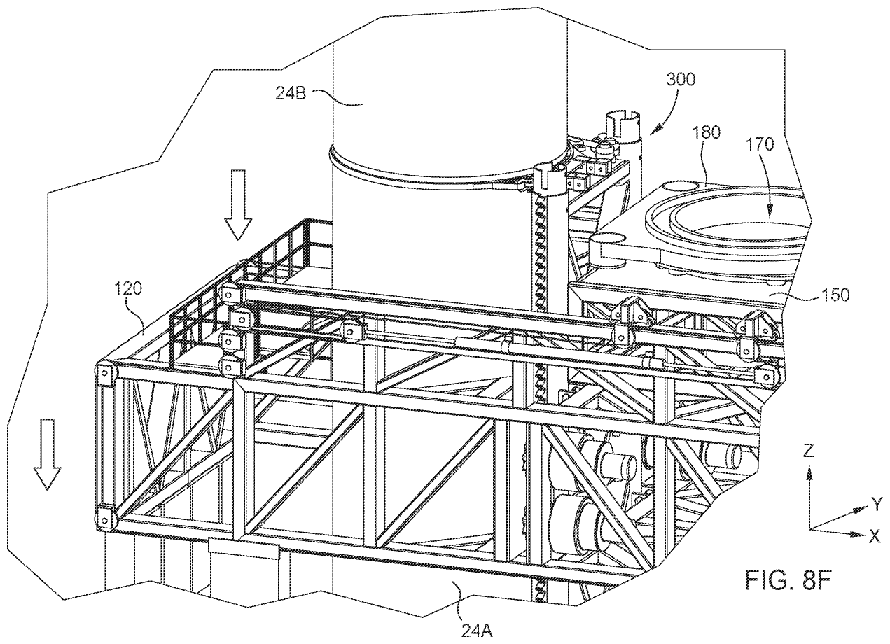

FIGS. 8A to 8F schematically illustrate the constructing of a structure 20. The illustrated example shows operations employed in the constructing of a tower 22. The operations are depicted involving the lift system 100, however the operations may be performed by any of the lift systems 100, 100′, or 200. Although the operations are depicted as being conducted on land, it is contemplated that the same operations may be conducted offshore, such as by using the lift system 100′. Although represented by rack assembly 300A, the rack assembly 300 may be any of the rack assemblies 300A, 300B, 300C, or 300D. Furthermore, the depicted carriage 120 may be replaced by the carriage 120′ in any land-based or offshore-based deployment. When the carriage 120′ is utilized, the (additional) crane 280′ may be mounted to the carriage 120′. When the carriage 120′ is utilized, the constructing of the structure 20 may be accomplished using the crane 280 or the crane 280′.

In FIG. 8A, the lift system 100 is adjacent a first tower section 24A that has been erected. The carriage 120 has been raised up the rack assembly 300 to the top of the first tower section 24A. The trolley 150 is on the carriage 120, and the stool 170 (obscured in this view) is on the trolley 150. A second tower section 24B is on the stool 170. In the illustrated example, the second tower section 24B is positioned on the adapter 180 on the stool 170, and is engaged with the adapter profile 182. The crane 280 is represented by the A-frame 282, and the top of the second tower section 24B is attached to the A-frame 282 via rigging 298 coupled to the lines 292 suspended from the head unit 284. The weight of the second tower section 24B is at least partially borne by the lines 292 suspended from the head unit 284 while the second tower section 24B is on the stool 170. In some embodiments, 50% or more of the weight of the second tower section 24B is borne by the lines 292 suspended from the head unit 284 while the second tower section 24B is on the stool 170. For example, the lines 292 suspended from the head unit 284 may bear 60% or more, 70% or more, 80% or more, 90% or more, or 95% or more of the weight of the second tower section 24B while the second tower section 24B is on the stool 170. In other embodiments, less than 50% of the weight of the second tower section 24B is borne by the lines 292 suspended from the head unit 284 while the second tower section 24B is on the stool 170.

In FIG. 8B, the trolley 150 is moved along the rails 126 of the carriage 120 towards the second end 124 of the carriage 120 to a position above the first tower section 24A. The A-frame 282 pivots about a horizontal axis with respect to the carriage 120 while the trolley 150 moves in order to maintain the second tower section 24B oriented vertically.

In FIG. 8C, the stool 170 is raised with respect to the trolley 150, such as by the jacks 176. The second tower section 24B is elevated by the stool 170 to a raised position. When the stool 170 is raised, the pistons 296 of the head unit 284 (FIG. 7) are actuated to pull on the lines 292 and take up slack in the lines 292.

In FIG. 8D, the stool 170 is lowered with respect to the trolley 150. The second tower section 24B is removed from the stool 170 as the stool 170 is lowered by maintaining tension in the lines 292 exerted by the pistons 296 of the head unit 284. When the second tower section 24B is removed from the stool 170, the entire weight of the second tower section 24B is borne by the A-frame 282 via the lines 292.

In some embodiments, the crane 280 lifts the second tower section 24B off the stool 170 without the stool 170 being raised and lowered by activating the jacks 176. For example, in embodiments in which the crane 280 includes a winch, the winch is used to apply tension to the lines 292 attached to the second tower section 24B via the rigging 298 to lift the second tower section 24B off the stool 170. In the illustrated example in which the crane 280 is represented by the A-frame 282, the pistons 296 of the head unit 284 may be actuated to pull on the lines 292 to lift the second tower section 24B off the stool 170.

In FIG. 8E, the trolley 150 with the stool 170 is moved away from the second tower section 24B towards the first end 122 of the carriage 120 along the rails 126. The trolley 150 is now no longer between the second tower section 24B and the first tower section 24A.

In FIG. 8F, the carriage 120 is moved down the rack assembly 300 and is thereby lowered with respect to the first tower section 24A. The trolley 150, the stool 170, the adapter 180, and the A-frame 282 are moved down with the carriage 120. The second tower section 24B is lowered with the carriage 120. The carriage 120 is lowered with respect to the first tower section 24A sufficiently to place the second tower section 24B on the first tower section 24A. The second tower section 24B is then secured to the first tower section 24A such as by bolting together corresponding internal flanges of the first and second tower sections 24A, 24B, respectively. Additionally, the second tower section 24B is released from the rigging 298 and the lines 292.

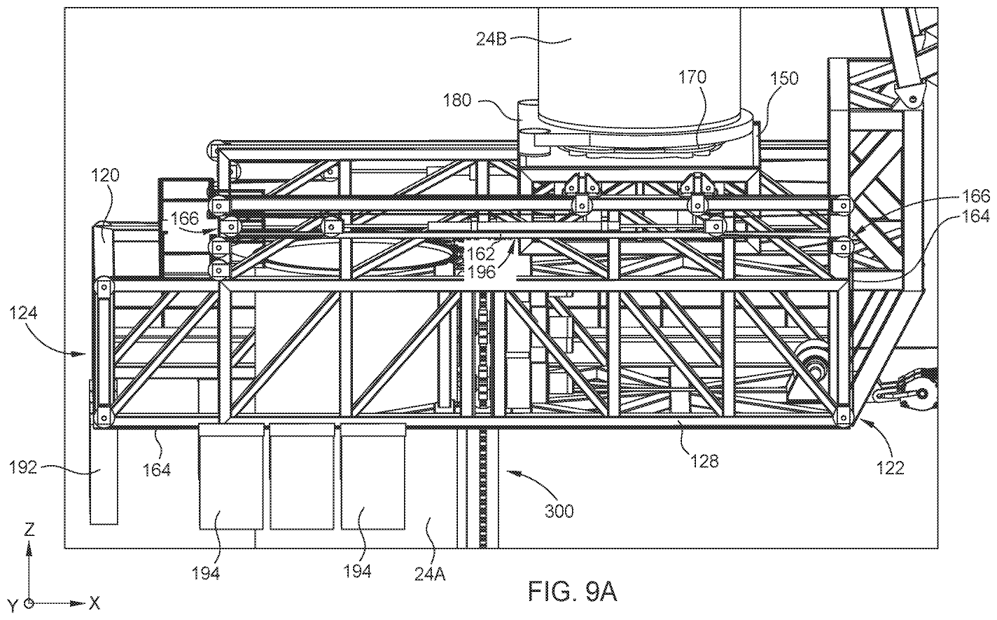

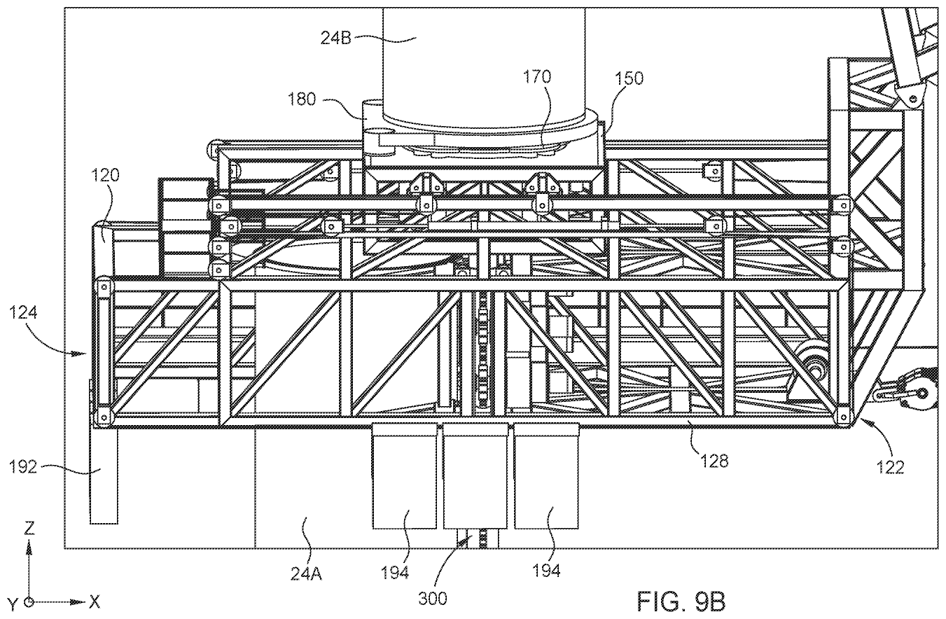

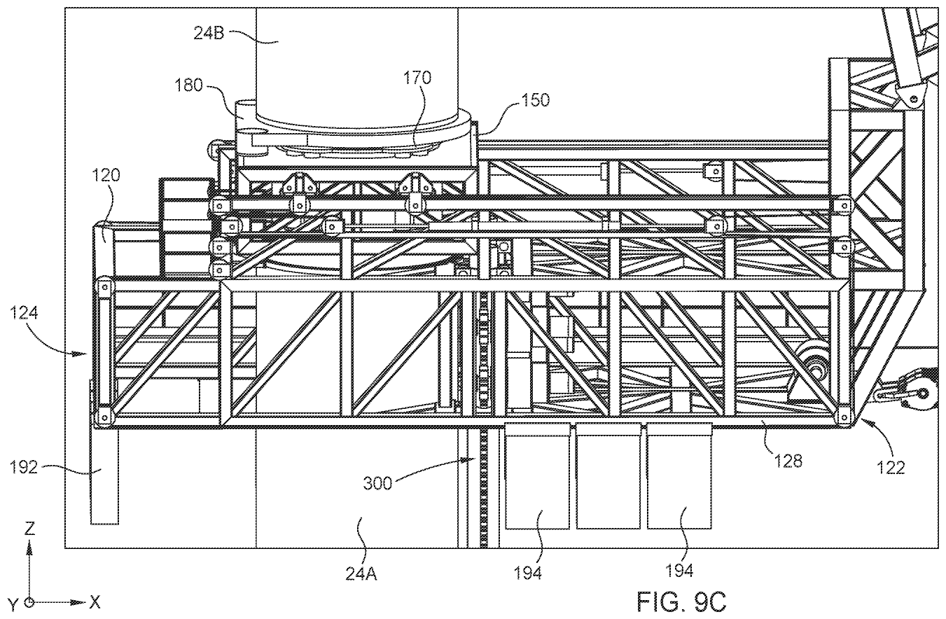

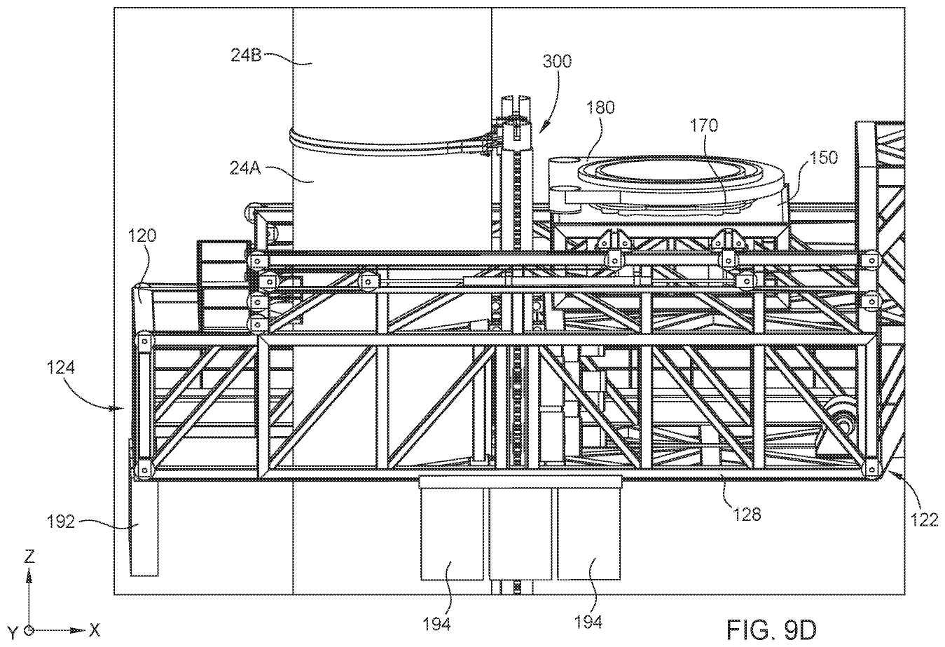

FIGS. 9A to 9D schematically illustrate the positioning of the movable counterweights 194 during the operations described above. The movable counterweights 194 are suspended from the bottom rails 128 of the carriage 120. As described above, the depicted carriage 120 may be replaced by the carriage 120′. In some embodiments, the movable counterweights 194 are moved along the bottom rails 128 by an actuator 196, such as a piston or a cable. In an example, the actuator 196 includes a cable that is driven by a winch. In another example, the actuator 196 includes a rack and pinion. In another example, the actuator 196 includes a screw thread. Relative rotation of a nut with respect to the screw thread advances or retracts the movable counterweights 194 along the bottom rails 128. In the illustrated example, the actuator 196 includes the piston 162 coupled to the cable 164 and pulley system 166 that also moves the trolley 150. In a further example, the movable counterweights 194 are coupled to an actuator 196 that is separate from the actuator 160 that moves the trolley 150.

As described above, the trolley 150 is moved transversely along the rails 126 towards and away from each of the first end 122 and the second end 124. The movable counterweights 194 are moved towards and away from each of the first end 122 and the second end 124. In some embodiments, the trolley 150 and the movable counterweights 194 are moved simultaneously. In some embodiments, the trolley 150 and the movable counterweights 194 are not moved simultaneously. In an example the trolley 150 is moved before the movable counterweights 194 are moved. In another example the trolley 150 is moved after the movable counterweights 194 are moved.

In some embodiments, movement of the trolley 150 and the movable counterweights 194 occurs at least partially simultaneously. In an example, movement of the trolley 150 commences before movement of the movable counterweights 194, and movement of the movable counterweights 194 commences during the movement of the trolley 150. In another example, movement of the movable counterweights 194 commences before movement of the trolley 150, and movement of the trolley 150 commences during the movement of the movable counterweights 194.

FIGS. 9A to 9D are isometric side views in which the lift system 100/100′/200 is positioned such that the first tower section 24A is to the left of the rack assembly 300, between the rack assembly 300 and the second end 124 of the carriage 120, where the fixed counterweights 192 are positioned. Although represented by rack assembly 300A, the rack assembly 300 may be any of the rack assemblies 300A, 300B, 300C, or 300D. In embodiments in which the carriage 120 is replaced by the carriage 120′, the fixed counterweights 192 may be present or may be omitted. Additionally, in embodiments in which the carriage 120 is replaced by the carriage 120′, the additional crane 280′ may be present and located to the left of the rack assembly 300, or may be omitted.

The motors 132 are to the right of the rack assembly 300, between the rack assembly 300 and the first end 122 of the carriage 120, where the crane 280 (represented by the A-frame 282) is coupled to the carriage 120. The trolley 150, the stool 170, the adapter 180, and the second tower section 24B can be positioned to the left of the rack assembly 300, centered over the rack assembly 300 (from a left-right perspective), or to the right of the rack assembly 300. The movable counterweights 194 can be positioned to the left of the rack assembly 300, adjacent the rack assembly 300 (from a left-right perspective), or to the right of the rack assembly 300.

As viewed in FIGS. 9A to 9D, the portion of the carriage 120 plus the equipment and components attached thereto that are to the left of the rack assembly 300 (i.e. between the rack assembly 300 and the second end 124) may be referred to as the left-hand elements. Similarly, the portion of the carriage 120 plus the equipment and components attached thereto that are to the right of the rack assembly 300 (i.e. between the rack assembly 300 and the first end 122) may be referred to as the right-hand elements. The weight of the carriage 120 plus the equipment and components attached thereto is transferred to the rack assembly 300, such as via the pinions 134 and/or via wedge blocks coupled to the carriage 120 and moved into engagement with the first and second sets of outwardly-projecting teeth 318-1, 318-2 of the rack assembly 300. The equipment mounted on the carriage 120 that engages portions of the rack assembly (such as the pinions, the guide rollers 142, the lateral guide rollers 143, and/or the wedge blocks) collectively acts like a fulcrum between the left-hand elements and the right-hand elements.

During operations, such as the operations described above and further below, the movable counterweights 194 are positioned such that the left-hand elements are substantially balanced with the right-hand elements. In an example, the movable counterweights 194 are moved such that the moment exerted on the pinions 134 by the left-hand elements is from about 90% to about 110% of the moment exerted on the pinions 134 by the right-hand elements. In another example, the movable counterweights 194 are moved such that the moment exerted on the pinions 134 by the left-hand elements is from about 95% to about 105% of the moment exerted on the pinions 134 by the right-hand elements. In a further example, the movable counterweights 194 are moved such that the moment exerted on the pinions 134 by the left-hand elements is from about 98% to about 102% of the moment exerted on the pinions 134 by the right-hand elements.

Additionally, or alternatively, in an example, the movable counterweights 194 are moved such that the moment exerted on the wedge blocks (described above) by the left-hand elements is from about 90% to about 110% of the moment exerted on the wedge blocks by the right-hand elements. In another example, the movable counterweights 194 are moved such that the moment exerted on the wedge blocks by the left-hand elements is from about 95% to about 105% of the moment exerted on the wedge blocks by the right-hand elements. In a further example, the movable counterweights 194 are moved such that the moment exerted on the wedge blocks by the left-hand elements is from about 98% to about 102% of the moment exerted on the wedge blocks by the right-hand elements.

Additionally, or alternatively, in an example, the movable counterweights 194 are positioned such that the moment exerted on one or more selected guide rollers 142 by the left-hand elements is from about 90% to about 110% of the moment exerted on the one or more selected guide rollers 142 by the right-hand elements. In another example, the movable counterweights 194 are moved such that the moment exerted on the one or more selected guide rollers 142 by the left-hand elements is from about 95% to about 105% of the moment exerted on the one or more selected guide rollers 142 by the right-hand elements. In a further example, the movable counterweights 194 are moved such that the moment exerted on the one or more selected guide rollers 142 by the left-hand elements is from about 98% to about 102% of the moment exerted on the one or more selected guide rollers 142 by the right-hand elements.

In some embodiments, the carriage 120′ and the (additional) crane 280′ are utilized in a lift system 100/100′/200/500/700 instead of the carriage 120 without the crane 280′. During operations (such as the operations described above and further below) in such embodiments, the crane 280′ is moved towards or away from the second end 124 of the carriage 120′ along the rails 274 by the one or more actuators 276, as described above. The crane 280′ may be positioned such that the left-hand elements are substantially balanced with the right-hand elements. In some embodiments, the crane 280′ and the movable counterweights 194 are moved and positioned such that the left-hand elements are substantially balanced with the right-hand elements. In some embodiments, the movable counterweights 194 are not moved, but the crane 280′ is moved and positioned such that the left-hand elements are substantially balanced with the right-hand elements.

In an example, the crane 280′ is moved such that the moment exerted on the pinions 134 by the left-hand elements is from about 90% to about 110% of the moment exerted on the pinions 134 by the right-hand elements. In another example, the crane 280′ is moved such that the moment exerted on the pinions 134 by the left-hand elements is from about 95% to about 105% of the moment exerted on the pinions 134 by the right-hand elements. In a further example, the crane 280′ is moved such that the moment exerted on the pinions 134 by the left-hand elements is from about 98% to about 102% of the moment exerted on the pinions 134 by the right-hand elements.

Additionally, or alternatively, in an example, the crane 280′ is moved such that the moment exerted on the wedge blocks (described above) by the left-hand elements is from about 90% to about 110% of the moment exerted on the wedge blocks by the right-hand elements. In another example, the crane 280′ is moved such that the moment exerted on the wedge blocks by the left-hand elements is from about 95% to about 105% of the moment exerted on the wedge blocks by the right-hand elements. In a further example, the crane 280′ is moved such that the moment exerted on the wedge blocks by the left-hand elements is from about 98% to about 102% of the moment exerted on the wedge blocks by the right-hand elements.

Additionally, or alternatively, in an example, the crane 280′ is positioned such that the moment exerted on one or more selected guide rollers 142 by the left-hand elements is from about 90% to about 110% of the moment exerted on the one or more selected guide rollers 142 by the right-hand elements. In another example, the crane 280′ is moved such that the moment exerted on the one or more selected guide rollers 142 by the left-hand elements is from about 95% to about 105% of the moment exerted on the one or more selected guide rollers 142 by the right-hand elements. In a further example, the crane 280′ is moved such that the moment exerted on the one or more selected guide rollers 142 by the left-hand elements is from about 98% to about 102% of the moment exerted on the one or more selected guide rollers 142 by the right-hand elements.

In some embodiments, an indication of the degree of balance between the left-hand elements and the right-hand elements is obtained from measurements made by the load pins 148 of each guide roller 142 (FIGS. 5B, 5C). In some embodiments, an indication of the degree of balance between the left-hand elements and the right-hand elements is obtained from measurements made by one or more strain gauges attached to the carriage 120.

FIG. 9A shows the carriage 120 in the configuration as depicted in FIG. 8A. The weights of at least the carriage 120, the motors 132, the trolley 150, the stool 170, the adapter 180, the crane 280, the fixed counterweights 192, the movable counterweights 194, and the second tower section 24B are borne by the rack assembly 300. The trolley 150, the stool 170, the adapter 180, and the second tower section 24B are positioned to the right of the rack assembly 300. The fixed counterweights 192 and the movable counterweights 194 are positioned to the left of the rack assembly 300 in order to achieve a balance between the left-hand elements and the right-hand elements. The movable counterweights 194 are proximal to the second end 124 of the carriage 120.

FIG. 9B shows the trolley 150, the stool 170, the adapter 180, and the second tower section 24B in an intermediate position between the configuration as depicted in FIG. 8A and the configuration as depicted in FIG. 8B. The trolley 150, the stool 170, the adapter 180, and the second tower section 24B have been moved to be centered over the rack assembly 300. The movable counterweights 194 have been moved towards the first end 122 of the carriage 120, and are positioned adjacent the rack assembly 300 in order to achieve a balance between the left-hand elements and the right-hand elements. It is contemplated that the movable counterweights 194 may be positioned to be more to the left of the rack assembly 300 when the trolley 150, the stool 170, the adapter 180, and the second tower section 24B have been moved to be centered over the rack assembly 300. It is contemplated that the movable counterweights 194 may be positioned to be more to the right of the rack assembly 300 when the trolley 150, the stool 170, the adapter 180, and the second tower section 24B have been moved to be centered over the rack assembly 300.

FIG. 9C shows the carriage 120 in the configuration as depicted in FIG. 8B. The trolley 150, the stool 170, the adapter 180, and the second tower section 24B are positioned to the left of the rack assembly 300. The movable counterweights 194 have been moved from the position depicted in FIG. 9B towards the first end 122 of the carriage 120. In the illustrated example, the movable counterweights 194 are positioned to the right of the rack assembly 300 in order to achieve a balance between the left-hand elements and the right-hand elements.

FIG. 9D shows the carriage 120 in the configuration as depicted in FIG. 8F. The trolley 150, the stool 170, and the adapter 180 are positioned to the right of the rack assembly 300. The second tower section 24B is positioned on the first tower section 24A. The weight of the second tower section 24B is borne by the first tower section 24A, and is no longer borne by the rack assembly 300. The transfer of the weight of the second tower section 24B to the first tower section 24A affects the balance of the carriage 120. The movable counterweights 194 have been moved from the position depicted in FIG. 9C towards the second end 124 of the carriage 120. In the illustrated example, the movable counterweights 194 are positioned adjacent the rack assembly 300 in order to achieve a balance between the left-hand elements and the right-hand elements. It is contemplated that the movable counterweights 194 may be positioned to be more to the left of the rack assembly 300 when the weight of the second tower section 24B is transferred to be borne by the first tower section 24A. It is contemplated that the movable counterweights 194 may be positioned to be more to the right of the rack assembly 300 when the weight of the second tower section 24B is transferred to be borne by the first tower section 24A.

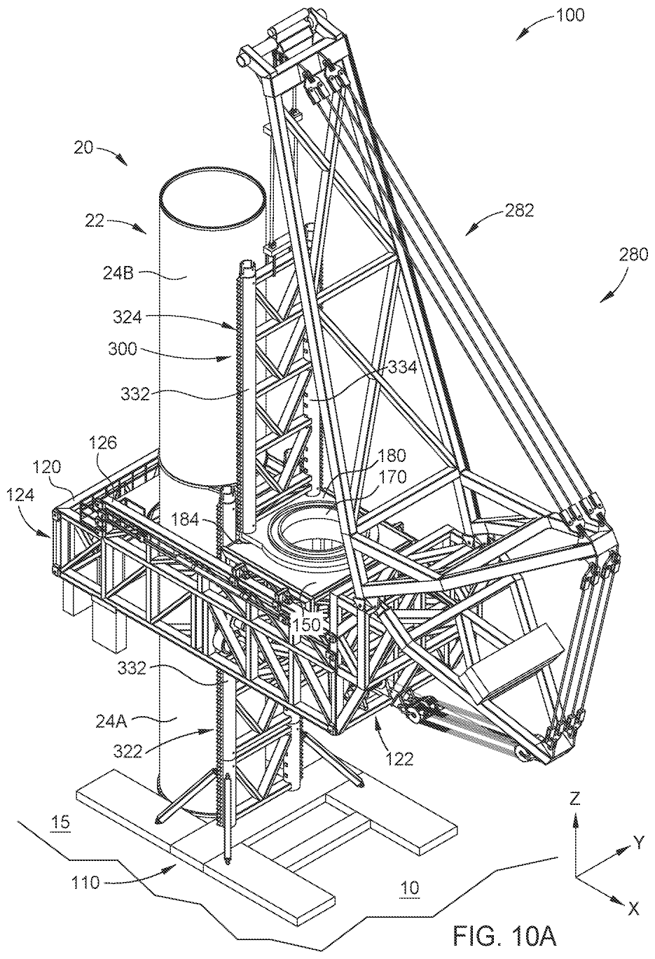

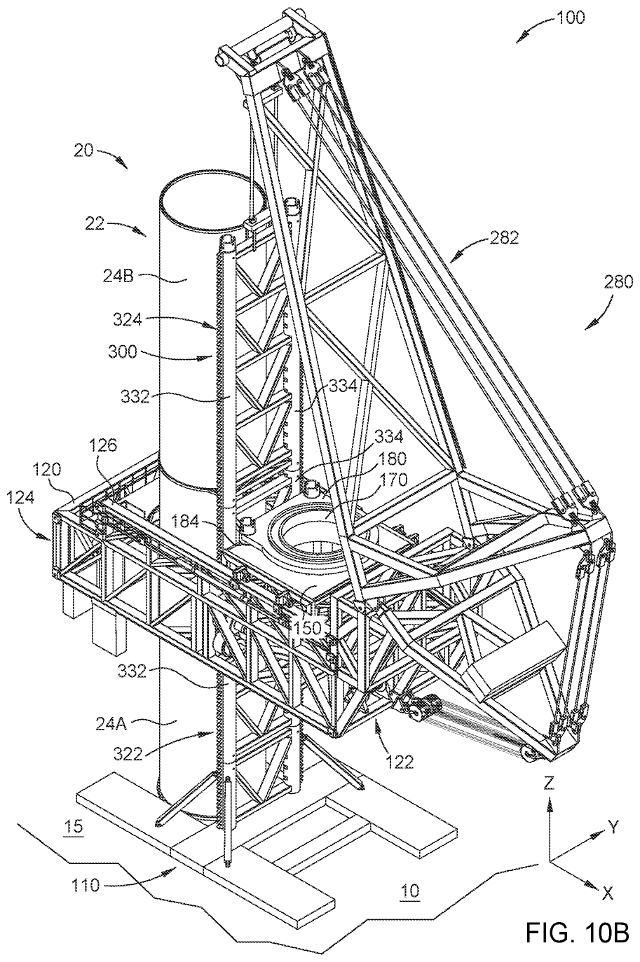

FIGS. 10A and 10B schematically illustrate aspects of the assembling of the rack assembly 300 adjacent a structure 20. The structure is represented by the tower 22 that includes the second tower section 24B mounted onto the first tower section 24A. The operations are depicted involving the lift system 100, however the operations may be performed by any of the lift systems 100, 100′, 200. The operations are depicted involving the carriage 120, however the operations may instead involve the carriage 120′. Furthermore, the (additional) crane 280′ may be mounted on the carriage 120′ during the operations. Alternatively, the (additional) crane 280′ may not be mounted on the carriage 120′ during the operations.

Assembling the rack assembly 300 involves operations similar to the operations described above for the building of a structure. The lift system 100/100′/200 is used to couple a second rack section 324 to a first rack section 322. Although represented by rack assembly 300A, the rack assembly 300 may be any of the rack assemblies 300A, 300B, 300C, or 300D. The process disclosed herein is relevant for any of the rack assemblies 300A, 300B, 300C, and 300D. Second rack section 324 represents any of second rack section 324A, 324B, 324C, or 324D. First rack section 322 represents any of corresponding first rack section 322A, 322B, 322C, or 322D.

In FIG. 10A, the crane 280 is represented by the A-frame 282, and the top of the second rack section 324 is attached to the A-frame 282 via the rigging 298 coupled to the lines 292 suspended from the head unit 284. The second rack section 324 is positioned on the adapter 180 on the stool 170. In an example, the second rack section 324 is coupled to the secondary adapter profile 184 of the adapter 180 on the stool 170. The weight of the second rack section 324 is at least partially borne by the lines 292 suspended from the head unit 284 while the second rack section 324 is on the stool 170. In some embodiments, 50% or more of the weight of the second rack section 324 is borne by the lines 292 suspended from the head unit 284 while the second rack section 324 is on the stool 170. For example, the lines 292 suspended from the head unit 284 may bear 60% or more, 70% or more, 80% or more, 90% or more, or 95% or more of the weight of the second rack section 324 while the second rack section 324 is on the stool 170. In other embodiments, less than 50% of the weight of the second rack section 324 is borne by the lines 292 suspended from the head unit 284 while the second rack section 324 is on the stool 170.

When the carriage 120 is at the top of the first rack section 322, the trolley 150 is moved along the rails 126 of the carriage 120 towards the second end 124 of the carriage 120 to position the second rack section 324 above the first rack section 322. The A-frame 282 pivots about a horizontal axis with respect to the carriage 120 while the trolley 150 moves in order to maintain the second rack section 324 oriented vertically.

In some embodiments, the second rack section 324 is removed from the stool 170 by using the A-frame 282 to lift the second rack section 324 from the stool 170. In some embodiments, the second rack section 324 is removed from the stool 170 as follows: The stool 170 is raised with respect to the trolley 150, such as by the jacks 176. The second rack section 324 is elevated by the stool 170 to a raised position. When the stool 170 is raised, the pistons 296 of the head unit 284 (FIG. 7) are actuated to pull on the lines 292 and take up slack in the lines 292. The stool 170 is then lowered with respect to the trolley 150. The second rack section 324 is removed from the stool 170 as the stool 170 is lowered by maintaining tension in the lines 292 exerted by the pistons 296 of the head unit 284. When the second rack section 324 is removed from the stool 170, the entire weight of the second rack section 324 is borne by the A-frame 282 via the lines 292.

After removing the second rack section 324 from the stool 170, the trolley 150 with the stool 170 is moved away from the second tower section 24B towards the first end 122 of the carriage 120 along the rails 126. The trolley 150 is now no longer between the second rack section 324 and the first rack section 322. Then the carriage 120 is moved down the rack assembly 300 and is thereby lowered with respect to the first rack section 322. The trolley 150, the stool 170, the adapter 180, and the A-frame 282 are moved down with the carriage 120. The second rack section 324 is lowered with the carriage 120. The carriage 120 is lowered with respect to the first rack section 322 sufficiently to place the second rack section 324 into engagement with the first rack section 322.

FIG. 10B shows the second rack section 324 engaged with the first rack section 322, such that the rack assembly 300 now includes the combined first and second rack sections 322, 324. The first leg unit 332 of the second rack section 324 is engaged end-to-end with the first leg unit 332 of the first rack section 322. The second leg unit 334 of the second rack section 324 is engaged end-to-end with the second leg unit 334 of the first rack section 322. As described above, cotters 374 are inserted through each of the first and second leg units 322, 324 of the second rack section 324 and the corresponding connectors 360, 360′. The top of the second rack section 324 remains attached to the A-frame 282 via the rigging 298 coupled to the lines 292.

After the second rack section 324 is engaged with the first rack section 322, the second rack section 324 is coupled to the tower 22. The second rack section 324 is coupled to the tower 22 using a stand-off brace (230, FIGS. 4A to 4F) and a strap (240, FIGS. 4A to 4F), as described above. After the second rack section 324 is coupled to the tower, the second rack section 324 is released from the rigging 298 and the lines 292.

In some embodiments, one or more additional couplings are effected between the rack assembly 300 and the tower after the second rack section 324 is engaged with the first rack section 322. In some embodiments, the one or more additional couplings may be omitted.

FIG. 10C shows examples of additional couplings between the rack assembly 300 and the tower 22. Also shown is a pre-existing strap 240 proximal to the flange 26, and coupling the tower 22 to the first rack section 322, such as described above with respect to FIG. 4A. The exemplary additional couplings include an additional strap 240′ positioned around the tower 22 proximal to the flange 26 and to the pre-existing strap 240, such as described above with respect to FIG. 4A. The strap 240 and additional strap 240′ may be positioned around the tower 22 proximal to the flange 26 as described above with respect to any of FIGS. 4A to 4F. In some embodiments, the additional strap 240′ is omitted.

The exemplary additional couplings include a lower stand-off brace 236 coupled to the second rack section 324 at the bottom of the second rack section 324. The lower stand-off brace 236 is similar to the stand-off brace 230 described above with respect to FIGS. 4A to 4F. The lower stand-off brace 236 is extended into contact with the tower 22 proximal to the flange 26. In some embodiments, the lower stand-off brace 236 is omitted. In some of such embodiments, the stand-off brace 230 at the top of the first rack section 322 is positioned to engage the uppermost portion of the first tower section 24A and the lowermost portion of the second tower section 24B.

It is contemplated that the building of a structure 20, such as the tower 22, can continue by sequentially adding a tower section 24 to the tower 22 followed by adding a rack section 320 to the rack assembly 300, as described above.

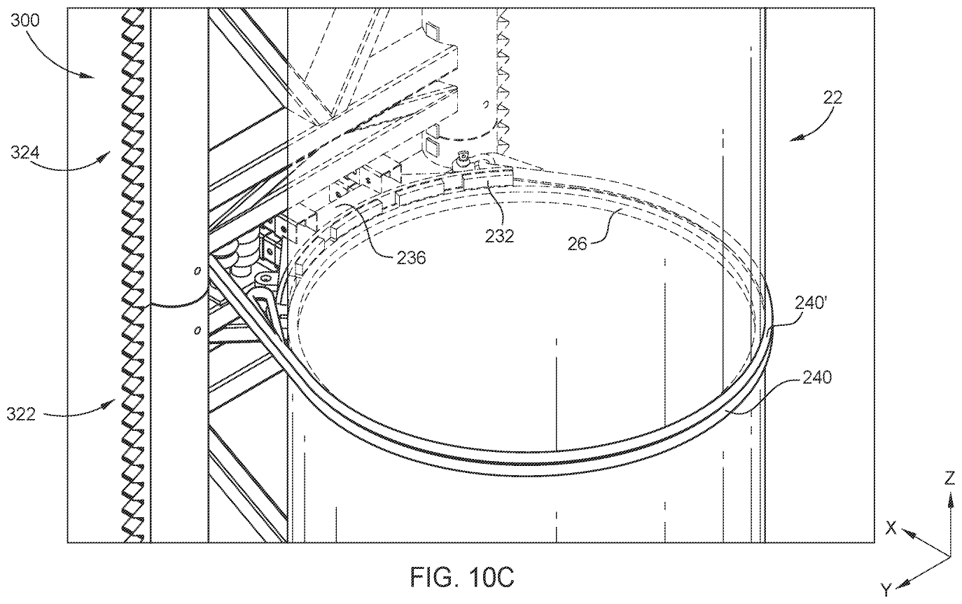

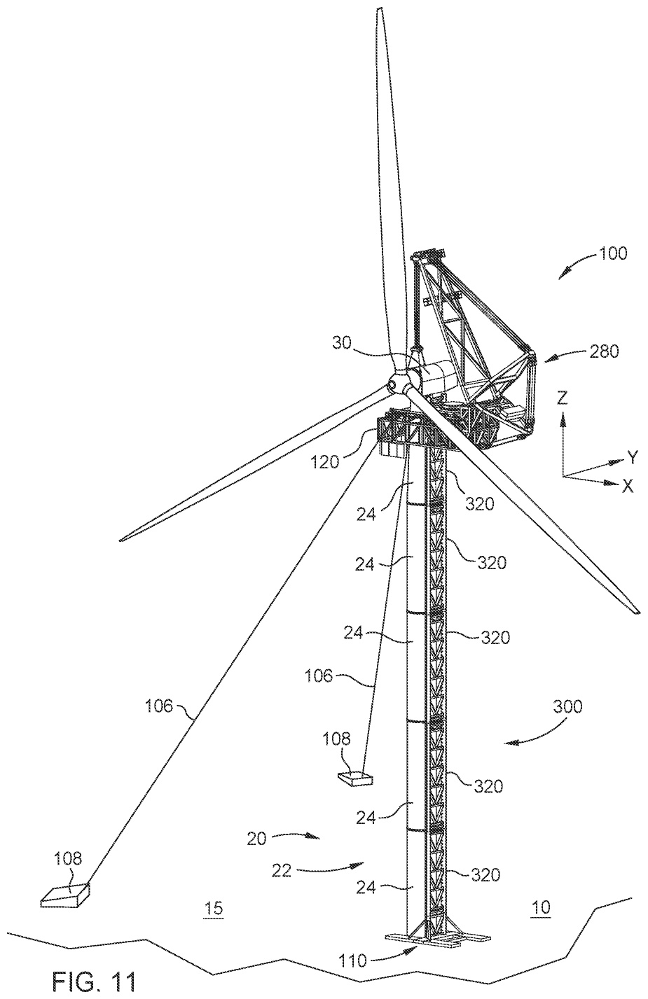

FIG. 11 schematically illustrates the installation of a nacelle 30 of a wind turbine on the top of the tower 22. The tower 22 is constructed of several tower sections 24, and the rack assembly 300 is constructed of several rack sections 320. The nacelle 30 is installed on the tower 22 in a similar manner as described above with respect to the adding of a tower section 24 to the tower 22.

The installation illustrated in FIG. 11 may be performed using any of the rack assemblies 300A, 300B, 300C, or 300D. The rack sections 320 represent any of the rack sections 320A, 320B, 320C, or 320D. The installation of the nacelle 30 is depicted in a land-based environment involving the lift system 100. Nevertheless, the installation of the nacelle 30 may be performed in a land-based environment by the lift system 200, the lift system 500, or the lift system 700. Furthermore, the installation of the nacelle 30 may be performed in an offshore environment by the lift system 100′, the lift system 200, the lift system 500, or the lift system 700.

Additionally, the depicted carriage 120 may be replaced by the carriage 120′ in any land-based or offshore-based deployment. When the carriage 120′ is utilized, the (additional) crane 280′ may be mounted to the carriage 120′. When the carriage 120′ is utilized, the installation of the nacelle 30 may be accomplished using the crane 280 or the crane 280′. Furthermore, the depicted carriage 120 may be replaced by the carriage 520 in any land-based or offshore-based deployment.

FIG. 11 also shows the use of one or more guy lines 106 to assist in stabilizing the carriage 120. The one or more guy lines 106 may be used in any of the operations described herein with any of the lift systems 100, 100′, 200; and with any of the carriages 120, 120′. In some embodiments, the guy lines 106 may be omitted. In some embodiments, one, two, three, four, five, six, or more guy lines 106 couple the carriage 120 to corresponding anchor points 108. When deployed in an offshore environment, the anchor points 108 may be located on one or more offshore structures, such as the offshore installation 50.

When deployed in a land-based environment, the anchor points 108 may be located on one or more other structures, or may be located at the support surface 15 (represented by ground surface 10). In some embodiments, at least one anchor point 108 is at a fixed location at the support surface 15. In some embodiments, at least one anchor point 108 is movable across the support surface 15. In an example, at least one anchor point 108 is a vehicle, such as a tractor, bulldozer, or the like.

In some embodiments, the number of guy lines 106 is changed during construction of the structure 20. In an example, the number of guy lines 106 is increased as the structure 20 is constructed higher. In some embodiments, the number of guy lines 106 is changed according to changes in weather during operations on the structure 20. In an example, the number of guy lines 106 is increased in anticipation of (or in response to) increasing wind speeds.

In some embodiments, the location of an anchor point 108 is changed during construction of the structure 20. In an example, the location of an anchor point 108 is moved further away from the structure 20 as the structure 20 is constructed higher. In some embodiments, the location of an anchor point 108 is changed according to changes in weather during operations on the structure 20. In an example, the location of an anchor point 108 is moved further away from the structure 20 in anticipation of (or in response to) increasing wind speeds.

After completion of the construction operations on the structure 20, the lift system 100/100′/200/500/700 is dismantled. The dismantling involves performing assembly operations of the lift system 100/100′/200/500/700 in reverse. Each rack section 320 is decoupled from the structure 20, and then detached from the rack assembly 300. It is contemplated that the decoupling of the rack assembly 300 from the structure 20 includes a reversal of the activities described above involved in coupling each rack section 320 to the structure 20. In an example, the uppermost rack section is coupled to the crane 280 by the rigging 298, each strap 240, 240′ that is coupled to the uppermost rack section is loosened and removed from the structure 20, and each stand-off brace 230, 236 that is coupled to the uppermost rack section 320 is retracted away from the structure 20.

It is contemplated that the detaching of each rack section 320 from the rack assembly 300 includes a reversal of the activities described above involved in attaching each rack section 320 to the rack assembly 300. For the rack assembly 300B, rack assembly 300C, or rack assembly 300D, each rack section 320B/320C/320D may be further dismantled after being removed from the rack assembly 300B/300C/300D. In an example, the first and second subsections 342/382, 344/384 of each rack section 3206/320C are disassembled. It is contemplated that each rack section 320D may be disassembled into similar subsections as for each rack section 3206/320C. Alternatively, each rack section 320B/320C/320D may not be further dismantled.

In some embodiments, the crane 280 is removed from the carriage 120, before the carriage 120 is removed from the rack assembly 300. In some embodiments, the crane 280 is not removed from the carriage 120, before the carriage 120 is removed from the rack assembly 300. In some embodiments, the crane 280 is removed from the carriage 120′ before the carriage 120′ is removed from the rack assembly 300. In some embodiments, the crane 280 is not removed from the carriage 120′, before the carriage 120′ is removed from the rack assembly 300. In some embodiments, the crane 280′ is removed from the carriage 120′ before the carriage 120′ is removed from the rack assembly 300. In some embodiments, the crane 280′ is not removed from the carriage 120′, before the carriage 120′ is removed from the rack assembly 300.

In some embodiments, the carriage 120 is not removed from the rack assembly 300. For example, when the carriage 120 is used as part of the lift system 200, the carriage 120 may be transported on the base 210, such as when the base 210 is moved under self-propulsion. In some instances, the crane 280 may not be removed from the carriage 120 prior to the base 210 being moved. Similarly, when the carriage 120 is used as part of the lift system 500, the carriage 120 may be transported on the base 510, such as when the base 510 is moved under self-propulsion. In some instances, the crane 280 may not be removed from the carriage 120 prior to the base 510 being moved.

In some embodiments, the carriage 120′ is not removed from the rack assembly 300. For example, when the carriage 120′ is used as part of the lift system 200, the carriage 120′ may be transported on the base 210, such as when the base 210 is moved under self-propulsion. In some instances, the crane 280 and/or the crane 280′ may not be removed from the carriage 120 prior to the base 210 being moved. Similarly, when the carriage 120′ is used as part of the lift system 500, the carriage 120′ may be transported on the base 510, such as when the base 510 is moved under self-propulsion. In some instances, the crane 280 and/or the crane 280′ may not be removed from the carriage 120′ prior to the base 510 being moved.

In the case of the lift system 100, the base 110 is then removed from the support surface 15. In the case of the lift system 100′ in which the base 110′ is not integral with the offshore installation 50, the base 110′ is then removed from the offshore installation 50. In the case of the lift system 100′ in which the base 110′ is integral with the offshore installation 50, the base 110′ is not then removed from the offshore installation 50. In the case of the lift system 200, the base 210 is moved away from the structure 20, such as under self-propulsion. In the case of the lift system 500, the base 510 is moved away from the structure 20, such as under self-propulsion. In the case of the lift system 700, the base 710 is then removed from the support surface 15. In the case of the lift system 700 in which the base 710 is not integral with the offshore installation 50, the base 710 is then removed from the offshore installation 50. In the case of the lift system 700 in which the base 710 is integral with the offshore installation 50, the base 710 is not then removed from the offshore installation 50.

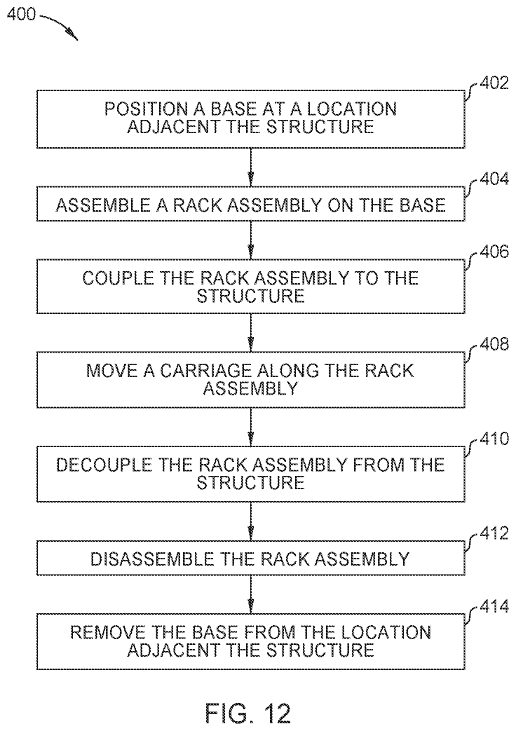

FIG. 12 is a flow chart for a method 400 of performing an operation on a structure, such as the structure 20. In some embodiments, the structure is a tower, such as the tower 22. In some embodiments, the method 400 is conducted using the lift system 100. In some embodiments, the method 400 is conducted using the lift system 100′. In some embodiments, the method 400 is conducted using the lift system 200. In some embodiments, the method 400 is conducted using the lift system 500. In some embodiments, the method 400 is conducted using the lift system 700.

At operation 402, a base is positioned at a location adjacent the structure. When conducting the method 400 using the lift system 100, operation 402 includes laying the base 110 on the support surface 15 (such as ground surface 10) at the location adjacent the structure 20. When conducting the method 400 using the lift system 700, operation 402 includes positioning the base 710 on the support surface 15 at the location adjacent the structure 20. When conducting the method 400 using the lift system 200, operation 402 includes moving the base 210, such as under self-propulsion, along the support surface 15 to the location adjacent the structure 20, such as described above. In some embodiments, the base 210 conveys a carriage (such as any one of carriage 120, 120′, or the carriage 520 that is described below) while the base 210 moves to the location adjacent the structure. When conducting the method 400 using the lift system 500, operation 402 includes moving the base 510, such as under self-propulsion, along the ground surface 10 to the location adjacent the structure 20, such as described below. In some embodiments, the base 510 conveys a carriage (such as any one of carriage 120, 120′, or 520) while the base 510 moves to the location adjacent the structure.

When conducting the method 400 using the lift system 100′, operation 402 includes laying the base 110′ on a support surface 15, such as an offshore installation (e.g. offshore installation 50). In some embodiments, operation 402 includes laying the base 110′ on the same offshore installation 50 upon which the structure (e.g. structure 20, tower 22) is mounted. In some embodiments, operation 402 includes laying the base 110′ on a different offshore installation that is located adjacent the structure. In an example, the base 110′ may be positioned on a mobile service vessel, such as a jack-up vessel. The base 110′ may be positioned on the mobile service vessel before, during, or after the mobile service vessel is moved on the water 55 to be located adjacent the structure. In some embodiments, the base 110′ is positioned at least partly on the offshore installation 50, and at least partly on a different offshore installation that is located adjacent the structure.

In some embodiments, when conducting the method 400 using any of the lift systems 100 or 100′, the base 110/110′ may be preexisting in place at the location adjacent the structure. In an example, the base 110/110′ may be situated before the structure is constructed, and may remain in place after construction of the structure. Operation 402 includes scenarios in which the base 110/110′ is already present at the location adjacent the structure.

Operation 402 includes scenarios in which the structure is yet to be in place when the base is positioned at a location adjacent the structure 20. In an example, operation 402 includes scenarios in which the site where the structure 20 is to be constructed is undeveloped at the time of positioning the base. In another example, operation 402 includes scenarios in which the site where the structure 20 is to be constructed includes a foundation for the structure 20 at the time of positioning the base. In yet another example, operation 402 includes scenarios in which the site where the structure 20 is to be constructed includes a portion of the structure 20 in place at the time of positioning the base.

At operation 404, a rack assembly is assembled on the base. It is contemplated that the rack assembly may be any of the rack assemblies 300/300A/300B/300C/300D described above. In some embodiments, the rack assembly includes one or more standard rack sections (such as standard rack section 450) and one or more stand-off rack sections (such as stand-off rack section 460), as described with respect to FIGS. 4C to 4F. It is further contemplated that assembling the rack assembly may involve at least some of the operations described above, such as at least some of the operations described with respect to FIGS. 10A and 10B, or described below with respect to the lift system 500.

At operation 406, the rack assembly is coupled to the structure 20. It is contemplated that the rack assembly may be coupled to the structure by at least some of the mechanisms described above with respect to FIGS. 4A to 4F. In some embodiments, the rack assembly is coupled to the structure 20 additionally by at least some of the mechanisms described above with respect to FIG. 10C. In some embodiments, the rack assembly is not coupled to the structure 20 additionally by at least some of the mechanisms described above with respect to FIG. 10C. In some embodiments, the rack assembly is coupled to the structure at a plurality of discrete locations along the structure.

In some embodiments, the activities of operations 404 and 406 are repeated in sequence for each rack section that is attached to form the rack assembly. In an example, the activities of operation 404 are performed to attach a rack section to the rack assembly, then the activities of operation 406 are performed on the rack section, then the activities of operation 404 are performed to attach another rack section to the rack assembly, and so on. In some embodiments, the activities of operation 404 are performed to attach more than one selected rack section to the rack assembly before the activities of operation 406 are performed on the selected rack sections.

In some embodiments, method 400 includes coupling a carriage (such as the carriage 120, 120′, or 520) to the rack assembly after coupling a lowermost rack section of the rack assembly (such as lowermost rack section 326) to the structure. In some embodiments, such as when method 400 is conducted using the lift system 200 or the lift system 500, the carriage is coupled to a lowermost rack section of the rack assembly on the base (such as base 210 or base 510) before the base is positioned at the location adjacent the structure. In some embodiments, such as when method 400 is conducted using the lift system 200 or the lift system 500, the carriage is coupled to a lowermost rack section of the rack assembly on the base after the base is positioned at the location adjacent the structure, but before the lowermost rack section of the rack assembly is coupled to the structure.

At operation 408, the carriage is moved along the rack assembly. It is contemplated that the carriage is moved along the rack assembly to access an elevated section of the structure 20. In some embodiments, an activity is performed on the structure. Exemplary activities include any one or more of cleaning, painting, maintenance, repair, observation, monitoring, equipment removal, or equipment installation (such as the installation of a tower section 24, a nacelle 30, a rotor, a blade, etc.).

At operation 410, the rack assembly is decoupled from the structure 20. It is contemplated that the decoupling of the rack assembly from the structure 20 includes a reversal of the activities described above involved in operation 406. In an example, each strap is loosened and removed from the structure 20, and each stand-off brace is retracted away from the structure 20.

At operation 412, the rack assembly is disassembled. It is contemplated that the disassembling of the rack assembly includes the removal of each rack section from the rack assembly. In an example, the detaching of each rack section from the rack assembly includes a reversal of the activities described above involved in attaching each rack section to the rack assembly.

In some embodiments, the activities of operations 410 and 412 are repeated in sequence for each rack section that is detached from the rack assembly. In an example, the activities of operation 410 are performed on a rack section, then the activities of operation 412 are performed on the rack section, then the activities of operation 410 are performed on another rack section, and so on. In some embodiments, the activities of operation 410 are performed on more than one selected rack section before the activities of operation 412 are performed on the selected rack sections.

At operation 414, the base is removed from the location adjacent the structure. When conducting the method 400 using the lift system 100, operation 414 includes picking up and moving the base 110 from the support surface 15 adjacent the structure 20. When conducting the method 400 using the lift system 700, operation 414 includes picking up and moving the base 710 from the support surface 15 adjacent the structure 20. When conducting the method 400 using the lift system 200, operation 414 includes moving the base 210, such as under self-propulsion, away from the structure 20 along the support surface 15, such as described above. In some embodiments, the base 210 conveys a carriage (such as any one of carriage 120, 120′, or 520) while the base 210 moves away from the structure. When conducting the method 400 using the lift system 500, operation 414 includes moving the base 510, such as under self-propulsion, away from the structure 20 along the support surface 15, such as described below. In some embodiments, the base 510 conveys a carriage (such as any one of carriage 120, 120′, or 520) while the base 510 moves away from the structure.

In some embodiments, when conducting the method 400 using the lift system 100′, operation 414 includes removing the base 110′ from the offshore installation. In some embodiments, when conducting the method 400 using the lift system 100′, operation 414 includes moving the mobile service vessel on which the base 110′ is mounted away from the structure. In some embodiments, when conducting the method 400 using the lift system 700, operation 414 includes removing the base 710 from the offshore installation. In some embodiments, when conducting the method 400 using the lift system 700, operation 414 includes moving the mobile service vessel (on which the base 710 is mounted) away from the structure.

In some embodiments, operation 414 may be omitted. In such embodiments, such as when conducting the method 400 using any of the lift systems 100 or 100′, the base 110/110′ may remain in place. In an example, the base 110′ of lift system 100′ may be integral with the offshore installation 50 upon which the structure 20 is mounted. In another example, when conducting the method 400 using the lift system 700, the base 710 may remain in place.

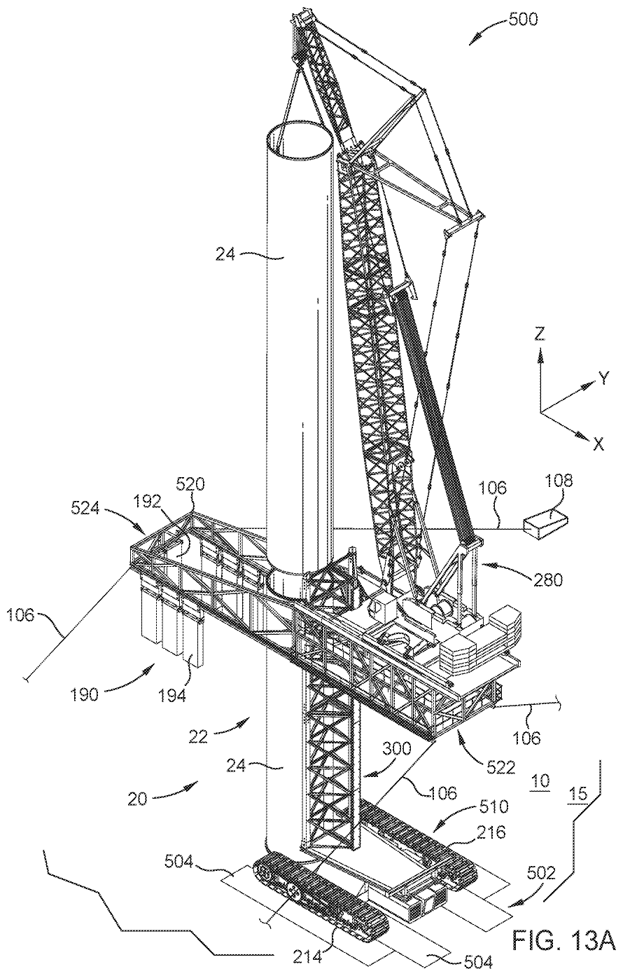

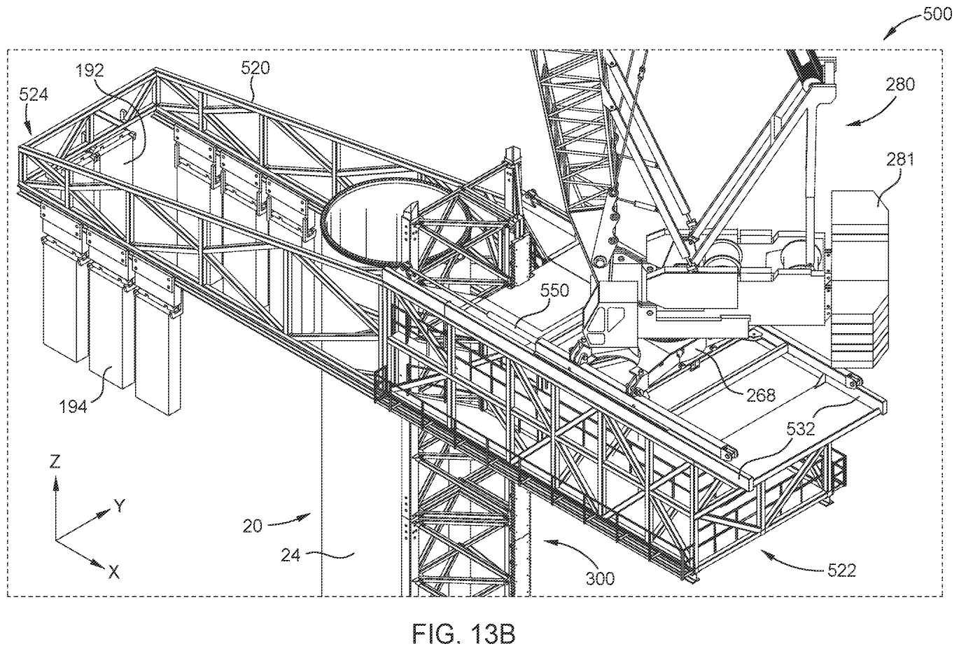

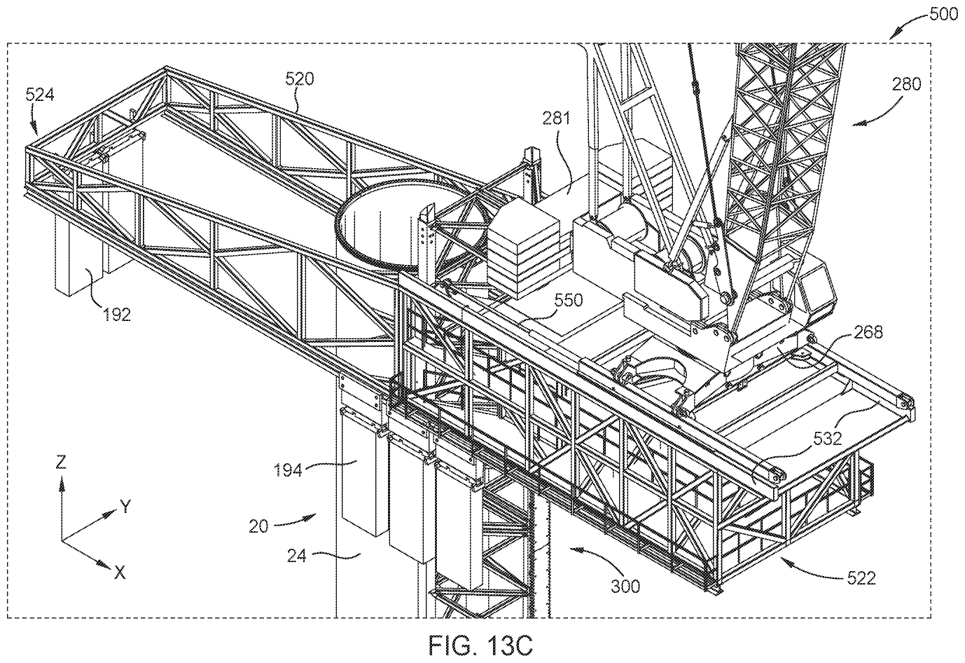

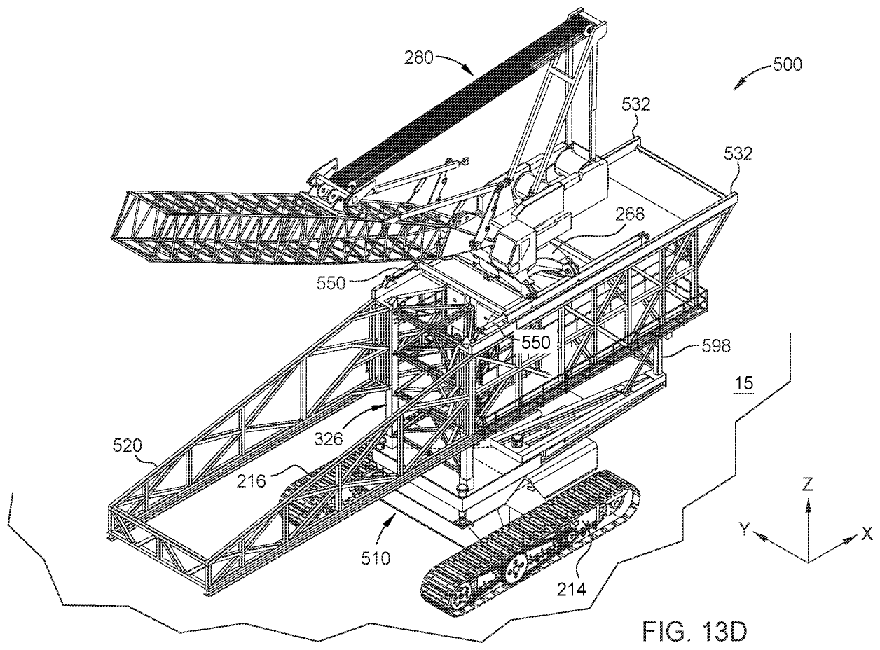

FIGS. 13A to 13D schematically illustrate a lift system 500 for performing operations on a structure, such as the structure 20 of FIGS. 1A and 1B, such as the tower 22. The lift system 500 is similar to the lift system 200. The lift system 500 includes a base 510. The base 510 is similar to the base 210.

The base 510 is shown in FIG. 13A on a support surface 15. Examples of the support surface 15 include any body configured to support a load, such as a ground surface (e.g. ground surface 10). The ground surface may include a road, a roadbed, a paved surface, or a foundation. The ground surface may include earth, wood, rock, aggregate, concrete, metal, asphalt, or the like. In some examples, the support surface 15 includes an item on a body that is configured to support a load, such as a mat 502 on the ground surface 10.

Further examples of the support surface 15 include a portion (e.g. a deck) of an offshore installation (e.g. offshore installation 50). In some instances, the structure 20 and the base 510 are on the same offshore installation. In other instances, the structure 20 and the base 510 are on different offshore installations.

The base 510 may be positioned on a mobile service vessel, such as a jack-up vessel. The base 510 may be positioned on the mobile service vessel before, during, or after the mobile service vessel is moved to be located adjacent the structure 20. In yet other instances, the structure 20 is on a first offshore installation, and the base 510 is at least partially on the first offshore installation and at least partially on a second, different, offshore installation (such as a mobile service vessel).

The base 510 is shown as being positioned on a mat 502. In some embodiments, the mat 502 is permanently located on the support surface 15 adjacent the structure 20. In some embodiments, the mat 502 is removably placed on the support surface 15 adjacent the structure 20. As illustrated, in some embodiments, the mat 502 includes a plurality of modules 504. In some embodiments, the modules 504 are removably coupled together. In some embodiments, the modules 504 are similar to the modules 112, described above. Additionally, or alternatively, the mat 502 may include another laterally-expansive and relatively flat structure configured to distribute loads over the support surface 15 adjacent the structure 20.

The lift system 500 includes the rack assembly 300 on the base 510. In the Figures, the rack assembly 300 is represented by rack assembly 300D, however the lift system 500 may incorporate any of rack assemblies 300A, 300B, or 300C. The lift system 500 includes the equipment, such as the stand-off braces 230, straps 240, etc. described above with respect to FIGS. 4A and/or 4B, for coupling the rack assembly 300 to a structure 20.

The lift system 500 includes a carriage 520. The carriage 520 is similar to the carriage 120. In some embodiments, the carriage 520 includes a work platform between the first end 522 and the portion that accommodates the structure 20. In some embodiments, the carriage 520 includes a work platform between the second end 524 and the portion that accommodates the structure 20.

The lift system 500 includes equipment (such as the motors 132 and pinions 134, etc. that are described above with respect to the lift systems 100, 100′, and 200) for conveying the carriage 520 along the rack assembly 300, and for maintaining the carriage 520 at a selected elevation along the rack assembly 300. In some embodiments, the lift system 500 includes the counterweights 190, such as one or more fixed counterweights 192 and/or movable counterweights 194, such as described above. In some embodiments, the lift system 500 includes one or more guy lines 106 that couple the carriage 120 to corresponding anchor points 108, as described above. In some embodiments, one or more of the guy lines 106 are omitted. The lift system 500 includes a crane 280 mounted on the carriage 520, however the trolley 150 and stool 170 of the lift systems 100, 100′, 200 are omitted. Other aspects of the lift system 500 are described below.

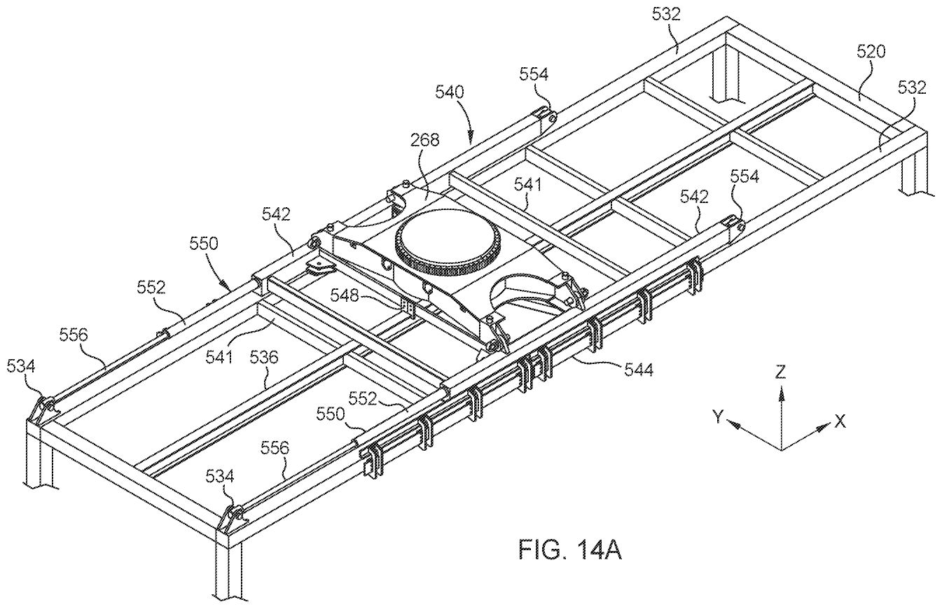

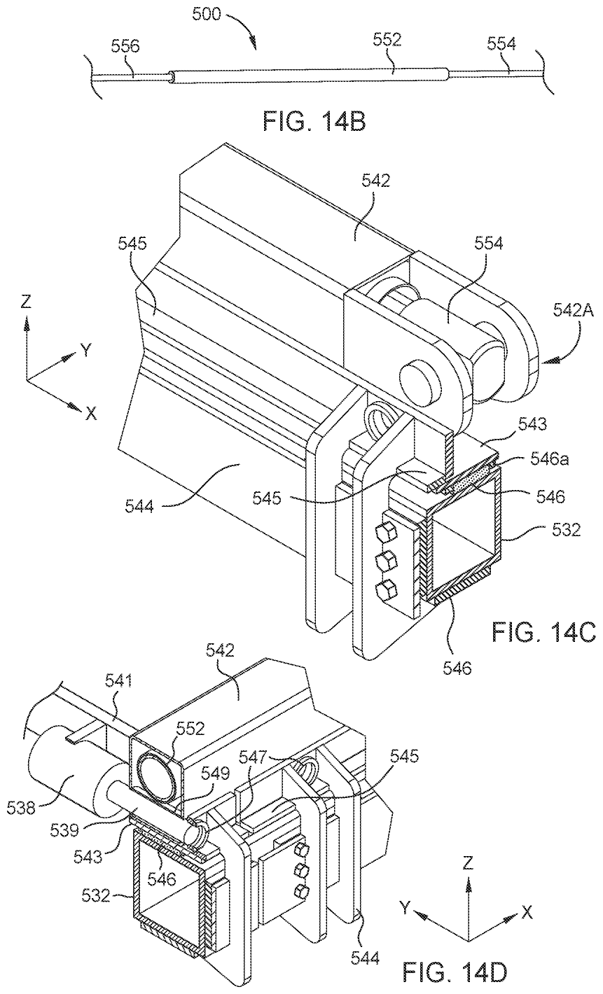

FIG. 13B is an enlargement of a portion of FIG. 13A. The crane 280 includes a counterweight 281, and is configured to slew on a chassis 268, such as a car body, that is coupled to one or more actuators 550. As illustrated, exemplary actuators 550 include corresponding pistons and cylinders, such as described below with respect to FIGS. 14A to 14D. Other exemplary actuators 550 include a motorized pinion engaged with a rack, a winch, or a driven chain. The one or more actuators 550 are configured to move the crane 280 along rails 532 of the carriage 520 between the first and second ends 522, 524 in a direction towards and away from the rack assembly 300. It is contemplated that the configuration of the crane 280 in the lift system 500 may be used also in the lift systems 100, 100′, or 200.

The crane 280 can pick up items from the support surface 15, or from a location proximal to the support surface 15 (e.g. a vehicle on the ground surface 10). The items that the crane 280 can pick up may include a portion of the rack assembly 300, equipment for performing maintenance on the structure 20 or on the lift system 500 itself, or a component of the structure 20 (e.g. sections 24 of the tower 22, a nacelle, a rotor, a blade, or a pre-assembled rotor with blades).

The range of slewing and sliding motion of the crane 280 on the carriage 520 is such that the crane 280 can pick up such items from various locations on the support surface 15 in the vicinity of the structure 20 or the lift system 500. The crane 280 can pick up such items while the carriage 520 is at the top of the rack assembly 300 or at a location between the top and bottom of the rack assembly 300. Similarly, the crane 280 can set down such items at various locations on the support surface 15 in the vicinity of the structure 20 or the lift system 500. The crane 280 can set down such items while the carriage 520 is at the top of the rack assembly 300 or at a location between the top and bottom of the rack assembly 300.

FIG. 13C shows a configuration of the lift system 500 when the carriage 520 is moving up or down the rack assembly 300. As illustrated, the carriage 520 is not carrying a component of the structure 20 or a component of the rack assembly 300. When the crane 280 is not being used to carry a load while the carriage 520 moves up or down the rack assembly 300, the crane 280 may be slewed such that the counterweight 281 is positioned close to the rack assembly 300. The movable counterweights 194 attached to the carriage 520 are positioned to place a center of gravity of the carriage 520 combined with all the items and equipment thereon at the rack assembly 300.

FIG. 13D schematically illustrates the lift system 500 in a transport configuration. In the transport configuration, the lift system 500 undergoes self-propelled motion across the support surface 15. The first and second traction units 214, 216 are operated to move the base 510 across the support surface 15. In embodiments in which the lift system 500 includes the mat 502, the first and second traction units 214, 216 are operated to move the base 510 onto, or off, the mat 502. The carriage 520 is in a lowered position at, or proximal to, the base 510. The carriage 520 is at least partially supported by a carriage rest 598 on the base 510. The counterweights 190 have been removed from the carriage 520. The rack assembly 300 has been disassembled except for a lowermost rack section 326. The crane 280 has been moved by the one or more actuators 550 towards the lowermost rack section 326. As illustrated, in some embodiments, the crane 280 may be partially disassembled prior to the base 510 undergoing self-propelled motion. For example, the counterweight 281 and/or portions of the boom may be removed from the crane 280.

FIGS. 14A to 14D schematically illustrate aspects of the mounting of the crane 280 to the carriage 520 in the lift system 500. For clarity, some details of the crane 280 and the carriage 520 are not shown. The chassis 268 is coupled to a sled 540. In some embodiments, the sled 540 is integral with the chassis 268. The actuators 550 move the sled 540 on the rails 532 of the carriage 520. In the illustrated embodiment, each actuator 550 is at least partially disposed within a corresponding side tube 542 of the sled 540.

FIG. 14B shows each actuator 550 includes first and second piston rods 554, 556 that extend from opposite ends of a cylinder 552. In some embodiments, the cylinder 552 includes a first cylinder that houses a portion of the first piston rod 554, and a second cylinder that houses a portion of the second piston rod 556, the first and second cylinders being positioned end-to-end. In some of such embodiments, the first and second cylinders are physically and/or hydraulically coupled together. To move the sled 540 away from the rack assembly 300, pressure is applied to further extend the first piston rod 554 from the cylinder 552, and to further extend the second piston rod 556 from the cylinder 552. To move the sled 540 towards the rack assembly 300, pressure is applied to retract the first piston rod 554 into the cylinder 552, and to retract the second piston rod 556 into the cylinder 552.

FIG. 14C is an enlarged view of a portion of the sled 540 showing first piston rod 554 coupled to a corresponding side tube 542. As shown in the illustrated example, each first piston rod 554 is coupled to the corresponding side tube 542 at an end 542A of the side tube 542 that is distal from the rack assembly 300. FIG. 14A shows each second piston rod 556 is coupled to a corresponding cleavis 534 of each rail 532.

As illustrated in FIG. 14A, in some embodiments, the sled 540 includes a catch 548 that is engaged with a chord 536 of the carriage 520. The catch 548 hinders the sled 540 from being removed from the carriage 520. In some embodiments, the catch 548 may be omitted.

Guides 544 assist in directing movement of the sled 540 along the rails 532. It is contemplated that each guide 544 is attached to a corresponding rail 532. FIG. 14A shows one of the guides 544, and FIGS. 14C and 14D illustrate features of a guide 544 in enlarged views of portions of the sled 540 in the form of partial cross-sections.

Each guide 544 is coupled to the corresponding rail 532, such as by welding and/or bolts. Each guide includes a retainer 545 that is positioned above the rail 532. As illustrated, in some embodiments, the retainer 545 is in the form of a bar. In other embodiments, the retainer 545 may be in the form of an I-beam or a tubular, such as a box section tubular.

Each side tube 542 of the sled 540 is coupled to a corresponding slide plate 543, such as by welding. The slide plate 543 extends laterally from the underside of the side tube 542. At least a portion of each slide plate 543 is positioned between a corresponding retainer 545 and rail 532. As the sled 540 moves along the rails 532 towards and away from the rack assembly, each slide plate 543 moves between the corresponding retainer 545 and rail 532 with the sled 540.

One or more pads 546 are provided at the interface of each slide plate 543 and the top side of each corresponding rail 532. The pads 546 assist in controlling friction between the slide plates 543 and the rails 532. Exemplary materials of the pads 546 include high density polyethylene (HDPE) or ultra high molecular weight (UHMW) polyethylene. In some examples, the material of the pads 546 is oil-impregnated. Each pad 546 is retained on the underside of each corresponding slide plate 543 by a holder 546A.

In some embodiments, additional pads 546 are provided at other interfaces between the sled 540 and each guide 544. An exemplary interface is between the underside of a retainer 545 and the top side of the corresponding slide plate 543. Additionally, or alternatively, other interfaces between the sled 540 and each guide 544 may be lubricated, such as by grease.

In some embodiments, the sled 540 can be locked in place at one or more locations along the carriage 520. In an example, FIG. 14D shows an actuator 538 for a locking pin 539. The actuator 538 may be operated electrically, hydraulically, or pneumatically. The actuator 538 is attached to a cross beam 541 of the sled 540. When the sled 540 is positioned at a desired location along the carriage 520, the actuator 538 is activated to move the locking pin 539 through a receiver 549 in the side tube 542 of the sled 540, and into a corresponding hole 547 in the guide 544. In some embodiments, each locking pin 539 is manually engaged with, and/or disengaged from, the corresponding hole 547.

It is contemplated that a plurality of locking pins 539, each with a corresponding actuator 538, may be used to secure the sled 540 at one or more discrete locations along the carriage 520. The position of each hole 547 may be predetermined to correspond with a specific discrete location of the sled 540 (and therefore the crane 280) along the carriage 520. Each discrete location of the sled 540 may correspond with a specific activity of the lift system 500. Examples of such specific activities include, without limitation, using the crane 280 to lift a tower section (e.g. tower section 24), using the crane 280 to install the tower section onto a structure, using the crane 280 to lift a rack section (e.g. rack section 320), using the crane 280 to install the rack section onto a rack assembly, using the crane 280 to lift a nacelle (e.g. nacelle 30), using the crane 280 to install the nacelle onto a structure, positioning the crane 280 for raising or lowering the carriage 520, or positioning the crane 280 for transportation of the lift system 500 along a support surface.

It is further contemplated that the positioning of the sled 540 (and therefore the crane 280) at one or more specific discrete locations along the carriage 520 is performed to correspond with the positioning of the movable counterweights 194 for a specific activity, such as described above. In an example, the sled 540 (and therefore the crane 280) is positioned at a desired location along the carriage 520 that corresponds with a selected activity to be performed. Additionally, the movable counterweights 194 are positioned at another desired location along the carriage 520 that corresponds with the positioning of the sled 540 (and therefore with the crane 280), and corresponds with the selected activity to be performed.

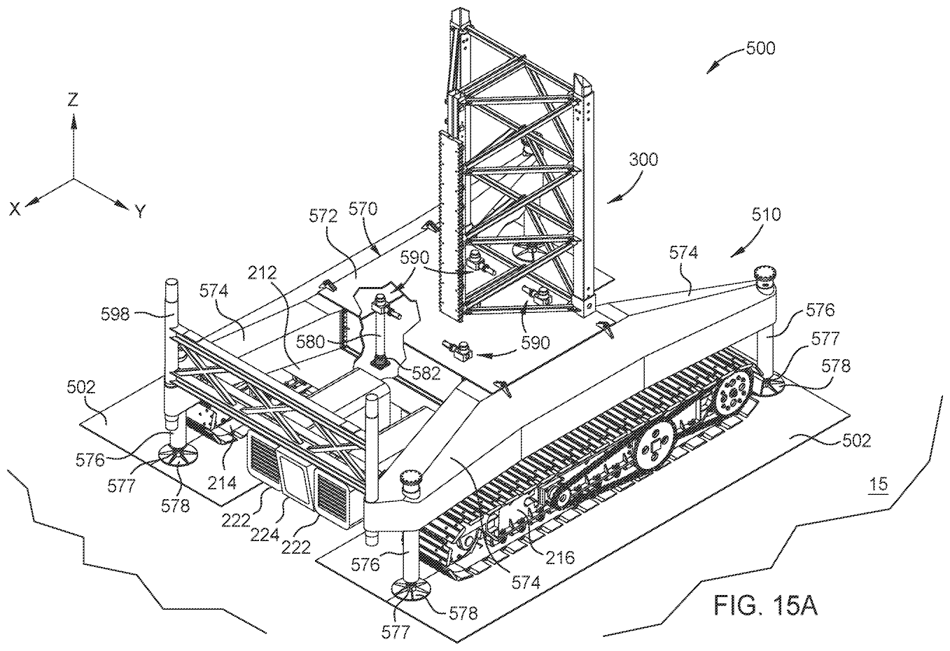

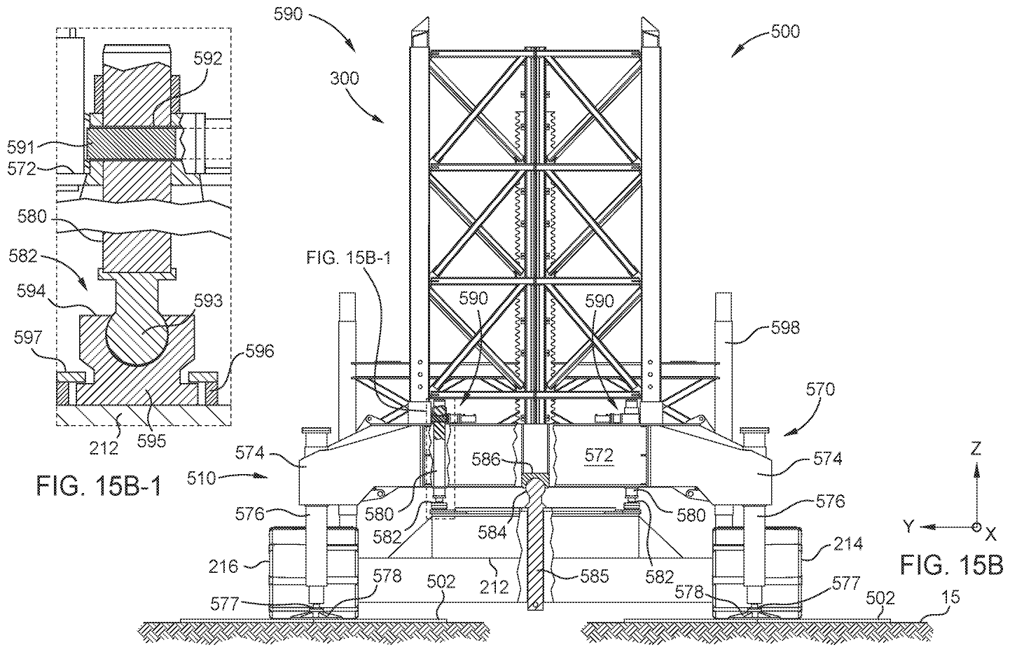

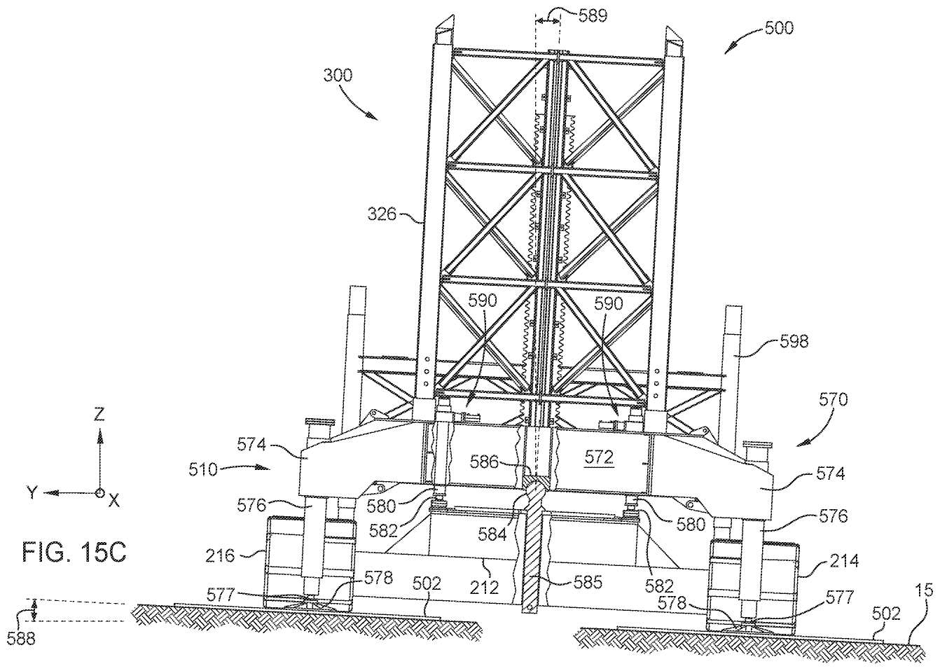

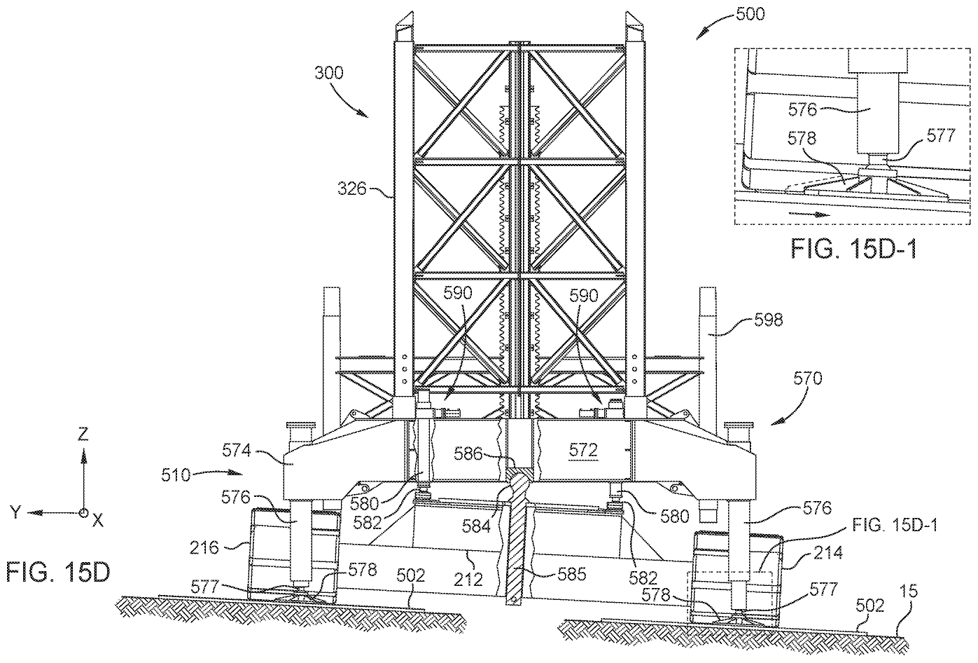

FIGS. 15A, 15B, and 15B-1 schematically illustrate selected aspects of the lift system 500. Certain items, such as the carriage 520, have been omitted for clarity. FIGS. 15A and 15B show the base 510 including the car body 212 coupled to first and second traction units 214, 216, such as described above. The base 510 includes one or more power units 222 (two are shown) that drive the first and second traction units 214, 216. In some embodiments, the base 510 is powered by a power unit mounted on the carriage 520. In some embodiments, the base 510 is powered by a power unit mounted on the crane 280.

The base 510 is shown positioned on a mat 502 that is on the support surface 15. The first and second traction units 214, 216 are on the mat 502, and transfer loads from the base 510 to the mat 502. In some embodiments, the mat 502 may be omitted, and the base 510 may be positioned directly on the support surface 15.

As illustrated, in some embodiments, the base 510 includes a leveling assembly 570 that can be used to adjust an orientation of the rack assembly 300 with respect to a structure (such as structure 20). In an example, if the portion of the support surface 15 (or the mat 502) on which the base 510 is positioned is not horizontal, the rack assembly 300 might not be appropriately aligned with the structure 20. Accordingly, the leveling assembly 570 can be used to adjust the alignment of the rack assembly 300 with respect to the structure 20. The rack assembly 300 is coupled to the car body 212 via the leveling assembly 570.

The leveling assembly 570 includes a leveling table 572. The rack assembly 300 is coupled to the leveling table 572. In some embodiments, the leveling table 572 includes a frame, a deck, or the like, onto which the rack assembly 300 is coupled. The leveling table 572 is coupled to the car body 212 by one or more link struts 580 (shown in a partial cutaway in FIGS. 15A and 15B). Each link strut 580 is pivotably coupled to the car body 212 by a ball joint 582. Each link strut 580 is releasably coupled to the leveling table 572 by a locking assembly 590.

FIG. 15B-1 is an enlargement of a portion of FIG. 15B. The upper portion of FIG. 15B-1 schematically depicts an exemplary locking assembly 590. The locking assembly 590 includes a locking pin 591 that is selectively actuated to engage a hole 592 in a corresponding link strut 580. Each locking pin 591 may be actuated manually, electrically, pneumatically, or hydraulically. The locking pin 591 is engaged with the hole 592 prior to moving the base 510. The locking pin 591 is disengaged from the hole 592 prior to performing a leveling operation (described below). In some embodiments, a detectable feature, such as a visible mark, on a portion of the link strut 580 that projects above the locking assembly 590 serves as an indicator as to whether the hole 592 is aligned with the pin 591.

The lower portion of FIG. 15B-1 schematically depicts an exemplary ball joint 582. A ball 593 on the link strut 580 is received in a socket 594. A base 595 of the socket 594 sits on an upper surface of the car body 212. A retainer 596 is secured to the car body 212 (such as by bolts or by a weld), and at least partially surrounds the base 595 of the socket 594. A cover plate 597 is removably attached to the retainer 596 (such as by bolts), and partially overlaps with the base 595 of the socket 594. Clearance between the base 595 and the retainer 596 permits the socket 594 to move laterally on the upper surface of the car body 212. For example, the clearance may allow for up to about two inches (about 50.8 mm) of lateral movement of the socket 594, such as up to about one inch (about 25.4 mm) or up to about half an inch (about 12.7 mm).

Returning to FIG. 15B, additionally, or alternatively, the leveling table 572 may be coupled to the car body 212 by a ball 584 (shown in a partial cutaway). In the illustrated example, the ball 584 is on a shaft 585 that is secured to the car body 212. In some examples, the ball 584 is affixed to the car body 212 directly. The leveling table 572 is coupled to the ball 584 by a socket 586.

As shown in FIGS. 15A and 15B, the leveling assembly 570 includes one or more outriggers 574 extending from the leveling table 572. Each outrigger 574 includes a structural member extending beyond the car body 212 and the first and second traction units 214, 216. Each outrigger 574 is configured to move with the leveling table 572. In some embodiments, the one or more outriggers 574 are integral with the leveling table 572. In some embodiments, the one or more outriggers 574 are removable from the leveling table 572.

Feet 578 are coupled to the one or more outriggers 574. Each foot 578 is raised and lowered by a corresponding jack 576. In some embodiments, each foot 578 is pivotably coupled to the corresponding jack 576 by a ball joint 577. Each jack 576 moves a corresponding foot 578 with respect to the leveling table 572 towards and away from the support surface 15. Each jack 576 moves a corresponding foot 578 to a raised position when the base 510 is to be moved to a different location. Each jack 576 moves a corresponding foot 578 to a lowered position in contact with the support surface 15 (or an item, such as mat 502, on the support surface 15) when the lift system 500 is to be used to perform an operation on a structure.

At least a portion of a combined loading of a weight of the lift system 500 plus a load borne by the lift system 500 is transferred to the support surface 15 via the feet 578 when the feet 578 are in the lowered position. For example, up to about 10%, about 20%, about 30%, about 40%, or about 50% of the combined loading is transferred to the support surface 15 via the feet 578. The remainder of the combined loading is transferred to the support surface 15 via the first and second traction units 214, 216.

FIGS. 15C, 15D, and 15D-1 show the leveling assembly 570 in operation with the base 510 positioned on the mat 502 on the support surface 15. In some embodiments, the mat 502 is omitted. FIG. 15C shows the leveling assembly 570 before adjusting the orientation of the rack assembly 300. The support surface 15 is sloped at an acute angle 588 with respect to horizontal. During operation of the leveling assembly 570, the rack assembly 300 is not necessarily fully assembled, or even present. A lowermost rack section 326 is depicted. The rack assembly 300 is shown oriented at a corresponding acute angle 589 with respect to vertical. In some embodiments, the acute angle 588 is equal to the acute angle 589.

FIG. 15D shows the leveling assembly 570 after adjusting the orientation of the rack assembly 300 to be vertical. FIG. 15D-1 shows an enlargement of a portion of FIG. 15D.

In operation, each jack 576 lowers each foot 578 into contact with the mat 502 (if present) and/or the support surface 15. The locking pins 591 are disengaged from the link struts 580. One or more of the jacks 576 are selectively energized to tilt the leveling table 572 with respect to the support surface 15. In an example, a jack 576 raises a first portion of the leveling table 572 with respect to the support surface 15 to a greater extent than a second portion of the leveling table 572 is raised with respect to the support surface 15. In another example, the jacks 576 are operated such that a first portion of the leveling table 572 is raised with respect to the support surface 15, and a second portion of the leveling table 572 is lowered with respect to the support surface 15.

The jacks 576 are operated such that each foot 578 remains in contact with the mat 502 (if present) and/or the support surface 15 while the leveling table 572 is being tilted. During the tilting of the leveling table 572, the leveling table 572 pivots with respect to the car body 212 on the ball 584. The socket 586 moves on the ball 584 while the leveling table 572 pivots.

In some embodiments, each jack 576 does not pivot with respect to the corresponding outrigger 574. In such embodiments, the tilting of the leveling table 572 causes an orientation of each jack 576 with respect to the support surface 15 to change. The change in orientation of each jack 576 is accommodated by each foot 578 sliding laterally with respect to the support surface 15 (shown in FIG. 15D-1). Each jack 576 pivots with respect to each corresponding foot 578 at the respective ball joint 577. Each foot 578 remains in contact with the mat 502 (if present) and/or the support surface 15.

In other embodiments, each jack 576 is able to pivot with respect to the corresponding outrigger 574. In an example, each jack 576 is coupled to the corresponding outrigger 574 by a gimbal. In at least some of such embodiments, a change in orientation of each jack 576 with respect to the support surface 15 is accommodated by pivoting of each jack 576 at the gimbal and at the corresponding foot 578 without the feet 578 sliding laterally with respect to the support surface 15.

Each link strut 580 remains coupled to the car body 212 by the corresponding socket 594 of the corresponding ball joint 582. Tilting of the leveling table 572 with respect to the car body 212 also moves the leveling table 572 with respect to the link struts 580. In an example, each link strut 580 slides through a corresponding opening in the leveling table 572. When tilting the leveling table 572 with respect to the car body 212, the link struts 580 pivot with respect to the car body 212 at the ball joints 582. In some embodiments, the tilting operation causes a socket 594 of a ball joint 582 to move laterally on the upper surface of the car body 212. Such lateral movement may be constrained by the corresponding retainer 596 (FIG. 15B-1).

The portion of the rack assembly 300 that is coupled to the leveling table 572 at the time of the tilting operation moves with the leveling table 572. When the rack assembly 300 has been moved to a desired orientation, the tilting operation is stopped. In some embodiments, at the cessation of the tilting operation, the jacks 576 are locked in position.

After orienting the rack assembly 300, the lift system 500 may be used to perform an operation on a structure, such as an operation described in the present disclosure. Examples of such operations include any one or more of: further assembling the rack assembly 300 adjacent the structure; coupling the rack assembly to the structure; further constructing the structure; or performing an activity on the structure, such as cleaning, painting, maintenance, repair, observation, monitoring, equipment removal, or equipment installation (such as the installation of a tower section 24, a nacelle 30, a rotor, a blade, etc.).

When preparing to move the lift system 500 away from the structure, such as under self-propulsion, the above operations are performed in reverse.

In some embodiments, the leveling assembly 570 can adjust the acute angle 589 of the rack assembly 300 with respect to vertical by as much as ten degrees, such as by as much as seven degrees or as much as five degrees.

In some embodiments, the acute angle 588 of the support surface 15 with respect to horizontal may be compensated at least in part by using a mat 502 having an increased thickness in one portion than in another portion. For example, a thicker mat module 504 (such as a stack of two or more mat modules 504) may be placed under one of the first or second traction units 214, 216, and a mat module 504 of regular (i.e. lesser) thickness may be placed under the other of the first or second traction units 214, 216. In an example, a disparity of thicknesses of the mat 502 (such as described above) may be utilized without operating the leveling assembly 570 in order to compensate for the acute angle 588 of the support surface 15 with respect to horizontal. In another example, a disparity of thicknesses of the mat 502 (such as described above) may be utilized in addition to operating the leveling assembly 570 in order to compensate for the acute angle 588 of the support surface 15 with respect to horizontal.

In some embodiments, the leveling assembly 570 is omitted. In such embodiments, the rack assembly 300 is coupled directly to the car body 212.

As illustrated in FIGS. 15A to 15D, in some embodiments, the base 510 includes a carriage rest 598. The carriage rest 598 is used to support a portion of the carriage 520 when the carriage 520 is lowered to facilitate transport of the lift system 500. In some embodiments, the carriage rest 598 can be raised and lowered, such as by hydraulic or pneumatic pistons. In some embodiments, the carriage rest 598 is coupled to the leveling table 572. In some embodiments, the carriage rest 598 is coupled to one or more of the outriggers 574. In some embodiments, the carriage rest 598 is coupled to the car body 212.

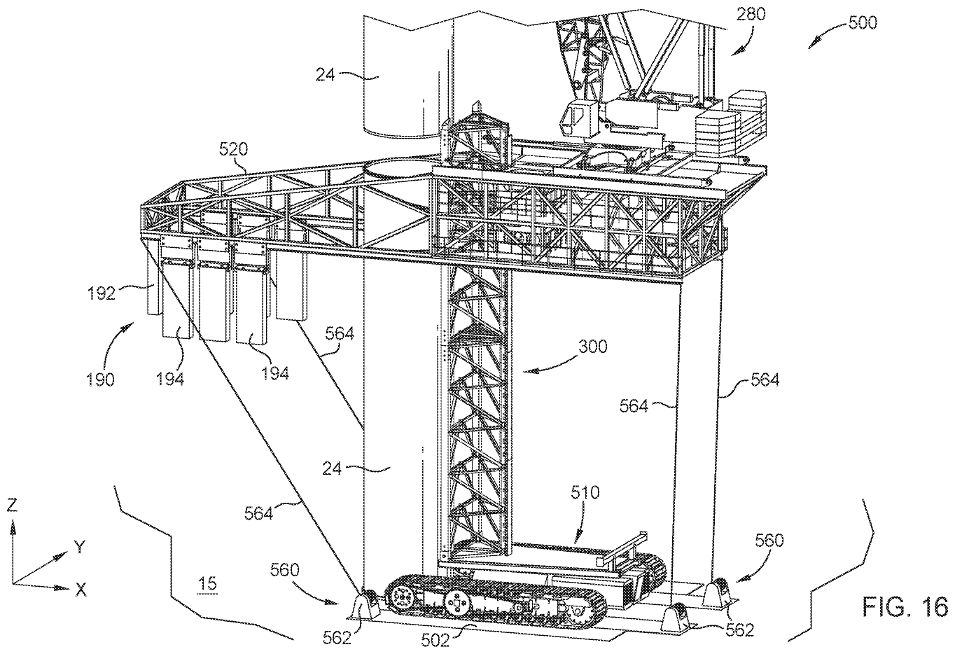

FIG. 16 schematically illustrates an aspect of some embodiments of the lift system 500. In some embodiments, the lift system 500 includes a counterbalance winch system 560. The counterbalance winch system 560 includes one or more winches 562 located on the mat 502. Each winch 562 spools out a corresponding counterbalance line 564. Each counterbalance line 564 is attached to a different portion of the carriage 520. Each winch 562 is controlled to apply tension to each corresponding counterbalance line 564 in order to compensate for unbalanced loading of the carriage 520.

In some embodiments, the counterweights 190 may be augmented by, or replaced by, the counterbalance winch system 560. In an example, the lift system 500 includes one or more fixed counterweights 192 and the counterbalance winch system 560, but no movable counterweights 194. In another example, the lift system 500 includes one or more movable counterweights 194 and the counterbalance winch system 560, but no fixed counterweights 192. In another example, the lift system 500 includes one or more fixed counterweights 192, one or more movable counterweights 194, and the counterbalance winch system 560. In a further example, the lift system 500 includes the counterbalance winch system 560, without any fixed counterweights 192 or movable counterweights 194. In some embodiments, the counterbalance winch system 560 is omitted.

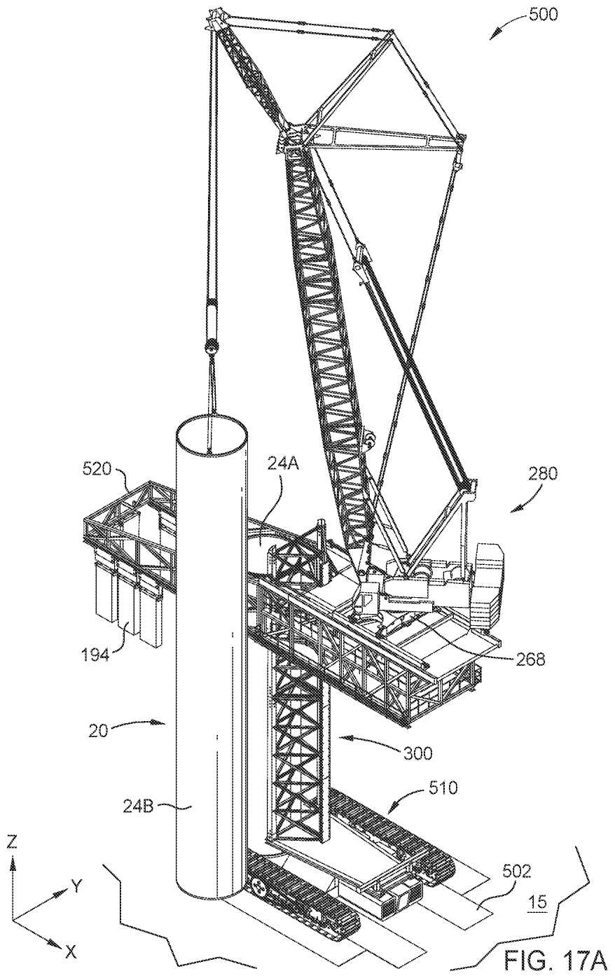

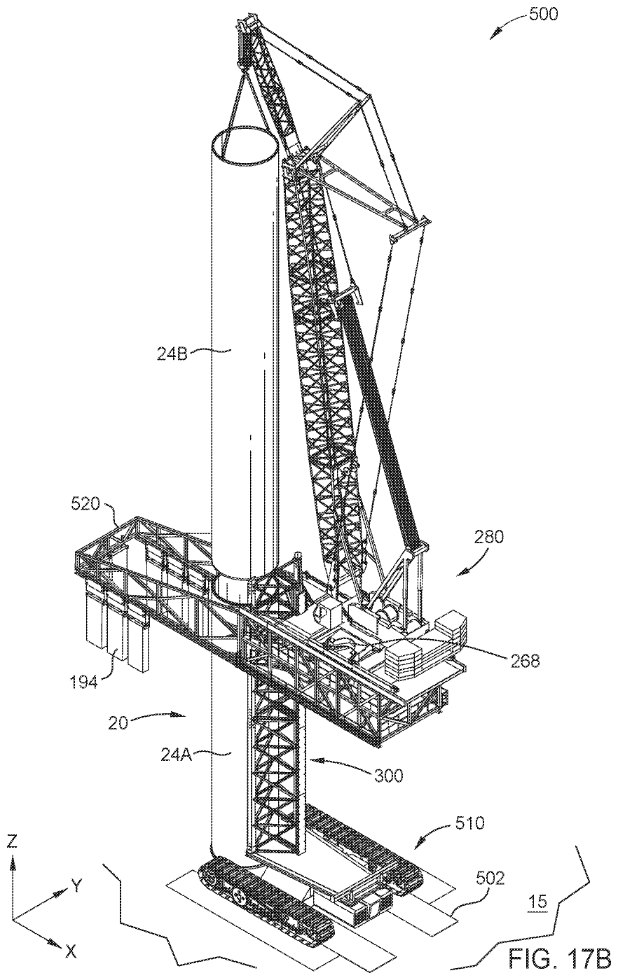

FIGS. 17A to 17C schematically illustrate exemplary operations of the lift system 500 in constructing a structure 20. The illustrated example shows operations employed in the placing of a second tower section 24B onto a first tower section 24A. In FIG. 17A, the first tower section 24A is already in place. The lift system 500 is adjacent the first tower section 24A. The carriage 520 has been raised up the rack assembly 300 to an elevated location, such as adjacent the top of the structure 20. In the illustrated example, the elevated location is adjacent the top of the first tower section 24A. The second tower section 24B is beside the first tower section 24A. The crane 280 has been moved on the carriage 520 towards the rack assembly 300, such as by using the sled 540 and the one or more actuators 550 described above. In some embodiments, the crane 280 is moved on the carriage 520 towards the rack assembly 300 while the carriage 520 is at the elevated location. The crane 280 has been slewed on the chassis 268 to facilitate picking up the second tower section 24B. In some embodiments, the crane 280 is slewed on the chassis 268 while the carriage 520 is at the elevated location.

The movable counterweights 194 are positioned to balance the loads on the carriage 520. In some embodiments, the crane 280 and the movable counterweights 194 are moved simultaneously. In some embodiments, the crane 280 and the movable counterweights 194 are not moved simultaneously. In an example the crane 280 is moved before the movable counterweights 194 are moved. In another example the crane 280 is moved after the movable counterweights 194 are moved.

In some embodiments, movement of the crane 280 and the movable counterweights 194 occurs at least partially simultaneously. In an example, movement of the crane 280 commences before movement of the movable counterweights 194, and movement of the movable counterweights 194 commences during the movement of the crane 280. In another example, movement of the movable counterweights 194 commences before movement of the crane 280, and movement of the crane 280 commences during the movement of the movable counterweights 194.

The crane 280 is shown raising the second tower section 24B. The crane 280 raises the second tower section 24B from the support surface 15. In some embodiments, the crane 280 raises the second tower section 24B from a location proximal to the support surface 15, such as from a transport vehicle on the support surface 15.

In FIG. 17B, the crane has raised the second tower section 24B to a height above the height of the first tower section 24A. The crane is slewed on the chassis 268 to align the second tower section 24B with the first tower section 24A.

In FIG. 17C, the crane is shown lowering and landing the second tower section 24B into engagement with the first tower section 24A. In some embodiments, the crane lowers the second tower section 24B while the carriage 520 remains at the elevation adjacent the top of the first tower section 24A. In some embodiments, the crane lowers the second tower section 24B while the carriage 520 is lowered from the elevation adjacent the top of the first tower section 24A. In some embodiments, the second tower section 24B is lowered without operating the crane 280, but by lowering the carriage 520 from the elevation adjacent the top of the first tower section 24A.

In some embodiments, the second tower section 24B is landed onto the first tower section 24A by operating the crane 280 while the carriage 520 remains stationary. In some embodiments, the second tower section 24B is landed onto the first tower section 24A by operating the crane 280 and lowering the carriage 520. In some embodiments, the second tower section 24B is landed onto the first tower section 24A by lowering the carriage 520 without operating the crane 280.

As illustrated, in some embodiments, the movable counterweights 194 are repositioned to account for the load of the second tower section 24B being transferred from the carriage 520 to the first tower section 24A. In some embodiments, the movable counterweights 194 are moved simultaneously with landing the second tower section 24B on the first tower section 24A. In some embodiments, the movable counterweights 194 are not moved simultaneously with landing the second tower section 24B on the first tower section 24A. In an example the movable counterweights 194 are moved before landing the second tower section 24B on the first tower section 24A. In another example the movable counterweights 194 are moved after landing the second tower section 24B on the first tower section 24A.

It is contemplated that assembling the rack assembly 300 is performed in a similar way as shown in FIGS. 17A to 17C for constructing the structure 20. For example, the operations of picking up a rack section (such as rack section 324D) from a location proximal to the support surface 15, aligning the rack section with the existing rack assembly 300, and landing the rack section on the existing rack assembly 300 may be performed in a similar way as described above.

Furthermore, the coupling of the rack assembly 300 to the structure 20 may be performed by at least some of the mechanisms described above with respect to FIGS. 4A to 4F. In some embodiments, the rack assembly 300 is coupled to the structure 20 additionally by at least some of the mechanisms described above with respect to FIG. 10C. In some embodiments, the rack assembly 300 is not coupled to the structure 20 additionally by at least some of the mechanisms described above with respect to FIG. 10C.

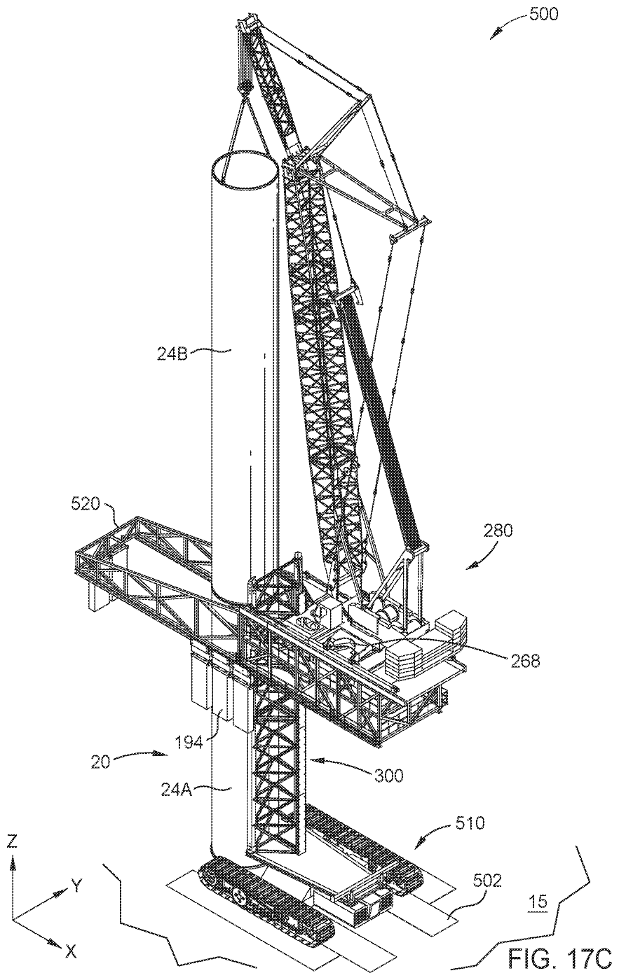

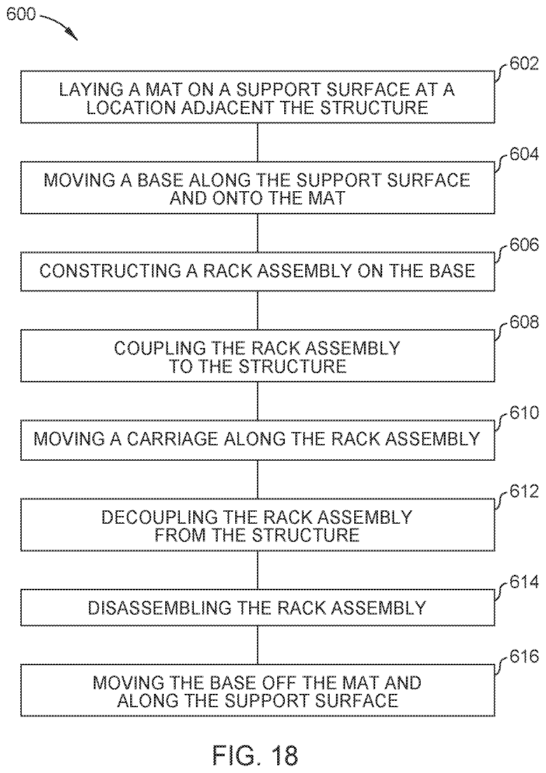

FIG. 18 is a flow chart for a method 600 of performing an operation on a structure, such as the structure 20. In some embodiments, the structure is a tower, such as the tower 22. In some embodiments, the method 600 is conducted using the lift system 200. In some embodiments, the method 600 is conducted using the lift system 500.

Operation 602 involves laying a mat on a support surface (e.g. support surface 15, described above) at a location adjacent the structure. In some embodiments, the mat is the mat 502. In some embodiments, the mat includes a plurality of modules, such as modules 504. In some embodiments, operation 602 includes coupling the modules together.

Operation 602 includes scenarios in which the structure is yet to be in place when the mat is laid at a location adjacent the structure. In other words, the mat is laid at a location adjacent to a site where the structure is going to be constructed. In an example, operation 602 includes scenarios in which the site where the structure is to be constructed is undeveloped at the time of laying the mat. In another example, operation 602 includes scenarios in which the site where the structure is to be constructed includes a foundation for the structure at the time of laying the mat. In yet another example, operation 602 includes scenarios in which at the time of laying the mat, a portion of the structure is in place at the site where the structure is to be constructed.

Operation 604 involves moving a base along the support surface and onto the mat. In some embodiments when conducting the method 600 using the lift system 200, operation 604 includes moving the base 210 under self-propulsion along the support surface and onto the mat. In some embodiments, the base 210 conveys a carriage (such as any one of carriage 120, 120′, or 520) while the base 210 moves onto the mat. In some embodiments, operation 604 includes moving the base 210 onto the mat and to a location adjacent the structure. In some embodiments when conducting the method 600 using the lift system 500, operation 604 includes moving the base 510 under self-propulsion along the support surface and onto the mat. In some embodiments, the base 510 conveys a carriage (such as any one of carriage 120, 120′, or 520) while the base 510 moves onto the mat. In some embodiments, operation 604 includes moving the base 510 onto the mat and to a location adjacent the structure.

Operation 606 involves constructing a rack assembly on the base. It is contemplated that the rack assembly may be any of the rack assemblies 300/300A/300B/300C/300D described above. In some embodiments, the rack assembly includes one or more standard rack sections (such as standard rack section 450) and one or more stand-off rack sections (such as stand-off rack section 460), as described with respect to FIGS. 4C to 4F. It is further contemplated that operation 606 includes constructing the rack assembly adjacent the structure. It is further contemplated that constructing the rack assembly may involve at least some of the rack assembling operations described above.

Operation 608 involves coupling the rack assembly to the structure. It is contemplated that the rack assembly may be coupled to the structure by at least some of the mechanisms described above with respect to FIGS. 4A to 4F. In some embodiments, the rack assembly is coupled to the structure additionally by at least some of the mechanisms described above with respect to FIG. 10C. In some embodiments, the rack assembly is not coupled to the structure additionally by at least some of the mechanisms described above with respect to FIG. 10C. In some embodiments, the rack assembly is coupled to the structure at a plurality of discrete locations along the structure.

In some embodiments, the activities of operations 606 and 608 are repeated in sequence for each rack section that is attached to form the rack assembly. In an example, the activities of operation 606 are performed to attach a rack section to the rack assembly, then the activities of operation 608 are performed on the rack section, then the activities of operation 606 are performed to attach another rack section to the rack assembly, and so on. In some embodiments, the activities of operation 606 are performed to attach more than one selected rack section to the rack assembly before the activities of operation 608 are performed on the selected rack sections.

In some embodiments, method 600 includes coupling a carriage (such as the carriage 120, 120′, or 520) to the rack assembly after coupling a lowermost rack section of the rack assembly (such as lowermost rack section 326) to the structure. In some embodiments, such as when method 600 is conducted using the lift system 200 or the lift system 500, the carriage is coupled to a lowermost rack section of the rack assembly on the base (such as base 210 or base 510) before the base is positioned at the location adjacent the structure. In some embodiments, such as when method 600 is conducted using the lift system 200 or the lift system 500, the carriage is coupled to a lowermost rack section of the rack assembly on the base after the base is positioned at the location adjacent the structure, but before the lowermost rack section of the rack assembly is coupled to the structure.

Operation 610 involves moving a carriage along the rack assembly. The carriage may be any of the carriage 120, 120′, or 520. It is contemplated that the carriage is moved along the rack assembly using the motors 132 and pinions 134. In some embodiments, the carriage is moved along the rack assembly to access an elevated section of the structure.

In some embodiments, method 600 includes performing one or more activities during and/or after operation 610. Exemplary activities include any one or more of cleaning, painting, maintenance, repair, observation, monitoring, equipment removal, or equipment installation (such as the installation of a tower section 24, a nacelle 30, a rotor, a blade, a pre-assembled rotor with blades, etc.). The one or more activities may involve operating a crane (such as crane 280 or 280′) on the carriage. In an example, operating the crane involves picking up a component from a location proximal to the support surface while the carriage is proximal to an uppermost end of the rack assembly. The one or more activities may be performed prior to operation 612.

Operation 612 involves decoupling the rack assembly from the structure. It is contemplated that the decoupling of the rack assembly from the structure includes a reversal of the activities described above involved in operation 608. In an example, each strap is loosened and removed from the structure, and each stand-off brace is retracted away from the structure.

Operation 614 involves disassembling the rack assembly. It is contemplated that the disassembling of the rack assembly includes the removal of each rack section from the rack assembly. In an example, the detaching of each rack section from the rack assembly includes a reversal of the activities of operation 606 that are involved in attaching each rack section to the rack assembly.

In some embodiments, the activities of operations 612 and 614 are repeated in sequence for each rack section that is detached from the rack assembly. In an example, the activities of operation 612 are performed on a rack section, then the activities of operation 614 are performed on the rack section, then the activities of operation 612 are performed on another rack section, and so on. In some embodiments, the activities of operation 612 are performed on more than one selected rack section before the activities of operation 614 are performed on the selected rack sections.

Operation 616 involves moving the base off the mat and along the support surface. When conducting the method 600 using the lift system 200, operation 616 includes moving the base 210, such as under self-propulsion, off the mat and away from the structure along the support surface, such as described above. In some embodiments, the base 210 conveys a carriage (such as any one of carriage 120, 120′, or 520) while the base 210 moves away from the structure. When conducting the method 600 using the lift system 500, operation 616 includes moving the base 510, such as under self-propulsion, off the mat and away from the structure along the support surface, such as described above. In some embodiments, the base 510 conveys a carriage (such as any one of carriage 120, 120′, or 520) while the base 510 moves away from the structure. In some embodiments, method 600 includes removing the mat from the support surface after moving the base off the mat.

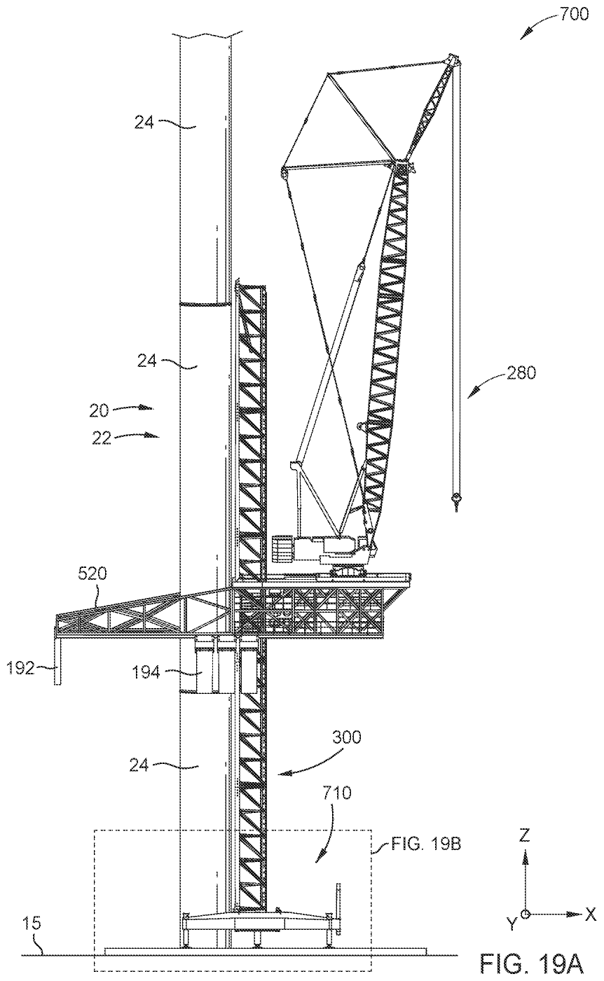

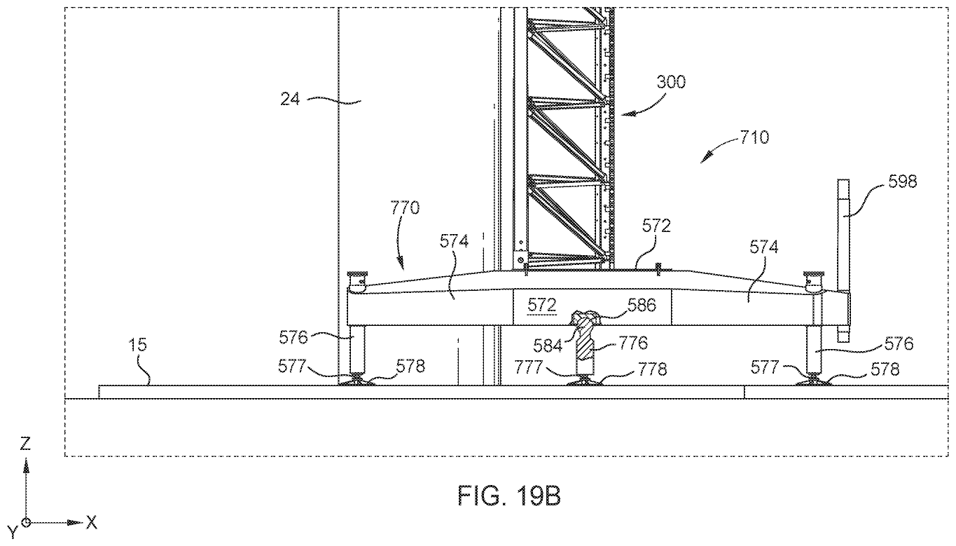

FIGS. 19A and B schematically illustrate a lift system 700. Lift system 700 is shown deployed on a support surface 15, described above. In some embodiments, the lift system 700 is deployed onshore, and the support surface 15 is a ground surface, such as ground surface 10. In some embodiments, the lift system 700 is deployed onshore, and the support surface 15 is a portion (e.g. a deck) of an offshore installation, such as offshore installation 50 (described above). In some embodiments, lift system 700 is deployed on a mat 502 that is positioned on the support surface 15. Lift system 700 is similar to lift system 500. Lift system 700 includes components of lift system 500, but major differences are highlighted in the following description. Lift system 700 includes a base 710. As shown in the Figures, base 710 is similar to base 510, but omits the car body 212 and the traction units 214, 216.

FIG. 19B is an enlargement of a portion of FIG. 19A depicting the base 710. Base 710 includes leveling assembly 770. Leveling assembly 770 is similar to leveling assembly 570, including leveling table 572 and one or more outriggers 574. Feet 578 are coupled to the one or more outriggers 574. Each foot 578 is raised and lowered with respect to the leveling table 572 by a corresponding jack 576. Leveling assembly 770 includes also a center foot 778. The center foot 778 is coupled to the leveling table 572 via a center jack 776 that is configured to raise and lower the center foot 778 with respect to the leveling table 572. In some embodiments, the center jack 776 is coupled to the center foot 778 by a ball joint 777. In some embodiments, the center jack 776 is coupled to the leveling table 572 by a ball joint, such as the ball 584 and corresponding socket 586 of leveling assembly 570.

At least a portion of a combined loading of a weight of the lift system 700 plus a load borne by the lift system 700 is transferred to the support surface 15 via the feet 578 when the feet 578 are in the lowered position. For example, up to about 10%, about 20%, about 30%, about 40%, or about 50% of the combined loading is transferred to the support surface 15 via the feet 578. The remainder of the combined loading is transferred to the support surface 15 via the center foot 778.

Operation of the leveling assembly 770 is similar to operation of the leveling assembly 570. Each jack 576 lowers each foot 578 into contact with the mat 502 (if present) and/or the support surface 15. One or more of the jacks 576 are selectively energized to tilt the leveling table 572 with respect to the support surface 15, as described above.

The jacks 576 are operated such that each foot 578 remains in contact with the mat 502 (if present) and/or the support surface 15 while the leveling table 572 is being tilted. During the tilting, the leveling table 572 pivots with respect to the center jack 776 on the ball 584. The socket 586 moves with the leveling table 572 while the ball 584 remains stationary. During the tilting, each jack 576 can pivot with respect to each corresponding foot 578 at the respective ball joints 577 coupling each jack 576 to each foot 578.

The rack assembly 300 moves with the leveling table 572. When the rack assembly 300 has been moved to a desired orientation, the tilting operation is stopped. In some embodiments, at the cessation of the tilting operation, the jacks 576 are locked in position.

Exemplary operations of the lift system 700 in assembling a rack assembly 300 and for constructing a structure 20 are as described above for the lift system 500 with respect to FIGS. 17A to 17C.

It is contemplated that elements and features of any one lift system 100, 100′, 200, 500, or 700 may be beneficially incorporated in one or more other lift system 100, 100′, 200, 500, or 700. In an example any of the lift systems 100, 100′, 200, 500, or 700 may include the carriage 120 with a single crane 280. In another example any of the lift systems 100, 100′, 200, 500, or 700 may include the carriage 120′ with the crane 280 and the crane 280′. In another example any of the lift systems 100, 100′, 200, 500, or 700 may include the carriage 520 with the crane 280 mounted the sled 540 for transverse movement on the carriage 520.

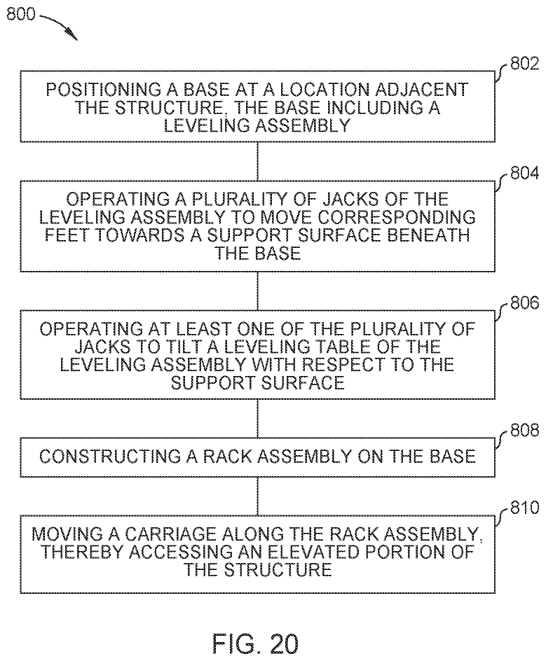

FIG. 20 is a flow chart for a method 800 of performing an operation on a structure, such as the structure 20. In some embodiments, the structure is a tower, such as the tower 22. The method 800 may be performed using the lift system 500 or the lift system 700. The method 800 involves using a base (such as base 510 or 710) that includes a leveling assembly (such as leveling assembly 570 or 770). In some embodiments, the leveling assembly includes a leveling table (such as leveling table 572) and a plurality of outriggers (such as outriggers 574) extending from the leveling table. In some examples, each outrigger includes a foot (such as foot 578) that is movable by a corresponding jack (such as jack 576).

Operation 802 involves positioning the base at a location adjacent the structure. The base may be positioned on a support surface, such as support surface 15 (described above). In some embodiments when conducting the method 800 using the lift system 500, operation 802 includes moving the base 510 under self-propulsion to the location adjacent the structure. In some of such embodiments, the base 510 conveys a carriage (such as any one of carriage 120, 120′, or 520) while the base 510 moves to the location adjacent the structure.

Operation 802 includes scenarios in which the structure is yet to be in place when the base is positioned at a location adjacent the structure. In other words, the base is positioned at a location adjacent to a site where the structure is going to be constructed. In an example, operation 802 includes scenarios in which the site where the structure is to be constructed is undeveloped at the time of positioning the base. In another example, operation 802 includes scenarios in which the site where the structure is to be constructed includes a foundation for the structure at the time of positioning the base. In yet another example, operation 802 includes scenarios in which at the time of positioning the base, a portion of the structure is in place at the site where the structure is to be constructed.

Operation 804 involves operating a plurality of jacks of the leveling assembly to move corresponding feet towards the support surface beneath the base. A load is imparted onto the support surface by each foot.

Operation 806 involves operating at least one of the plurality of jacks to tilt the leveling table of the leveling assembly with respect to the support surface. In an example, a jack raises a first portion of the leveling table with respect to the support surface to a greater extent than a second portion of the leveling table is raised with respect to the support surface. In some embodiments, while the leveling table is being tilted, the jacks are operated to maintain contact between each foot and the support surface and/or an object thereon (such as a mat, e.g. mat 502). In some embodiments, the leveling table is locked in place at a tilted position. In an example, the jacks are locked in position.

In some embodiments, operation 806 includes positioning the leveling table such that a rack assembly that is subsequently constructed on the base will be positioned at a preselected orientation. In an example, the rack assembly is substantially vertical, such as within five degrees, within four degrees, within three degrees, or within two degrees of vertical. In some embodiments, operation 806 includes positioning the leveling table such that the rack assembly that is subsequently constructed on the base is positioned at a preselected orientation with respect to the structure. In an example, the rack assembly is substantially parallel to a central axis of the structure, such as within five degrees, within four degrees, within three degrees, or within two degrees of the central axis of the structure.

Operation 808 involves constructing a rack assembly on the base. It is contemplated that the rack assembly may be any of the rack assemblies 300/300A/300B/300C/300D described above. In some embodiments, the rack assembly includes one or more standard rack sections (such as standard rack section 450) and one or more stand-off rack sections (such as stand-off rack section 460), as described with respect to FIGS. 4C to 4F. It is further contemplated that operation 808 includes constructing the rack assembly adjacent the structure. It is further contemplated that constructing the rack assembly may involve at least some of the rack assembling operations described above.

In some embodiments, method 800 includes coupling the rack assembly to the structure, such as by at least some of the mechanisms described above with respect to FIGS. 4A to 4F. In some embodiments, the rack assembly is coupled to the structure additionally by at least some of the mechanisms described above with respect to FIG. 10C. In some embodiments, the rack assembly is not coupled to the structure additionally by at least some of the mechanisms described above with respect to FIG. 10C. In some embodiments, the rack assembly is coupled to the structure at a plurality of discrete locations along the structure.

In some embodiments, method 800 includes coupling a carriage (such as the carriage 120, 120′, or 520) to the rack assembly after coupling a lowermost rack section of the rack assembly (such as lowermost rack section 326) to the structure. In some embodiments, such as when method 800 is conducted using the lift system 200 or the lift system 500, the carriage is coupled to a lowermost rack section of the rack assembly on the base (such as base 210 or base 510) before the base is positioned at the location adjacent the structure. In some embodiments, such as when method 800 is conducted using the lift system 200 or the lift system 500, the carriage is coupled to a lowermost rack section of the rack assembly on the base after the base is positioned at the location adjacent the structure, but before the lowermost rack section of the rack assembly is coupled to the structure.

Operation 810 involves moving a carriage along the rack assembly. The carriage may be any of the carriage 120, 120′, or 520. It is contemplated that the carriage is moved along the rack assembly using the motors 132 and pinions 134. In some embodiments, the carriage is moved along the rack assembly to access an elevated section of the structure.

In some embodiments, method 800 includes performing one or more activities during and/or after operation 810. Exemplary activities include any one or more of cleaning, painting, maintenance, repair, observation, monitoring, equipment removal, or equipment installation (such as the installation of a tower section 24, a nacelle 30, a rotor, a blade, a pre-assembled rotor with blades, etc.). The one or more activities may involve operating a crane (such as crane 280 or 280′) on the carriage. In an example, operating the crane involves picking up a component from a location proximal to a floor while the carriage is proximal to an uppermost end of the rack assembly. It is contemplated that the floor may be the support surface, such as support surface 15. In an example, the floor is a ground surface, such as ground surface 10. In another example, the floor is a portion (e.g. a deck) of an offshore installation, such offshore installation 50.

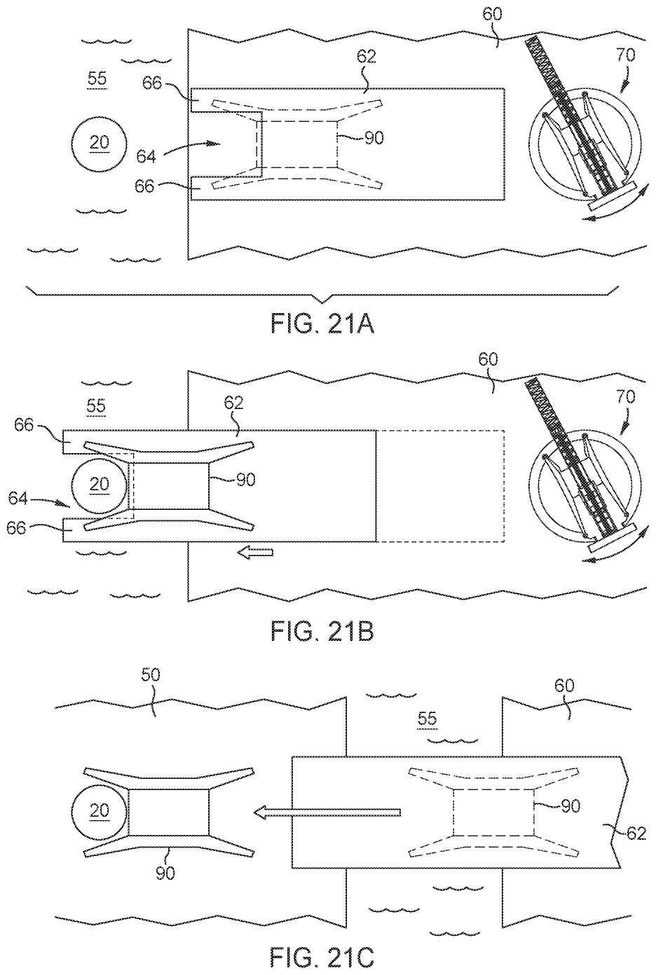

FIGS. 21A to 21C schematically illustrate additional examples of locating a lift system, such as lift system 100, 100′, 200, 500, or 700 adjacent a structure 20, such as the tower 22. The Figures provide simplified views from above. In the illustrated examples, the structure 20 is offshore in a body of water 55, such as a lake, river, or sea.

FIGS. 21A and 21B depict an example of locating a lift system adjacent a structure 20. Although not illustrated, it is contemplated that the structure 20 may be disposed on, or part of, an offshore installation, such as offshore installation 50 described above. As such, the structure 20 may be disposed on, or part of, a monopile, a tripod, a quadrapod, a gravity-based structure, a jacket (e.g. a conventional jacket, a suction caisson, or the like), a platform (e.g. a tension leg platform), a floating vessel (e.g. a ship, a barge, a semi-submersible vessel, or a spar-buoy), or the like.

In FIG. 21A, a service vessel 60, such as a jack-up vessel, is positioned near to the structure 20. In some embodiments, a master crane 70 on the service vessel 60 assists with positioning, assembling, and/or disassembling a lift system on the service vessel 60. In some embodiments, the master crane 70 assists with handling components of the structure 20, such as tower sections, nacelles, rotors, blades, etc. In some embodiments, the master crane 70 is a ring crane. In some of such embodiments, the ring of the ring crane is configured to be moved laterally across a deck of the service vessel 60.

The service vessel 60 includes a cantilever platform 62. As illustrated, in some embodiments, the cantilever platform 62 includes a moonpool 64 that is flanked by one or more decks 66. In the illustrated example, the moonpool 64 and decks 66 form a U-shaped opening at an end of the cantilever platform 62. The cantilever platform is movable on the service vessel 60 to extend from the service vessel 60 over the water 55. When the cantilever platform 62 is extended over the water 55, the moonpool 64 provides access for installing, or performing an activity on, a structure in the water 55. In an example, the moonpool facilitates the installation of a monopile in the water 55. In some embodiments, the cantilever platform 62 does not include the moonpool 64.

A lift system 90 is shown in dashed outline on the cantilever platform. The lift system 90 is a generic representation of any lift system, such as the lift system 100, 100′, 200, 500, or 700. In some embodiments, the lift system 90 is located elsewhere on the service vessel 60 while the service vessel 60 is being maneuvered into position near to the structure 20. In some embodiments, the lift system 90 is in place as shown at the moonpool 64 while the service vessel 60 is being maneuvered into position near to the structure 20. In some embodiments, a portion of the lift system 90 (such as a base, e.g. base 110/110′/210/510/710) is in place at the moonpool 64 while the service vessel 60 is being maneuvered into position near to the structure 20.

In FIG. 21B, the cantilever platform 62 is shown extended from the service vessel 60 over the water 55 towards the structure 20. In some embodiments, the lift system 90 is located at the moonpool 64 before or during the extending of the cantilever platform 62 towards the structure 20. In some embodiments, the lift system 90 is positioned at the moonpool 64 after the cantilever platform 62 has been extended towards the structure 20. The moonpool 64 is juxtaposed with the structure 20 such that the decks 66 are positioned either side of the structure 20. The lift system 90 is positioned on the cantilever platform 62. The cantilever platform 62 is an exemplary support surface 15. The lift system 90 is positioned adjacent the structure 20 to facilitate the performance of an activity on the structure. Exemplary activities include any one or more of cleaning, painting, maintenance, repair, observation, monitoring, equipment removal, or equipment installation (such as the installation of a tower section 24, a nacelle 30, a rotor, a blade, a pre-assembled rotor with blades, etc.).

FIG. 21C depicts another example of locating a lift system adjacent a structure 20. The structure 20 is shown disposed on, or part of, an offshore installation 50, such as described above. The service vessel 60 is positioned near to the offshore installation 50. The cantilever platform 62 is extended from the service vessel 60 to the offshore installation 50. The cantilever platform 62 provides a bridge from the service vessel 60 to the offshore installation 50. The lift system 90 is shown as being conveyed from the service vessel 60 to the offshore installation 50 via the cantilever platform 62. The lift system 90 is then positioned adjacent the structure 20 to facilitate the performance of an activity on the structure.

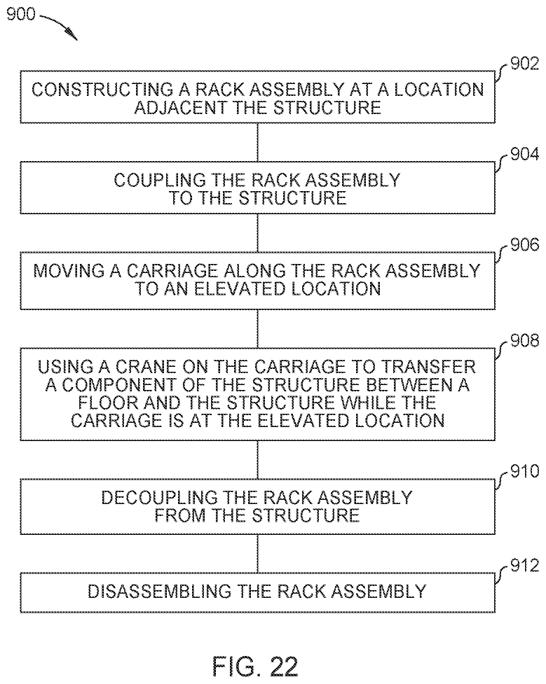

FIG. 22 is a flow chart for a method 900 of performing an operation on a structure, such as the structure 20. In some embodiments, the structure is a tower, such as the tower 22. The method 900 may be performed by any of lift system 100, 100′, 200, 500, or 700.

Operation 902 involves constructing a rack assembly at a location adjacent the structure. The rack assembly may be any of the rack assemblies 300/300A/300B/300C/300D described above. In some embodiments, the rack assembly includes one or more standard rack sections (such as standard rack section 450) and one or more stand-off rack sections (such as stand-off rack section 460), as described with respect to FIGS. 4C to 4F. Constructing the rack assembly may involve at least some of the rack assembling operations described above. In some embodiments, operation 902 includes constructing the rack assembly on a base, such as base 110, 110′, 210, 510, or 710. The base is located on a support surface (such as support surface 15, described above).

Operation 904 involves coupling the rack assembly to the structure. It is contemplated that the rack assembly may be coupled to the structure by at least some of the mechanisms described above with respect to FIGS. 4A to 4F. In some embodiments, the rack assembly is coupled to the structure additionally by at least some of the mechanisms described above with respect to FIG. 10C. In some embodiments, the rack assembly is not coupled to the structure additionally by at least some of the mechanisms described above with respect to FIG. 10C. In some embodiments, the rack assembly is coupled to the structure at a plurality of discrete locations along the structure.

In some embodiments, the activities of operations 902 and 904 are repeated in sequence for each rack section that is attached to form the rack assembly. In an example, the activities of operation 902 are performed to attach a rack section to the rack assembly, then the activities of operation 904 are performed on the rack section, then the activities of operation 902 are performed to attach another rack section to the rack assembly, and so on. In some embodiments, the activities of operation 902 are performed to attach more than one selected rack section to the rack assembly before the activities of operation 904 are performed on the selected rack sections.

In some embodiments, method 900 includes coupling a carriage (such as the carriage 120, 120′, or 520) to the rack assembly after coupling a lowermost rack section of the rack assembly (such as lowermost rack section 326) to the structure. In some embodiments, such as when method 900 is conducted using the lift system 200 or the lift system 500, the carriage is coupled to a lowermost rack section of the rack assembly on the base (such as base 210 or base 510) before the base is positioned at the location adjacent the structure. In some embodiments, such as when method 900 is conducted using the lift system 200 or the lift system 500, the carriage is coupled to a lowermost rack section of the rack assembly on the base after the base is positioned at the location adjacent the structure, but before the lowermost rack section of the rack assembly is coupled to the structure.

Operation 906 involves moving a carriage along the rack assembly to an elevated location. The carriage may be any of the carriage 120, 120′, or 520. It is contemplated that the carriage is moved along the rack assembly using the motors 132 and pinions 134.

Operation 908 involves using a crane (such as crane 280 or 280′) on the carriage to transfer a component of the structure between a floor and the structure while the carriage is at the elevated location. It is contemplated that the floor may be the support surface, such as support surface 15. In an example, the floor is a ground surface, such as ground surface 10. In another example, the floor is a portion (e.g. a deck) of an offshore installation, such offshore installation 50. Exemplary components may include a tower section 24, a nacelle 30, a rotor, a blade, a pre-assembled rotor with blades, etc. In some embodiments, operation 908 involves using the crane to pick up the component from the floor (or a location proximal to the floor) and place the component on the structure. In some embodiments, operation 908 involves using the crane to pick up the component from the structure and place the component onto the floor (or onto a location proximal to the floor).

In some embodiments, operation 908 also involves moving the crane on the carriage towards or away from the rack assembly (such as by using the sled 540 and the one or more actuators 550) while the carriage is at the elevated location. In some embodiments, operation 908 also involves slewing the crane (such as on the chassis 268) while the carriage is at the elevated location.

In some embodiments, method 900 includes performing one or more activities during and/or after operation 908. Exemplary activities include any one or more of cleaning, painting, maintenance, repair, observation, monitoring, equipment removal, or equipment installation (such as the installation of a tower section 24, a nacelle 30, a rotor, a blade, a pre-assembled rotor with blades, etc.). The one or more activities may be performed prior to operation 910.

Operation 910 involves decoupling the rack assembly from the structure. It is contemplated that the decoupling of the rack assembly from the structure includes a reversal of the activities described above involved in operation 904. In an example, each strap is loosened and removed from the structure, and each stand-off brace is retracted away from the structure.

Operation 912 involves disassembling the rack assembly. It is contemplated that the disassembling of the rack assembly includes the removal of each rack section from the rack assembly. In an example, the detaching of each rack section from the rack assembly includes a reversal of the activities of operation 902 that are involved in attaching each rack section to the rack assembly.

In some embodiments, the activities of operations 910 and 912 are repeated in sequence for each rack section that is detached from the rack assembly. In an example, the activities of operation 910 are performed on a rack section, then the activities of operation 912 are performed on the rack section, then the activities of operation 910 are performed on another rack section, and so on. In some embodiments, the activities of operation 910 are performed on more than one selected rack section before the activities of operation 912 are performed on the selected rack sections.

It is contemplated that any one of the methods 400, 600, 800, or 900 may incorporate any one or more of the operations or activities of any other of the methods 400, 600, 800, or 900. It is further contemplated that any one of the methods 400, 600, 800, or 900 may incorporate any one or more of the operations, procedures, or activities contained in the present disclosure. For example, it is contemplated that any one of the methods 400, 600, 800, or 900 may include positioning a cantilever platform (such as cantilever platform 62) adjacent to the structure, such as shown and described above with respect to FIGS. 21A to 21C.

It is contemplated that any operation or activity of any one of the methods 400, 600, 800, or 900 may be employed during the construction of a structure, such as the structure 20, such as the tower 22. It is contemplated that any operation or activity of any one of the methods 400, 600, 800, or 900 may be employed during the deconstruction of a structure, such as the structure 20, such as the tower 22. It is contemplated that any operation or activity of any one of the methods 400, 600, 800, or 900 may be employed during the performance of maintenance on a structure, such as the structure 20, such as the tower 22.

In some embodiments, for each lift system (100, 100′, 200, 500, 700) and for each method (400, 600, 800, 900), it is contemplated that the rack assembly 300 is assembled along, and releasably coupled to, a substantial portion of an upwardly-extending length of the structure 20. In an example, a magnitude of the upwardly-extending length of the structure 20 is a height of the structure 20 measured from the ground surface 10 to an uppermost point of the structure 20. In another example, the structure 20 is located on a support surface of an offshore installation 50, and a magnitude of the upwardly-extending length of the structure 20 is a height of the structure 20 measured from the support surface to an uppermost point of the structure 20. In some examples, the rack assembly 300 is assembled along, and releasably coupled to, 30% or greater, 40% or greater, 50% or greater, 60% or greater, 70% or greater, 80% or greater, or 90% or greater of an upwardly-extending length of the structure 20.

The systems and methods of the present disclosure provide robust, modular lift systems that facilitate construction and maintenance operations on structures, such as towers, such as used for wind turbines. The systems and methods of the present disclosure facilitate such operations without necessitating the use of large cranes (such as 1000 metric ton cranes or larger cranes), and without incurring the cost and complexities of using such cranes.

It is contemplated that elements and features of any one disclosed embodiment may be beneficially incorporated in one or more other embodiments. While the foregoing is directed to embodiments of the present disclosure, other and further embodiments of the disclosure may be devised without departing from the basic scope thereof, and the scope thereof is determined by the claims that follow.

What is claimed is:

1. A lift system for performing an operation on a structure, the lift system comprising:
a base configured for self-propelled motion;
a rack assembly on the base, the rack assembly configured to be releasably coupled to the structure;
a carriage engaged with the rack assembly and configured to travel along the rack assembly; and
a crane on the carriage.

2. The lift system of claim 1, wherein:
the base comprises a car body coupled to first and second traction units; and
the first and second traction units are configured to propel the base.

3. The lift system of claim 2, wherein:
the base includes a leveling assembly coupled to the car body;
the leveling assembly comprises:
a leveling table; and
one or more outriggers extending from the leveling table, each outrigger including a foot coupled to a corresponding jack; and
the rack assembly is coupled to the leveling table.

4. The lift system of claim 1, further comprising a plurality of straps, each strap configured to couple the rack assembly to the structure.

5. The lift system of claim 4, further comprising a plurality of stand-off braces, each stand-off brace configured to couple the rack assembly to the structure.

6. The lift system of claim 5, wherein:
at least one strap of the plurality of straps is configured to provide a maximum stand-off between the rack assembly and the structure; and
at least one stand-off brace of the plurality of stand-off braces is configured to provide a minimum stand-off between the rack assembly and the structure.

7. The lift system of claim 1, wherein:
the crane is coupled to a sled engaged with the carriage; and
the lift system further comprises an actuator coupled to the sled and configured to move the sled along the carriage.

8. The lift system of claim 7, wherein the actuator includes:
a first piston rod connected to the sled; and
a second piston rod connected to the carriage.

9. A lift system for performing an operation on a structure, the lift system comprising:
a rack assembly;
a carriage engaged with the rack assembly and configured to travel along the rack assembly;
a sled on the carriage, the sled movable along the carriage towards and away from the rack assembly; and
a crane on the sled.

10. The lift system of claim 9, wherein:
the rack assembly is coupled to a base; and
the base is powered for motion by a motor mounted on one of the base, the carriage, or the crane.

11. The lift system of claim 10, wherein:
the base comprises a car body coupled to first and second traction units;
the first and second traction units propel the base; and
the rack assembly is coupled to the car body.

12. The lift system of claim 9, further comprising an actuator coupled to the sled and configured to move the sled along the carriage, the actuator including a piston and cylinder, a pinion, a winch, or a driven chain.

13. The lift system of claim 9, further comprising a counterweight movably mounted to the carriage and coupled to an actuator, the actuator including a piston or a cable.

14. A method of performing an operation on a structure, comprising:
positioning a base at a location adjacent the structure;
assembling a rack assembly on the base;
coupling the rack assembly to the structure;
moving a carriage along the rack assembly;
decoupling the rack assembly from the structure;
disassembling the rack assembly; and
removing the base from the location adjacent the structure.

15. The method of claim 14, wherein positioning the base at the location adjacent the structure comprises moving the base under self-propulsion.

16. The method of claim 14, further comprising transporting the carriage on the base while positioning the base at the location adjacent the structure.

17. The method of claim 14, wherein coupling the rack assembly to the structure comprises:
positioning a strap around a portion of the structure proximal to a connection between first and second structure sections; and
securing the strap to the rack assembly.

18. The method of claim 17, wherein coupling the rack assembly to the structure further comprises contacting the structure proximal to the connection using a stand-off brace.

19. The method of claim 14, further comprising operating a crane on the carriage to install a component onto the structure, the component including one of a tower section, a nacelle, a rotor, or a blade.

20. The method of claim 19, further comprising moving a counterweight along the carriage while operating the crane.
